(19) United States
(12) Patent Application Publication
(10) Pub. No.: US 2023/0114010 A1
(43) Pub. Date: Apr. 13, 2023

(54) METHOD AND APPARATUS FOR BEAM RECOVERY

(71) Applicant: Samsung Electronics Co., Ltd., Suwon-si (KR)

(72) Inventors: Dalin Zhu, Richardson, TX (US); Eko Onggosanusi, Coppell, TX (US); Emad N. Farag, Flanders, NJ (US); Md. Saifur Rahman, Plano, TX (US)

(21) Appl. No.: 17/932,625

(22) Filed: Sep. 15, 2022

Related U.S. Application Data
(60) Provisional application No. 63/248,372, filed on Sep. 24, 2021.
(60) Provisional application No. 63/248,888, filed on Sep. 27, 2021.
(60) Provisional application No. 63/276,970, filed on Nov. 8, 2021.
(60) Provisional application No. 63/278,792, filed on Nov. 12, 2021.
(60) Provisional application No. 63/286,408, filed on Dec. 6, 2021.

(51) Int. Cl. H04W 72/04; H04B 7/06; H04B 17/318; H04W 56/00; H04W 24/08

(52) U.S. Cl. CPC H04W 72/046; H04B 7/0695; H04B 17/318; H04W 24/08; H04W 56/001; H04W 72/042

(57) ABSTRACT

Apparatuses and methods for beam recovery operations in a wireless communication system. A method for operating a user equipment (UE) includes transmitting a reference signal (RS) resource index (q_new), receiving an indication of a unified transmission configuration indication (TCI) state, and receiving a beam failure recovery response (BFRR). The method further includes determining, based on the q_new and the BFRR, antenna port quasi co-location (QCL) parameters for: monitoring a physical downlink control channel (PDCCH), receiving a physical downlink shared channel (PDSCH), and receiving a channel state information RS (CSI-RS) and determining, based on the q_new and the BFRR, a spatial domain filter for transmitting: a physical uplink control channel (PUCCH), a physical uplink shared channel (PUSCH), and a sounding RS (SRS). The q_new corresponds to a synchronization signal block (SSB) resource index or a CSI-RS resource configuration index.

### CROSS REFERENCE TO RELATED APPLICATIONS AND CLAIM OF PRIORITY

The present application claims priority to:
U.S. Provisional Pat. Application No. 63/248,372, filed on Sep. 24, 2021;
U.S. Provisional Pat. Application No. 63/248,888, filed on Sep. 27, 2021;
U.S. Provisional Pat. Application No. 63/276,970, filed on Nov. 8, 2021;
U.S. Provisional Pat. Application No. 63/278,792, filed on Nov. 12, 2021; and
U.S. Provisional Pat. Application No. 63/286,408, filed on Dec. 6, 2021. The content of the above-identified patent documents are incorporated herein by reference.

### TECHNICAL FIELD

The present disclosure relates generally to wireless communication systems and, more specifically, the present disclosure relates to a beam recovery operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a beam recovery operation in a wireless communication system.

In one embodiment, a user equipment (UE) is provided. The UE includes a transceiver configured to transmit a reference signal (RS) resource index (q_new), receive an indication of a unified transmission configuration indication (TCI) state, and receive a beam failure recovery response (BFRR). The UE further includes a processor operably coupled to the transceiver. The processor configured is to determine, based on the q_new and the BFRR, antenna port quasi co-location (QCL) parameters for: monitoring a physical downlink control channel (PDCCH), receiving a physical downlink shared channel (PDSCH), and receiving a channel state information RS (CSI-RS) and determine, based on the q_new and the BFRR, a spatial domain filter for transmitting: a physical uplink control channel (PUCCH), a physical uplink shared channel (PUSCH), and a sounding RS (SRS). The q_new corresponds to a synchronization signal block (SSB) resource index or a CSI-RS resource configuration index.

In another embodiment, a base station (BS) is provided. The BS includes a transceiver configured to receive a q_new; transmit an indication of a unified TCI state; and transmit a BFRR. The BS further includes a processor operably coupled to the transceiver. The processor is configured to determine, based on the q_new and the BFRR, antenna port QCL parameters for transmitting: a PDCCH, a PDSCH, and a CSI-RS and determine, based on the q_new and the BFRR, a spatial domain filter for receiving: a PUCCH, a PUSCH, and a SRS. The q_new corresponds to a SSB resource index or a CSI-RS resource configuration index.

In yet another embodiment, a method for operating a UE is provided. The method includes transmitting a q_new, receiving an indication of a unified TCI state, and receiving a BFRR. The method further includes determining, based on the q_new and the BFRR, antenna port QCL parameters for: monitoring a PDCCH, receiving a PDSCH, and receiving a CSI-RS and determining, based on the q_new and the BFRR, a spatial domain filter for transmitting: a PUCCH, a PUSCH, and a SRS. The q_new corresponds to a SSB resource index or a CSI-RS resource configuration index.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of BFR procedure for a PCell or PSCell under the CA framework according to embodiments of the present disclosure;

FIG. 9 illustrates an example of SCell beam failure according to embodiments of the present disclosure;

FIG. 10 illustrates an example of MAC CE based unified/common TCI state/beam indication/update as a format/form of BFRR according to embodiments of the present disclosure;

FIG. 11 illustrates an example of DCI based unified/common TCI state/beam indication/update as a format/form of BFRR according to embodiments of the present disclosure;

FIG. 12 illustrates an example of DCI based unified/common TCI state/beam indication/update (with MAC CE based TCI states activation) as a format/form of BFRR according to embodiments of the present disclosure;

FIG. 13 illustrates an example of MAC CE based unified/common TCI state/beam indication/update as a format/form of BFRR for the multi-TRP operation according to embodiments of the present disclosure;

FIG. 14 illustrates an example of DCI based unified/common TCI state/beam indication/update as a format/form of BFRR for the multi-TRP operation according to embodiments of the present disclosure; and

FIG. 15 illustrates an example of DCI based unified/common TCI state/beam indication/update (with MAC CE based TCI states activation) as a format/form of BFRR for the multi-TRP operation according to embodiments of the present disclosure.

### DETAILED DESCRIPTION

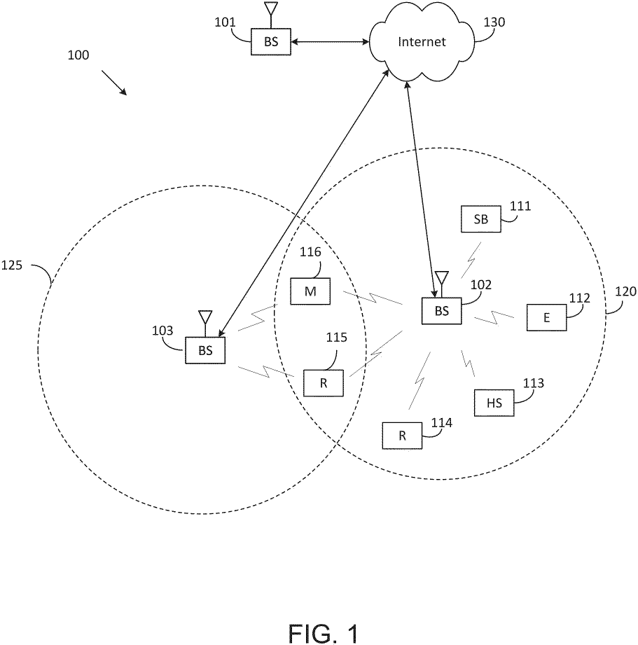

FIG. 1 through FIG. 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a beam recovery operation in a wireless communication system. In certain embodiments, and one or more of the gNBs 101-103 includes circuitry, programing, or a combination thereof, for a beam recovery operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

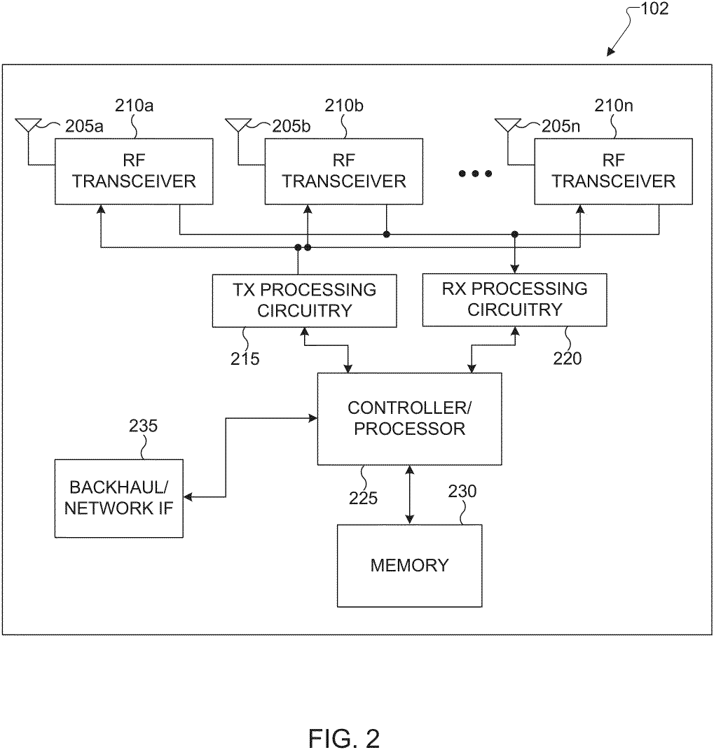

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support a beam recovery operation in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

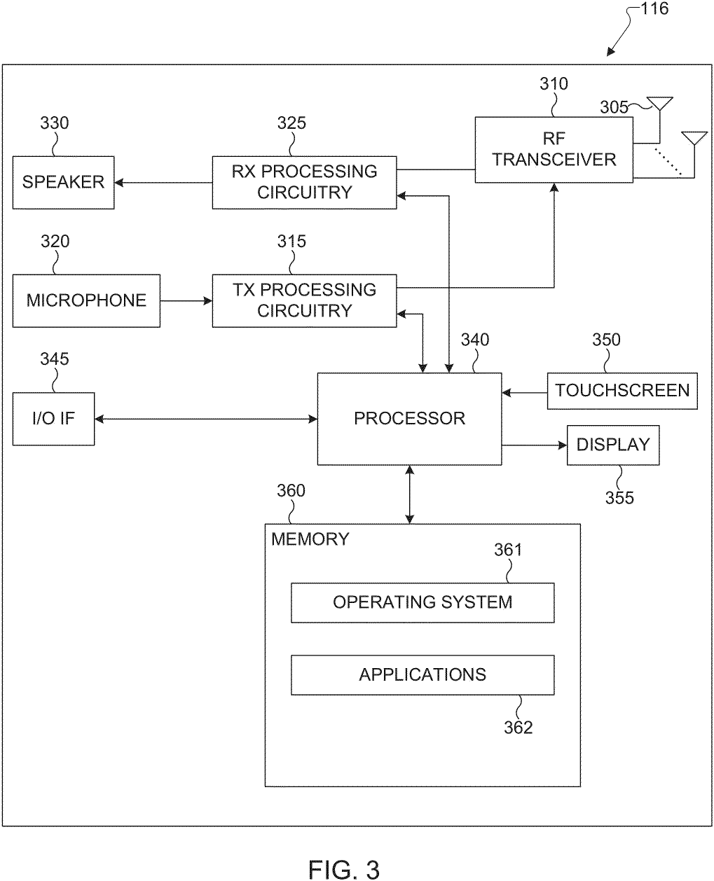

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and RX processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a beam recovery operation in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

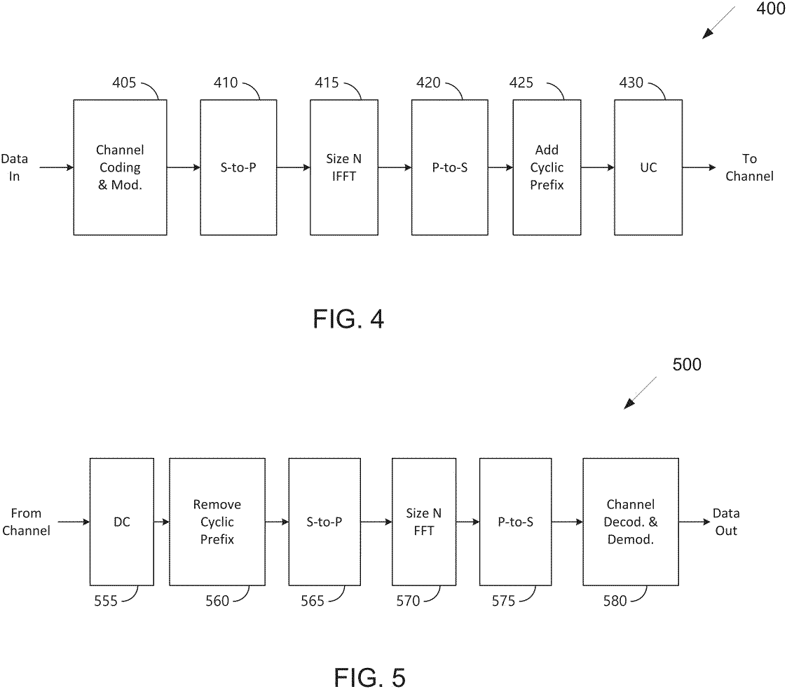

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel.

In the present disclosure, a beam is determined by either of: (1) a TCI state, which establishes a QCL relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

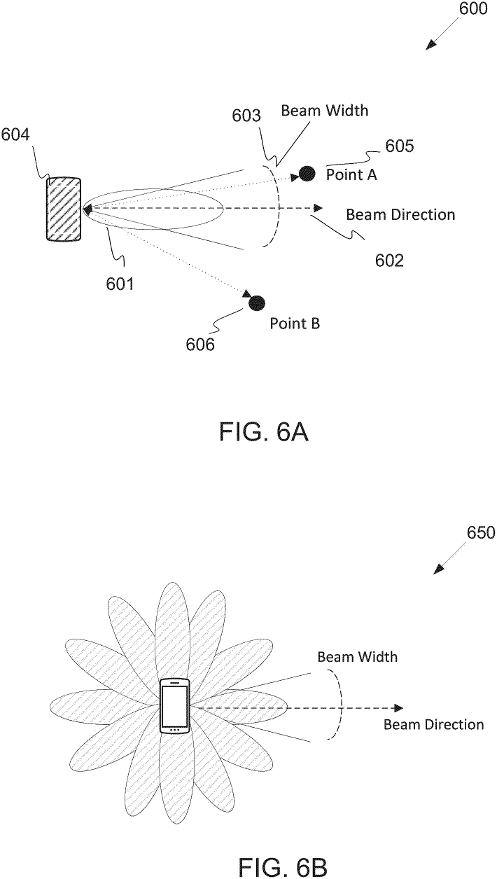

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

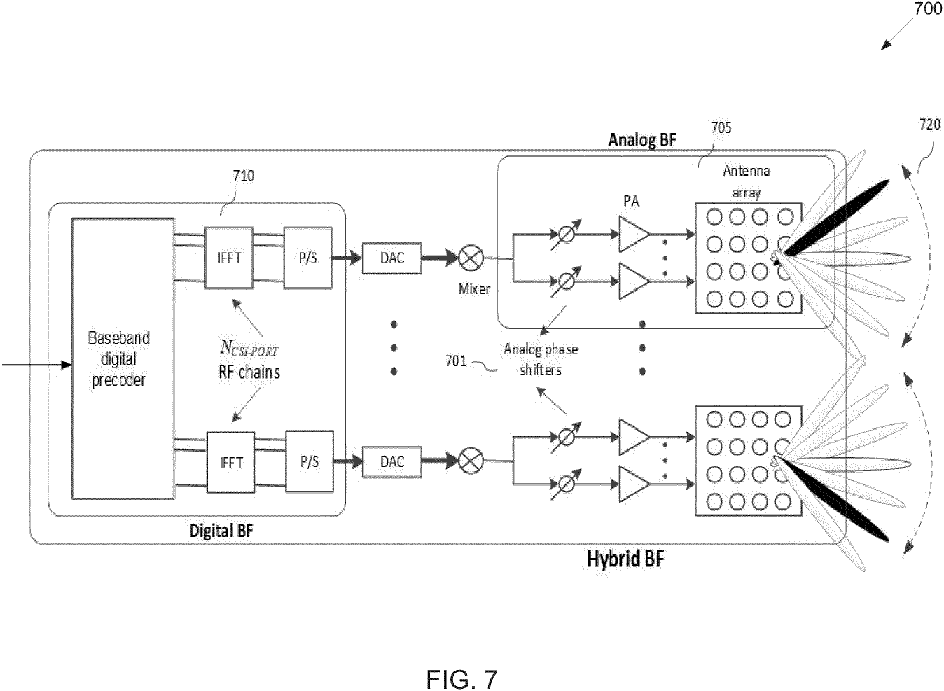

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports —which can correspond to the number of digitally precoded ports - tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration - to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (∼10 dB additional loss @100 m distance), larger number of and sharper analog beams (hence larger number of radiators in the array) may be needed to compensate for the additional path loss.

In a wireless communications system, a radio link failure (RLF) could occur if a significant/sudden link quality drop is observed at the UE side. If a RLF occurs, fast RLF recovery mechanisms, therefore, become essential to promptly re-establish the communication link(s) and avoid severe service interruption. At higher frequencies, e.g., millimeter-wave (mmWave) frequencies or FR2 in the 3 GPP NR, both the transmitter and receiver could use directional (analog) beams to transmit and receive various RSs/channels such as SSBs, CSI-RSs, PDCCHs or PDSCHs. Hence, prior to declaring a full RLF, the UE could first detect and recover a potential beam failure if the signal qualities/strengths of certain beam pair links (BPLs) are below a certain threshold for a certain period of time.

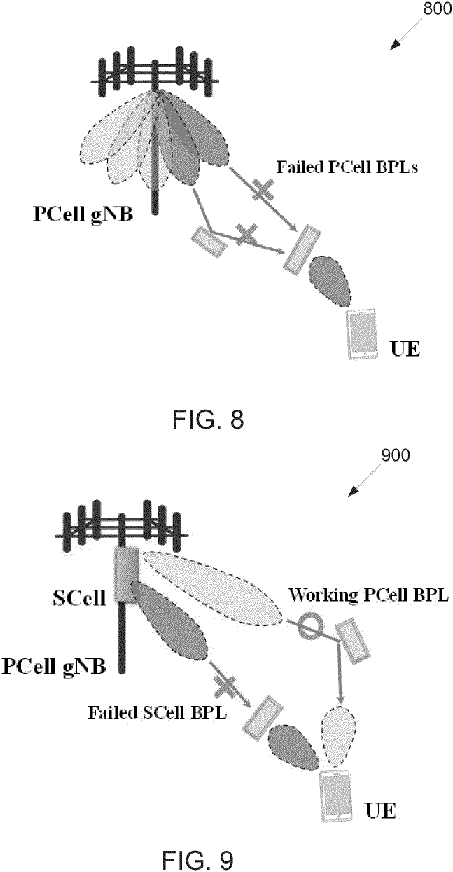

FIG. 8 illustrates an example of BFR procedure for a PCell or PSCell under the CA framework 800 according to embodiments of the present disclosure. An embodiment of the BFR procedure for a PCell or PSCell under the CA framework 800 shown in FIG. 8 is for illustration only.

The 3 GPP Rel. 15 beam failure recovery (BFR) procedure mainly targets for a primary cell (PCell or PSCell) under the carrier aggregation (CA) framework (e.g., as illustrated in FIG. 8). The BFR procedure in the 3 GPP Rel. 15 comprises the following key components: (1) a beam failure detection (BFD); (2) a new beam identification (NBI); (3) a BFR request (BFRQ); and (4) a BFRQ response (BFRR).

The UE is first configured by the gNB a set of BFD RS resources to monitor the link qualities between the gNB and the UE. One BFD RS resource could correspond to one (periodic) CSI-RS/SSB RS resource, which could be a quasi-co-located (QCL) source RS with typeD in a TCI state for a CORESET. If the received signal qualities of all the BFD RS resources are below a given threshold (implying that the hypothetical BLERs of the corresponding CORESETs/PDCCHs are a given threshold), the UE could declare a beam failure instance (BFI). Furthermore, if the UE has declared N_BFI consecutive BFIs within a given time period, the UE may declare a beam failure.

After declaring/detecting the beam failure, the UE may transmit the BFRQ to the gNB via a contention-free (CF) PRACH (CF BFR-PRACH) resource, whose index is associated with a new beam identified by the UE. Specifically, to determine a potential new beam, the UE could be first configured by the network a set of SSB and/or CSI-RS resources (NBI RS resources) via a higher layer parameter candidateBeamRSList. The UE may then measure the NBI RSs and calculate their L1-RSRPs. If at least one of the measured L1-RSRPs of the NBI RSs is beyond a given threshold, the UE may select the beam that corresponds to the NBI RS with the highest L1-RSRP as the new beam.

To determine a CF BFR-PRACH resource to convey the BFRQ, the UE could be first configured by the network a set of PRACH resources, each associated with a NBI RS resource. The UE could then select the PRACH resource that has the one-to-one correspondence to the selected NBI RS resource (the new beam) to send the BFRQ to the gNB. From the index of the selected CF PRACH resource, the gNB could also know which beam is selected by the UE as the new beam.

Four slots after the UE has transmitted the BFRQ, the UE could start to monitor a dedicated CORESET/search space for BFRQ response. The dedicated CORESET is addressed to the UE-specific C-RNTI and may be transmitted by the gNB using the newly identified beam. If the UE detects a valid UE-specific DCI in the dedicated CORESET for BFRR, the UE may assume that the beam failure recovery request has been successfully received by the network, and the UE may complete the BFR process. Otherwise, if the UE does not receive the BFRR within a configured time window, the UE may initiate a contention based (CB) random access (RA) process to reconnect to the network.

FIG. 9 illustrates an example of SCell beam failure 900 according to embodiments of the present disclosure. An embodiment of the SCell beam failure 900 shown in FIG. 9 is for illustration only.

In the 3GPP Rel. 16, the BFR procedures were customized for the secondary cell (SCell) under the CA framework, in which the BPL(s) between the PCell and the UE is assumed to be always working. An illustrative example of the SCell beam failure is given in FIG. 9.

After declaring/detecting the beam failure for the SCell, the UE may transmit the BFRQ in form of a scheduling request (SR) over a PUCCH for the working PCell. Furthermore, the UE could only transmit the BFRQ at this stage without indicating any new beam index, failed SCell index or other information to the network. This is different from the Rel. 15 PCell/PSCell procedure, in which the UE may indicate both the BFRQ and the identified new beam index to the network at the same time. Allowing the gNB to quickly know the beam failure status of the SCell without waiting for the UE to identify a new beam could be beneficial. For instance, the gNB could deactivate the failed SCell and allocate the resources to other working SCells.

The UE could be indicated by the network an uplink grant in response to the BFRQ SR, which may allocate necessary resources for the MAC CE to carry new beam index (if identified), failed SCell index and etc. over the PUSCH for the working PCell. After transmitting the MAC CE for BFR (e.g., via a message 3 (Msg3) or message A (MsgA)) to the working PCell, the UE may start to monitor the BFRR. The BFRR could be a TCI state indication for a CORESET for the corresponding SCell. The BFRR to the MAC CE for BFR could also be a normal uplink grant for scheduling a new transmission for the same HARQ process as the PUSCH carrying the MAC CE for BFR. If the UE could not receive the BFRR within a configured time window, the UE could transmit BFR-PUCCH again, or fall back to CBRA process.

In the current 3GPP Rel. 15/16 based BFR designs, the UE may apply the new beam X symbols after the UE has received the BFRR, and the new beam applies only to the control channels such as PDCCH and PUCCH. For example, X symbols after the UE has received the BFRR, the UE may assume that the network uses the new beam to transmit the PDCCH(s), and the UE may accordingly set the receive spatial filter to receive the PDCCH(s). For another example, X symbols after the UE has received the BFRR, the UE may apply the same spatial filter as that for receiving the new beam to transmit the PUCCH. In the 3GPP Rel. 17, a unified TCI framework is specified, wherein common beam indication is introduced for all DL and UL channels (both data and control). Hence, for BFR, the new beam may be applied to all DL and UL data and control channels such as PDCCH, PDSCH, PUCCH and PUSCH as well.

The present disclosure provides various design aspects for beam updating after the BFR process has been completed. Specifically, the beam updating follows the unified TCI framework specified in Rel. 17, wherein a common beam indication is applied for all DL and UL channels.

As described in the U.S. Pat. Application No. 17/584,239 as incorporated by reference herein in its entirety, a unified TCI framework could indicate/include N≥ 1 DL TCI states and/or M≥ 1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the U.S. Pat. Application No. 17/584,239 as incorporated by reference herein in its entirety.

In one example, a MAC CE could be used to indicate to the UE a beam (i.e., a TCI state and/or a TCI state ID) for the transmission/reception of a PDCCH or a PDSCH.

In another example, a DCI could be used to indicate to the UE a beam (i.e., a TCI state and/or a TCI state ID) for the transmission/reception of a PDCCH or a PDSCH.

For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.

For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.

Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state can be used at least for UE-dedicated DL channels; or (3) in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

As discussed herein, a UE could be provided by the network, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination ofN> 1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources.

Throughout the present disclosure, the term “configuration” or “higher layer configuration” and variations thereof (such as “configured” and so on) could be used to refer to one or more of: a system information signaling such as by a MIB or a SIB (such as SIB1), a common or cell-specific higher layer / RRC signaling, or a dedicated or UE-specific or BWP-specific higher layer / RRC signaling.

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Typel for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values: (1) ‘typeA’: {Doppler shift, Doppler spread, average delay, delay spread}, (2) ‘typeB’: {Doppler shift, Doppler spread}, (3) ‘typeC’: {Doppler shift, average delay}, and (4) ‘typeD’: {Spatial Rx parameter}.

The UE can be configured with a list of up to 128 DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS.

If the DLorJointTCIState or UL-TCIState configurations are absent in a BWP of the CC, the UE can apply the DLorJointTCIState or UL-TCIState configurations from a reference BWP of a reference CC. The UE is not expected to be configured with TCI-State, SpatialRelationInfo or PUCCH-SpatialRelationInfo, except SpatialRelationlnfoPos in a CC in a band, if the UE is configured with DLorJointTCIState or UL-TCIState in any CC in the same band. The UE can assume that when the UE is configured with TCI-State in any CC in the CC list configured by simultaneousTCI-UpdateList1-r16, simultaneousTCI UpdateList2-r16, simultaneousSpatial-UpdatedList1-r16, or simultaneousSpatial-UpdatedList2-r16, the UE is not configured with DLorJointTCIState or UL-TCIState in any CC within the same band in the CC list.

The UE receives an activation command, as described in clause 6.1.3.14 of [10, TS 38.321] or 6.1.3.x of [10, TS 38.321], used to map up to 8 TCI states and/or pairs of TCI states, with one TCI state for DL channels/signals and one TCI state for UL channels/signals to the codepoints of the DCI field ‘Transmission Configuration Indication’ for one or for a set ofCCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.

The Unified TCI States Activation/Deactivation MAC CE is identified by a MAC subheader with eLCID as specified in Table 6.2.1-1b in TS 38.321. It has a variable size consisting of one or more of the following fields: (1) serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI UpdateList3 or simultaneousU-TCI-UpdateList4 as specified in TS 38.331, this MAC CE applies to all theServing Cells in the set simultaneousU-TCI-UpdateList1, simultaneousU-TCI-UpdateList2, simultaneousU- TCI UpdateList3 or simultaneousU-TCI-UpdateList4, respectively; (2) DL BWP ID: This field indicates a DL BWP for which the MAC CE applies as the codepoint of the DCI bandwidth part indicator field as specified in TS 38.212. The length of the BWP ID field is 2 bits; (3) UL BWP ID: This field indicates a UL BWP for which the MAC CE applies as the codepoint of the DCI bandwidth part indicator field as specified in TS 38.212. The length of the BWP ID field is 2 bits; (4) Pᵢ: This field indicates whether each TCI codepoint has multiple TCI states or single TCI state. If Pᵢ field set to 1, it indicates that i^{th} TCI codepoint includes the DL TCI state and the UL TCI state. If Pᵢ field set to 0, it indicates that i^{th} TCI codepoint includes only the DL TCI state or the UL TCI state; (5) D/U: This field indicate whether the TCI state ID in the same octet is for joint/downlink or uplink TCI state. If this field is set to 1, the TCI state ID in the same octet is for j oint/downlink. If this field is set to 0, the TCI state ID in the same octet is for uplink; (6) TCI state ID: This field indicates the TCI state identified by TCI-StateId as specified in TS 38.331. If D/U is set to 1, 7-bits length TCI state ID i.e. TCI-StateId as specified in TS 38.331 is used. If D/U is set to 0, the most significant bit of TCI state ID is considered as the reserved bit and remainder 6 bits indicate the UL-TCIState-Id as specified in TS 38.331. The maximum number of activated TCI states is 16; (7) R: Reserved bit, set to 0.

The CellGroupConfig IE specified in the TS 38.331 is used to configure a master cell group (MCG) or secondary cell group (SCG). A cell group comprises of one MAC entity, a set of logical channels with associated RLC entities and of a primary cell (SpCell) and one or more secondary cells (SCells).

simultaneousTCI-UpdateList1, simultaneousTCI-UpdateList2 are list of serving cells which can be updated simultaneously for TCI relation with a MAC CE. The simultaneousTCI-UpdateList1 and simultaneousTCI-UpdateList2 shall not contain same serving cells. Network should not configure serving cells that are configured with a BWP with two different values for the coresetPoollndex in these lists.

simultaneousU-TCI-UpdateList1, simultaneousU-TCI- UpdateList2, simultaneousU-TCI-UpdateList3, simultaneousU-TCI-UpdateList4 are list of serving cells for which the Unified TCI States Activation/Deactivation MAC CE applies simultaneously, as specified in [TS 38.321 v17.1.0 clause 6.1.3.47]. The different lists shall not contain same serving cells. Network only configures in these lists serving cells that are configured with unifiedtci-StateType.

When the bwp-id or cell for QCL-TypeA/D source RS in a QCL-Info of the TCI state configured with DLorJointTCIState is not configured, the UE assumes that QCL-TypeA/D source RS is configured in the CC/DL BWP where TCI state applies.

When tci-PresentInDCIis set as ‘enabled’ or tci-PresentDCI-1-2 is configured for the CORESET, the UE with activated DLorJointTCIState or UL-TCIState receives DCI format 1_1/1_2 providing indicated DLorJointTCIState or UL-TCIState for a CC or all CCs in the same CC list configured by simultaneousTCI- UpdateList1-r17, simultaneousTCI-UpdateList2-r17, simultaneousTCI-UpdateList3-r17, simultaneousTCI- UpdateList4-r17. The DCI format 1_1/1_2 can be with or without, if applicable, DL assignment. If the DCI format 1_1/1_2/ is without DL assignment, the UE can assume the following: (1) CS-RNTI is used to scramble the CRC for the DCI, (2) the values of the following DCI fields are set as follows: RV = all ‘1’s, MCS = all ‘1’s, NDI = 0, and set to all ‘0’s for FDRA Type 0, or all ‘1’s for FDRA Type 1, or all ‘0’s for dynamicSwitch (same as in Table 10.2-4 of [6, TS 38.213]).

After a UE receives an initial higher layer configuration of more than one DLorJoint-TCIState and before application of an indicated TCI state from the configured TCI states: the UE assumes that DM-RS of PDSCH and DM-RS of PDCCH and the CSI-RS applying the indicated TCI state are quasi co-located with the SS/PBCH block the UE identified during the initial access procedure.

After a UE receives an initial higher layer configuration of more than one DLorJoint-TCIState or UL-TCIState and before application of an indicated TCI state from the configured TCI states: the UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during the initial access procedure.

After a UE receives a higher layer configuration of more than one DLorJoint-TCIState as part of a Reconfiguration with sync procedure as described in [12, TS 38.331] and before applying an indicated TCI state from the configured TCI states: the UE assumes that DM-RS of PDSCH and DM-RS of PDCCH, and the CSI-RS applying the indicated TCI state are quasi co-located with the SS/PBCH block or the CSI-RS resource the UE identified during the random access procedure initiated by the Reconfiguration with sync procedure as described in [12, TS 38.331].

After a UE receives a higher layer configuration of more than one DLorJoint-TCIState or UL-TCIState as part of a Reconfiguration with sync procedure as described in [12, TS 38.331] and before applying an indicated TCI state from the configured TCI states: the UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during random access procedure initiated by the Reconfiguration with sync procedure as described in [12, TS 38.331].

If a UE receives a higher layer configuration of a single DLorJoint-TCIState, that can be used as an indicated TCI state, the UE obtains the QCL assumptions from the configured TCI state for DM-RS of PDSCH and DM-RS of PDCCH, and the CSI -RS applying the indicated TCI state.

If a UE receives a higher layer configuration of a single DLorJoint-TCIState or UL-TCIState, that can be used as an indicated TCI state, the UE determines an UL TX spatial filter, if applicable, from the configured TCI state for dynamic-grant and configured-grant based PUSCH and PUCCH, and SRS applying the indicated TCI state.

When the UE would transmit the last symbol of a PUCCH with HARQ-ACK information corresponding to the DCI carrying the TCI State indication and without DL assignment, or corresponding to the PDSCH scheduling by the DCI carrying the TCI State indication, and if the indicated TCI State is different from the previously indicated one, the indicated DLorJointTCIState or UL-TCIstate should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

If a UE is configured with pdsch-TimeDomainAllocationListForMultiPDSCH-r17 in which one or more rows contain multiple SLIVs for PDSCH on a DL BWP of a serving cell, and the UE is receiving a DCI carrying the TCI-State indication and without DL assignment, the UE does not expect that the number of indicated SLIVs in the row of the pdsch-TimeDomainAllocationListForMultiPDSCHr17 by the DCI is more than one.

If the UE is configured with NumberOfAdditionalPCI and with PDCCH-Config that contains two different values of coresetPoollndex in ControlResourceSet, the UE receives an activation command for CORESET associated with each coresetPoollndex, as described in clause 6.1.3.14 of [10, TS 38.321], used to map up to 8 TCI states to the codepoints of the DCI field ‘Transmission Configuration Indication’ in one CC/DL BWP. When a set of TCI state IDs are activated for a coresetPoollndex, the activated TCI states corresponding to one coresetPoollndex can be associated with one physical cell ID and activated TCI states corresponding to another coresetPoollndex can be associated with another physical cell ID.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n +

$$3 {N}_{s l o t}^{s u b f r a m e , μ}$$

+

$$\frac{{2}^{μ}}{{2}^{{μ}_{K}} m a c}$$

▪ k_{mac} where m is the SCS configuration for the PUCCH and ^{µ}K_{mac} is the subcarrier spacing configuration for k_{mac} with a value of 0 for frequency range 1, and k_{mac} is provided by K-Mac or k_{mac} = 0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling a PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

When a UE is configured with both sfnSchemePdcch and sfnSchemePdsch scheduled by DCI format 1_0 or by DCI format 1_1/1_2, if the time offset between the reception of the DL DCI and the corresponding PDSCH of a serving cell is equal to or greater than a threshold timeDurationForQCL if applicable: if the UE supports DCI scheduling without TCI field, the UE assumes that the TCI state(s) or the QCL assumption(s) for the PDSCH is identical to the TCI state(s) or QCL assumption(s) whichever is applied for the CORESET used for the reception of the DL DCI within the active BWP of the serving cell regardless of the number of active TCI states of the CORESET. If the UE does not support dynamic switching between SFN PDSCH and non-SFN PDSCH, the UE should be activated with the CORESET with two TCI states; else if the UE does not support DCI scheduling without TCI field, the UE shall expect TCI field present when scheduled by DCI format 1_1/1_2.

When a UE is configured with sfnSchemePdsch and sfnSchemePdcch is not configured, when scheduled by DCI format 1_1/1_2, if the time offset between the reception of the DL DCI and the corresponding PDSCH of a serving cell is equal to or greater than a threshold timeDurationForQCL if applicable, the UE shall expect TCI field present.

For PDSCH scheduled by DCI format 1_0, 1_1, 1_2, when a UE is configured with sfnSchemePdcch set to ‘sfnSchemeA’ and sfnSchemePdsch is not configured, and there is no TCI codepoint with two TCI states in the activation command, and if the time offset between the reception of the DL DCI and the corresponding PDSCH is equal or larger than the threshold timeDurationForQCL if applicable and the CORESET which schedules the PDSCH is indicated with two TCI states, the UE assumes that the TCI state or the QCL assumption for the PDSCH is identical to the first TCI state or QCL assumption which is applied for the CORESET used for the PDCCH transmission within the active BWP of the serving cell.

If a PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [13, TS 38.306]. For a single slot PDSCH, the indicated TCI state(s) should be based on the activated TCI states in the slot with the scheduled PDSCH. For a multi-slot PDSCH or the UE is configured with higher layer parameterpdsch-TimeDomainAllocationListForMultiPDSCHr17, the indicated TCI state(s) should be based on the activated TCI states in the first slot with the scheduled PDSCH(s), and UE shall expect the activated TCI states are the same across the slots with the scheduled PDSCH(s). When the UE is configured with CORESET associated with a search space set for cross-carrier scheduling and the UE is not configured with enableDefaultBeamForCCS, the UE expects tci-PresentInDCIis set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and a corresponding PDSCH is larger than or equal to the threshold timeDurationForQCL.

Independent of the configuration of tciPresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

Independent of the configuration of tciPresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, If a UE is configured with enableDefaultTCI-StatePerCoresetPoolIndex and the UE is configured by higher layer parameter PDCCH-Config that contains two different values of coresetPoolIndex in different ControlResourceSets, the UE may assume that the DM-RS ports of PDSCH associated with a value of coresetPoollndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoollndex as the PDCCH scheduling that PDSCH, in the latest slot in which one or more CORESETs associated with the same value of coresetPoollndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same value of coresetPoollndex, the UE is expected to prioritize the reception of PDCCH associated with that CORESET. This also applies to the intra-band CA case (when PDSCH and the CORESET are in different component carriers).

Independent of the configuration of tciPresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 in TS 38.214 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

Independent of the configuration of tciPresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, if a UE is not configured with sfnSchemePdsch, and the UE is configured with sfnSchemePdcch set to ‘sfnSchemeA’ and there is no TCI codepoint witih two TCI states in the activation command and the CORESET with the lowest ID in the latest slot is indicated with two TCI states, the UE may assume that the DM-RS ports of PDSCH of a serving cell are quasi co-located with the RS(s) with respect to the QCL parameter(s) associated with the first TCI state of two TCI states indicated for the CORESET.

Independent of the configuration of tciPresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, in all cases above, if none of configured TCI states for the serving cell of scheduled PDSCH is configured with qcl-Type set to ‘typeD’, the UE shall obtain the other QCL assumptions from the indicated TCI state(s) for its scheduled PDSCH irrespective of the time offset between the reception of the DL DCI and the corresponding PDSCH.

If the PDCCH carrying the scheduling DCI is received on one component carrier, and a PDSCH scheduled by that DCI is on another component carrier: (1) the timeDurationForQCL is determined based on the subcarrier spacing of the scheduled PDSCH. If ^{µ}_{PDCCH} < ^{µ}_{PDSCH} an additional timing delay

$$d \frac{{2}^{μ P D S C H}}{{2}^{μ P D C C H}}$$

is added to the timeDurationForQCL, where d is defined in 5.2.1.5.1a-1 in TS 38.214, otherwise d is zero; or (2) when the UE is configured with enableDefaultBeamForCCS, if the offset between the reception of the DL DCI and the corresponding PDSCH is less than the threshold timeDurationForQCL, or if the DL DCI does not have the TCI field present, the UE obtains its QCL assumption for the scheduled PDSCH from the activated TCI state with the lowest ID applicable to PDSCH in the active BWP of the scheduled cell.

A UE that has indicated a capability beamCorrespondenceWithoutUL-BeamSweeping set to ‘1’, as described in [18, TS 38.822], can determine a spatial domain filter to be used while performing the applicable channel access procedures described in [16, TS 37.213] to transmit a UL transmission on the channel as follows: (1) if UE is indicated with an SRI corresponding to the UL transmission, the UE may use a spatial domain filter that is same as the spatial domain transmission filter associated with the indicated SRI, or (2) if UE is configured with TCI-State configurations with DLorJointTCIState or UL-TCIState, the UE may use a spatial domain transmit filter that is same as the spatial domain receive filter the UE may use to receive the DL reference signal associated with the indicated TCI state.

When the PDCCH reception includes two PDCCH from two respective search space sets, as described in clause 10.1 of [6, TS 38.213], for the purpose of determining the time offset between the reception of the DL DCI and the corresponding PDSCH, the PDCCH candidate that ends later in time is used. When the PDCCH reception includes two PDCCH candidates from two respective search space sets, as described in clause 10.1 of [6, TS 38.213], for the configuration of tci-PresentInDCI or tci-PresentDCI-1-2, the UE expects the same configuration in the first and second CORESETs associated with the two PDCCH candidates; and if the PDSCH is scheduled by a DCI format not having the TCI field present and if the scheduling offset is equal to or larger than timeDurationForQCL, if applicable, PDSCH QCL assumption is based on the CORESET with lower ID among the first and second CORESETs associated with the two PDCCH candidates.

For a periodic CSI-RS resource in an NZP-CSI-RS-ResourceSet configured with higher layer parameter trs-Info, the UE shall expect that a TCI-State indicates one of the following quasi co-location type(s): (1) 'typeC' with an SS/PBCH block and, when applicable, 'typeD' with the same SS/PBCH block, or (2) 'typeC' with an SS/PBCH block and, when applicable,'typeD' with a CSI-RS resource in an NZP-CSI-RS-ResourceSet configured with higher layer parameter repetition.

For periodic/semi-persistent CSI-RS, the UE can assume that the indicated DLorJointTCIState is not applied.

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s): (1) 'typeA' with a CSI-RS resource in a NZP-CSI-RS-ResourceSet configured with higher layer parameter trs-Info and, when applicable, 'typeD' with the same CSI-RS resource, (2) 'typeA' with a CSI-RS resource in a NZP-CSI-RS-ResourceSet configured with higher layer parameter trs-Info and, when applicable, 'typeD' with an SS/PBCH block, (3) 'typeA' with a CSI-RS resource in a NZP-CSI-RS-ResourceSet configured with higher layer parameter trs-Info and, when applicable, 'typeD' with a CSI-RS resource in a NZP-CSI-RS-ResourceSet configured with higher layer parameter repetition, or (4) 'typeB' with a CSI-RS resource in a NZP-CSI-RS-ResourceSet configured with higher layer parameter trs-Info when 'typeD' is not applicable.

For a CSI-RS resource in an NZP-CSI-RS-ResourceSet configured with higher layer parameter repetition, the UE shall expect that a TCI-State indicates one of the following quasi co-location type(s): (1) ‘typeA’ with a CSI-RS resource in aNZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, (3) ‘typeC’ with an S S/PBCH block and, when applicable, ‘typeD’ with the same SS/PBCH block, the reference RS may additionally be an SS/PBCH block having a PCI different from the PCI of the serving cell. The UE can assume center frequency, SCS, SFN offset are the same for SS/PBCH block from the serving cell and SS/PBCH block having a PCI different from the serving cell.

For the DM-RS of PDCCH, the UE shall expect that a TCI-State or DLorJointTCIState except an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or (3) ‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

When a UE is configured with sfnSchemePdcch set to ‘sfnSchemeA’, and CORESET is activated with two TCI states, the UE shall assume that the DM-RS port(s)of the PDCCH in the CORESET is quasi co-located with the DL-RSs of the two TCI states. When a UE is configured with sfnSchemePdcch set to ‘sfnSchemeB’, and a CORESET is activated with two TCI states, the UE shall assume that the DM-RS port(s)of the PDCCH is quasi co-located with the DL-RSs of the two TCI states except for quasi co-location parameters {Doppler shift, Doppler spread} of the second indicated TCI state.

For the DM-RS of PDSCH, the UE shall expect that a TCI-State or DLorJointTCIState except an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition,or (3) ‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDCCH, the UE shall expect that an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, or (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

For the DM-RS of PDSCH, the UE shall expect that an indicated DLorJointTCIState indicates one of the following quasi co-location type(s) if the UE is configured TCI-State(s) with tci-StateId r17: (1) ‘typeA’ with a CSI-RS resource in a NZP-CSI-RS-ResourceSet configured with higher layer parameter trs-Info and, when applicable, ‘typeD’ with the same CSI-RS resource, or (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

When a UE is configured with sfnSchemePdsch set to ‘sfnSchemeA’, and the UE is indicated with two TCI states in a codepoint of the DCI field ‘Transmission Configuration Indication’ in a DCI scheduling a PDSCH, the UE shall assume that the DM-RS port(s)of the PDSCH is quasi co-located with the DL-RSs of the two TCI states. When a UE is configured with sfnSchemePdsch set to ‘sfnSchemeB’, and the UE is indicated with two TCI states in a codepoint of the DCI field ‘Transmission Configuration Indication’ in a DCI scheduling a PDSCH, the UE shall assume that the DM-RS port(s)of the PDSCH is quasi co-located with the DL-RSs of the two TCI states except for quasi co-location parameters {Doppler shift, Doppler spread} of the second indicated TCI state.

Throughout the present disclosure, the joint (e.g., provided by DLorJoint-TCIState), separate DL (e.g., provided by DLorJoint-TCIState) and/or separate UL (e.g., provided by UL-TCIState) TCI states described/discussed herein could also be referred to as unified TCI states, common TCI states, main TCI states and etc.

A UE can be provided, for each BWP of a serving cell, a set q̅₀ of periodic CSI-RS resource configuration indexes by failureDetectionResourcesToAddModList and a set q̅₁ of periodic CSI-RS resource configuration indexes and/or SS/PBCH block indexes by candidateBeamRSList or candidateBeamRSListExt or candidateBeamRSSCellList for radio link quality measurements on the BWP of the serving cell. In the present disclosure, in a single-TRP system or for single-TRP operation, a BFD RS (beam) set could correspond to the set q̅₀ described herein, and a NBI RS (beam) set could correspond to the set q̅₁ described herein.

Instead of the sets q̅₀ and q̅₁ for each BWP of a serving cell, the UE can be provided respective two sets q̅_{0,0} and q̅_{0,1} of periodic CSI-RS resource configuration indexes that can be activated by a MAC CE [11 TS 38.321] and corresponding two sets q̅_{1,0} and q̅_{1,1} of periodic CSI-RS resource configuration indexes and/or SS/PBCH block indexes by candidateBeamRSList1 and candidateBeamRSList2, respectively, for radio link quality measurements on the BWP of the serving cell. The set q̅_{0,0} is associated with the set q̅_{1,0} and the set q̅_{0,1} is associated with the set q̅_{1,1}. In the present disclosure, in a multi-TRP system or for multi-TRP operation, the UE can be provided a BFD RS (beam) set p, where 1,2,...,N} and N denotes the total number of BFD RS (beam) sets configured/provided to the UE. For this case, the first BFD RS set or BFD RS set 1 (e.g., p=1) could correspond to the set q̅_{0,0} described herein, and the second BFD RS set or BFD RS set 2 (e.g., p=2) could correspond to the set described herein. In addition, the UE can be provided a NBI RS (beam) set p′, where

$$\text{p} ' ∈ \left\{1 , 2 , … , \text{M}\right\}$$

and M denotes the total number of NBI RS (beam) sets configured/provided to the UE. For this case, the first NBI RS set or NBI RS set 1 (e.g., p′=1) could correspond to the set q̅_{1,0} described herein, and the second NBI RS set or NBI RS set 2 (e.g., p′=2) could correspond to the set q̅_{1,1} described herein.

If the UE is not provided q̅₀ by failureDetectionResourcesToAddModList for a BWP of the serving cell, the UE determines the set q̅₀ to include periodic CSI-RS resource configuration indexes with same values as the RS indexes in the RS sets indicated by TCI-State for respective CORESETs that the UE uses for monitoring PDCCH. If the UE is not provided q̅_{0,0} or q̅_{0,1} for a BWP of the serving cell, the UE determines the set q̅_{0,0} or q̅_{0,1} to include periodic CSI-RS resource configuration indexes with same values as the RS indexes in the RS sets indicated by TCI-State for first and second CORESETs that the UE uses for monitoring PDCCH, where the UE is provided two coresetPoollndex values 0 and 1 for the first and second CORESETs, or is not provided coresetPoollndex value for the first CORESETs and is provided coresetPoollndex value of 1 for the second CORESETs, respectively. If there are two RS indexes in a TCI state, the set q̅₀ or q̅_{0,0} or q̅_{0,1} includes RS indexes configured with qcl-Type set to ‘typeD’ for the corresponding TCI states. In the present disclosure, in a single-TRP system or for single-TRP operation, a BFD RS (beam) set could correspond to the set q̅₀ described herein, and a NBI RS (beam) set could correspond to the set q̅₁ described herein. In the present disclosure, in a multi-TRP system or for multi-TRP operation, the UE can be provided a BFD RS (beam) set p, where p∈{1,2,...,N} and N denotes the total number of BFD RS (beam) sets configured/provided to the UE. For this case, the first BFD RS set or BFD RS set 1 (e.g., p=1) could correspond to the set q̅_{0,0} described herein, and the second BFD RS set or BFD RS set 2 (e.g., p=2) could correspond to the set q̅_{0,1} described herein. In addition, the UE can be provided a NBI RS (beam) set p′, where p′∈{ 1,2,...,M} and M denotes the total number of NBI RS (beam) sets configured/provided to the UE. For this case, the first NBI RS set or NBI RS set 1 (e.g., p′=1) could correspond to the set q̅_{1,0} described herein, and the second NBI RS set or NBI RS set 2 (e.g., p′=2) could correspond to the set q̅_{1,1} described herein.

If a CORESET that the UE uses for monitoring PDCCH includes two TCI states and the UE is provided sfnSchemePdcch set to ‘sfnSchemeA’ or ‘sfnSchemeB’, the set q̅₀ includes RS indexes in the RS sets associated with the two TCI states. The UE expects the set q̅₀ to include up to two RS indexes. If the UE is provided q̅_{0,0} or q̅_{0,1} the UE expects the set q̅_{0,0} or the set q̅_{0,1} to include up to a number of N_{BFD} RS indexes indicated by capabilityparametername. If the UE is not provided q̅_{0,0} or q̅_{0,1}, and if a number of active TCI states for PDCCH receptions in the first or second CORESETs is larger than N_{BFD}, the UE determines the set q̅_{0,0} or q̅_{0,1} to include periodic CSI-RS resource configuration indexes with same values as the RS indexes in the RS sets associated with the active TCI states for PDCCH receptions in the first or second CORESETs corresponding to search space sets according to an ascending order for monitoring periodicity. If more than one first or second CORESETs correspond to search space sets with same monitoring periodicity, the UE determines the order of the first or second CORESETs according to a descending order of a CORESET index.

If a UE is not provided coresetPoolIndex or is provided coresetPoollndex with a value of 0 for first CORESETs on an active DL BWP of a serving cell, and/or the UE is provided coresetPoollndex with a value of 1 for second CORESETs on the active DL BWP of the serving cells, and/or the UE is provided SSBMTCAdditionalPCI, SS/PBCH block indexes associated with a physical cell identity other than the one provided by physCellld in ServingCellConfigCommon can be provided in either q̅_{1,0} or q̅_{1,1} set and the corresponding q̅_{0,0} or q̅_{0,1} set is associated with the physical cell identity.

The UE expects single port RS in the set q̅₀, or q̅_{0,0}, or q̅_{0,1}. The UE expects single-port or two-port CSI-RS with frequency density equal to 1 or 3 REs per RB in the set q̅₁, or q̅_{1,0}, or q̅_{1,1}. The thresholds Q_{out,LR} and Q_{in,LR} correspond to the default value of rlmInSyncOutOfSyncThreshold, as described in [10, TS 38.133] for Qₒᵤₜ, and to the value provided by rsrp-ThresholdSSB or rsrp-ThresholdBFR, respectively.

The physical layer in the UE assesses the radio link quality according to the set q̅₀, q̅_{0,0}, or q̅_{0,1}, of resource configurations against the threshold Q_{out,LR}. For the set q̅₀, the UE assesses the radio link quality only according to SS/PBCH blocks on the PCell or the PSCell or periodic CSI-RS resource configurations that are quasi co-located, as described in [6, TS 38.214], with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

In non-DRX mode operation, the physical layer in the UE provides an indication to higher layers when the radio link quality for all corresponding resource configurations in the set q̅₀, or in the set q̅_{0,0} or q̅_{0,1} that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀, q̅_{0,0}, or q̅_{0,1} that the UE uses to assess the radio link quality and 2 msec. In DRX mode operation, the physical layer provides an indication to higher layers when the radio link quality is worse than the threshold Q_{out,LR} with a periodicity determined as described in [10, TS 38.133].

For the PCell or the PSCell, upon request from higher layers, the UE provides to higher layers the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold.

For the SCell, upon request from higher layers, the UE indicates to higher layers whether there is at least one periodic CSI-RS configuration index or SS/PBCH block index from the set q̅₁, or q̅_{1,0}, or q̅_{1,1} with corresponding L1-RSRP measurements that is larger than or equal to the Q_{in,LR} threshold, and provides the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold, if any.

For the PCell or the PSCell, a UE can be provided a CORESET through a link to a search space set provided by recoverySearchSpaceId, as described in clause 10.1, for monitoring PDCCH in the CORESET. If the UE is provided recoverySearchSpaceld, the UE does not expect to be provided another search space set for monitoring PDCCH in the CORESET associated with the search space set provided by recoverySearchSpaceld.

For the PCell or the PSCell, the UE can be provided, by PRACH-ResourceDedicatedBFR, a configuration for PRACH transmission as described in clause 8.1. For PRACH transmission in slot n and according to antenna port quasi co-location parameters associated with periodic CSI-RS resource configuration or with SS/PBCH block associated with index q_{new} provided by higher layers [11, TS 38.321], the UE monitors PDCCH in a search space set provided by recoverySearchSpaceId for detection of a DCI format with CRC scrambled by C-RNTI or MCS-C-RNTI starting from slot n + 4 + 2^{µ} ▪ k_{mac}, where µ is the SCS configuration for the PRACH transmission and k_{mac} is a number of slots provided by K-Mac [12, TS 38.331] or k_{mac} = 0 if K-Mac is not provided, within a window configured by BeamFailureRecoveryConfig. For PDCCH monitoring in a search space set provided by recoverySearchSpaceld and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTIin the search space set provided by recoverySearchSpaceld, the UE continues to monitor PDCCH candidates in the search space set provided by recoverySearchSpaceld until the UE receives a MAC CE activation command for a TCI state or tci-StatesPDCCHToAddList and/or tci-StatesPDCCH-ToReleaseList.

In the present disclosure, in a single-TRP system or for single-TRP operation, a BFD RS (beam) set could correspond to the set q̅₀ described herein, and a NBI RS (beam) set could correspond to the set q̅₁ described herein. In the present disclosure, in a multi-TRP system or for multi-TRP operation, the UE can be provided a BFD RS (beam) set p, where pʹ∈{1,2,...,N} and N denotes the total number of BFD RS (beam) sets configured/provided to the UE. For this case, the first BFD RS set or BFD RS set 1 (e.g., p=1) could correspond to the set q̅_{0,0} described herein, and the second BFD RS set or BFD RS set 2 (e.g., p=2) could correspond to the set q̅_{0,1} described herein. In addition, the UE can be provided a NBI RS (beam) set p′, where pʹ∈{ 1,2,...,M} and M denotes the total number of NBI RS (beam) sets configured/provided to the UE. For this case, the first NBI RS set or NBI RS set 1 (e.g., p′=1) could correspond to the set q̅_{1,0} described herein, and the second NBI RS set or NBI RS set 2 (e.g., p′=2) could correspond to the set q̅_{1,1} described herein.

As discussed herein, after the UE has sent to the network a BFRQ, the UE would monitor for a BFRR to the BFRQ. Under the unified TCI framework, the BFRR could be a common/unified TCI state indication/update described/discussed herein in the present disclosure for various DL and/or UL channels/signals such as PDCCH, PDSCH, PUCCH or PUSCH. In this case, the QCL source RS provided/indicated in the common/unified TCI state could be a SSB or a CSI-RS corresponding to the NBI RS with index q_new (also referred to as the new beam) selected/identified by the UE from the corresponding NBI RS (beam) set. Various channels to convey the common/unified TCI state indication/update for BFRR are presented as follows.

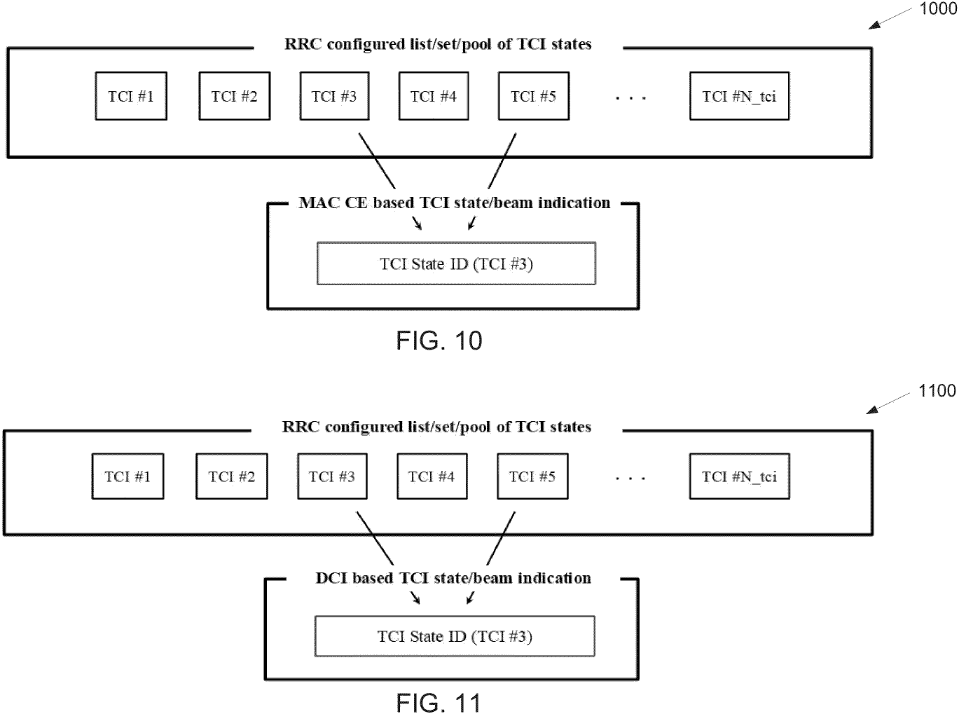

FIG. 10 illustrates an example of MAC CE based unified/common TCI state/beam indication/update as a format/form of BFRR 1000 according to embodiments of the present disclosure. An embodiment of the MAC CE based unified/common TCI state/beam indication/update as a format/form of BFRR 1000 shown in FIG. 10 is for illustration only.

In FIG. 10, an example of MAC CE based TCI state/beam indication for BFRR is presented. As illustrated in FIG. 10, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE commands to indicate one or more beam(s) (i.e., the TCI state(s)) for the transmission/reception of the PDCCH(s), PDSCH(s), PUCCH(s) or PUSCH(s).

The MAC CE for common TCI state/beam indication could include at least a TCI state ID. As discussed herein, the TCI state corresponding to the TCI state ID could be at least one of: (1) a DL TCI state; (2) an UL TCI state; (3) a joint DL and UL TCI state; or (4) separate DL TCI state and UL TCI state.

FIG. 11 illustrates an example of DCI based unified/common TCI state/beam indication/update as a format/form of BFRR 1100 according to embodiments of the present disclosure. An embodiment of the DCI based unified/common TCI state/beam indication/update as a format/form of BFRR 1100 shown in FIG. 11 is for illustration only.

In FIG. 11, an example of DCI based common TCI state/beam indication for BFRR is presented. As illustrated in FIG. 11, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more DCIs to indicate one or more beam(s) (i.e., the TCI state(s)) for the transmission/reception of the PDCCH(s), PDSCH(s), PUSCH(s) or PUCCH(s).

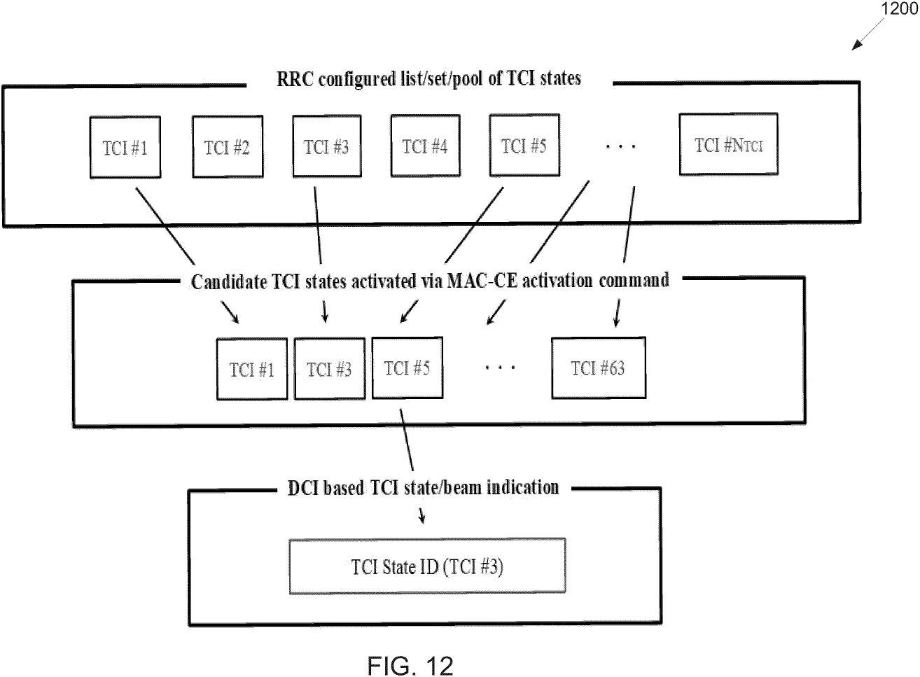

FIG. 12 illustrates an example of DCI based unified/common TCI state/beam indication/update (with MAC CE based TCI states activation) as a format/form of BFRR 1200 according to embodiments of the present disclosure. An embodiment of the DCI based unified/common TCI state/beam indication/update (with MAC CE based TCI states activation) as a format/form of BFRR 1200 shown in FIG. 12 is for illustration only.

In FIG. 12, an example of DCI based common TCI state/beam indication (with MAC CE activated TCI states) for BFRR is presented. As illustrated in FIG. 12, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE activation commands activating one or more TCI states from the higher layer configured list/pool of TCI states, e.g., up to eight TCI states could be activated by a MAC CE activation command. The UE could receive from the network one or more DCIs for beam indication to indicate one or more beam(s) (i.e., the TCI state(s)) from the MAC CE activated TCI state(s)/beam(s) for the transmission/reception of the PDCCH(s), PDSCH(s), PUCCH(s) or PUSCH(s).

As described herein, a DCI used to indicate to the UE a beam (i.e., a TCI state and/or a TCI state ID) for the transmission/reception of a PDCCH or a PDSCH could be at least one of the following examples.

In one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.

In another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.

Yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for beam indication could be at least one of: (1) a DL TCI state; (2) an UL TCI state; (3) a joint DL and UL TCI state; or (4) separate DL TCI state and UL TCI state.

The BFRR could be a common DL TCI state indication for both PDCCH and PDSCH. The NBI RS corresponding to the new beam q_new is indicated as the QCL source RS in the common DL TCI state. The UE could be indicated by the network the common DL TCI state via the MAC CE based or DCI based (with or without MAC CE activation) common beam indication strategy discussed herein.

In one example, for the DL channels, X symbols after receiving the BFRR (i.e., the common DL TCI state indication for both PDCCH and PDSCH), the UE may assume/expect that the network may apply/use the new beam to transmit the subsequent PDCCH(s) and PDSCH(s) until the UE receives a TCI state update for the PDCCH(s) or PDSCH(s). That is, X symbols after receiving the BFRR (i.e., the common DL TCI state indication for both PDCCH and PDSCH), the UE may apply the same receive filter as that for receiving the new beam to receive the DL channels PDCCH(s) and PDSCH(s) until the UE receives a TCI state update for the PDCCH(s) or PDSCH(s).

In another example, for the DL channels, X symbols after receiving the BFRR (i.e., the common DL TCI state indication for both PDCCH and PDSCH), the UE may assume/expect that the network may apply/use the new beam to transmit the subsequent PDCCH(s) until the UE receives a TCI state update for the PDCCH(s). That is, X symbols after receiving the BFRR (i.e., the common DL TCI state indication for both PDCCH and PDSCH), the UE may apply the same receive filter as that for receiving the new beam to receive the PDCCH(s) until the UE receives a TCI state update for the PDCCH(s). Furthermore, Y symbols after receiving the BFRR (i.e., the common DL TCI state indication for both PDCCH and PDSCH), the UE may assume/expect that the network may apply/use the new beam to transmit the subsequent PDSCH(s) until the UE receives a TCI state update for the PDSCH(s). That is, Y symbols after receiving the BFRR (i.e., the common DL TCI state indication for both PDCCH and PDSCH), the UE may apply the same receive filter as that for receiving the new beam to receive the PDSCH(s) until the UE receives a TCI state update for the PDSCH(s). Here, Y could be different from X.

In yet another example, for the DL channels, the UE could receive from the network an indicator indicating whether the new beam q_new indicated in the common DL TCI state may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X symbols after receiving the BFRR (i.e., the common DL TCI state indication for both PDCCH and PDSCH), the UE may apply the same receive filter as that for receiving the new beam to receive the subsequent PDCCH(s) until the UE receives a TCI state update for the PDCCH(s). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR, i.e., the common DL TCI state indication for both PDCCH and PDSCH via MAC CE or DCI for common beam indication, to receive the subsequent PDSCH(s) until the UE receives a TCI state update for the PDSCH(s).

If the one-bit indicator is set to “1,” Y symbols after receiving the BFRR (i.e., the common DL TCI state indication for both PDCCH and PDSCH), the UE may assume/expect that the network may apply/use the new beam to transmit the subsequent PDSCH(s) until the UE receives a TCI state update for the PDSCH(s). That is, Y symbols after receiving the BFRR (i.e., the common DL TCI state indication for both PDCCH and PDSCH), the UE may apply the same receive filter as that for receiving the new beam to receive the PDSCH(s) until the UE receives a TCI state update for the PDSCH(s). Here, Y could be the same as or different from X.

For another example, Y symbols after receiving the BFRR (i.e., the common DL TCI state indication for both PDCCH and PDSCH), the UE may apply the same receive filter as that for receiving the new beam to receive the subsequent PDSCH(s) until the UE receives a TCI state update for the PDSCH(s). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR, i.e., the common DL TCI state indication for both PDCCH and PDSCH via MAC CE or DCI for common beam indication, to receive the subsequent PDCCH(s) until the UE receives a TCI state update for the PDCCH(s).

If the one-bit indicator is set to “1,” X symbols after receiving the BFRR (i.e., the common DL TCI state indication for both PDCCH and PDSCH), the UE may assume/expect that the network may apply/use the new beam to transmit the subsequent PDCCH(s) until the UE receives a TCI state update for the PDCCH(s). That is, X symbols after receiving the BFRR (i.e., the common DL TCI state indication for both PDCCH and PDSCH), the UE may apply the same receive filter as that for receiving the new beam to receive the PDCCH(s) until the UE receives a TCI state update for the PDCCH(s). Here, X could be the same as or different from Y.

The UE could receive from the network an indicator indicating whether the new beam indicated in the BFRR, i.e., the common DL TCI state for both PDCCH and PDSCH, may be applied to at least one of PUCCH and PUSCH; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. For instance, the UE could receive from the network a one-bit indicator with “0”/absent indicating that the new beam may not be applied to the subsequent PUCCH and PUSCH transmissions, and “1” indicating that the new beam may be applied to at least one of subsequent PUCCH and PUSCH transmissions. If the new beam q_new indicated in the BFRR (i.e., the common DL TCI state indicated for both PDCCH and PDSCH) may be applied to at least one of PUCCH and PUSCH,

In one example, K symbols after receiving the BFRR (i.e., the common DL TCI state indication for both PDCCH and PDSCH), the UE may apply a transmit filter same as the receive filter for receiving the new beam to transmit the UL channels PUCCH(s) and PUSCH(s) until the UE receives a TCI state/spatial relation information update for the PUCCH(s) or PUSCH(s).

In another example, K symbols after receiving the BFRR (i.e., the common DL TCI state indication for both PDCCH and PDSCH), the UE may apply a transmit filter same as the receive filter for receiving the new beam to transmit the subsequent PUCCH(s) until the UE receives a TCI state/spatial relation information update for the PUCCH(s). Furthermore, L symbols after receiving the BFRR (i.e., the common DL TCI state indication for both PDCCH and PDSCH), the UE may apply a transmit filter same as the receive filter for receiving the new beam to transmit the subsequent PUSCH(s) until the UE receives a TCI state/spatial relation information update for the PUSCH(s). Here, L could be different from K.

In yet another example, the UE could receive from the network an indicator indicating whether the new beam q_new indicated in the common DL TCI state may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K symbols after receiving the BFRR (i.e., the common DL TCI state indication for both PDCCH and PDSCH), the UE may apply a transmit filter same as the receive filter for receiving the new beam to transmit the subsequent PUCCH(s) until the UE receives a TCI state/spatial relation information update for the PUCCH(s). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR, i.e., the common DL TCI state indication for both PDCCH and PDSCH via MAC CE or DCI for common beam indication, to transmit the subsequent PUSCH(s) until the UE receives a TCI state/spatial relation information update for the PUSCH(s).

If the one-bit indicator is set to “1,” L symbols after receiving the BFRR (i.e., the common DL TCI state indication for both PDCCH and PDSCH), the UE may apply a transmit filter same as the receive filter for receiving the new beam to transmit the PUSCH(s) until the UE receives a TCI state/spatial relation information update for the PUSCH(s). Here, L could be the same as or different from K.

For another example, L symbols after receiving the BFRR (i.e., the common DL TCI state indication for both PDCCH and PDSCH), the UE may apply a transmit filter same as the receive filter for receiving the new beam to transmit the subsequent PUSCH(s) until the UE receives a TCI state/spatial relation information update for the PUSCH(s). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR, i.e., the common DL TCI state indication for both PDCCH and PDSCH via MAC CE or DCI for common beam indication, to transmit the subsequent PUCCH(s) until the UE receives a TCI state/spatial relation information update for the PUCCH(s).

If the one-bit indicator is set to “1,” K symbols after receiving the BFRR (i.e., the common DL TCI state indication for both PDCCH and PDSCH), the UE may apply a transmit filter same as the receive filter for receiving the new beam to transmit the PUCCH(s) until the UE receives a TCI state/spatial relation information update for the PUCCH(s). Here, K could be the same as or different from L.

If the new beam q_new indicated in the BFRR (i.e., the common DL TCI state indicated for both PDCCH and PDSCH) may not be applied to either PUCCH or PUSCH, the UE may apply a transmit filter same as the receive filter for receiving the PDCCH(s) or PDSCH(s) prior to receiving the BFRR to transmit the subsequent PUCCH(s) or PUSCH(s) until the UE receives a TCI state/spatial relation information update for the PUCCH(s) or PUSCH(s); alternatively, the UE may apply a transmit filter same as the receive filter for receiving the BFRR, i.e., the common DL TCI state indication for both PDCCH and PDSCH via MAC CE or DCI for common beam indication, to transmit the subsequent PUCCH(s) or PUSCH(s) until the UE receives a TCI state/spatial relation information update for the PUCCH(s) or PUSCH(s).

The BFRR could be a common UL TCI state indication for both PUCCH and PUSCH. The NBI RS corresponding to the new beam q_new is indicated as the QCL source RS in the common UL TCI state. The UE could be indicated by the network the common UL TCI state via the MAC CE based or DCI based (with or without MAC CE activation) common beam indication strategy discussed herein.

In one example, for the UL channels, K symbols after receiving the BFRR (i.e., the common UL TCI state indication for both PUCCH and PUSCH), the UE may apply a transmit filter same as the receive filter for receiving the new beam to transmit the UL channels PUCCH(s) and PUSCH(s) until the UE receives a TCI state/spatial relation information update for the PUCCH(s) or PUSCH(s).

In another example, for the UL channels, K symbols after receiving the BFRR (i.e., the common UL TCI state indication for both PUCCH and PUSCH), the UE may apply a transmit filter same as the receive filter for receiving the new beam to transmit the PUCCH(s) until the UE receives a TCI state/spatial relation update for the PUCCH(s). Furthermore, L symbols after receiving the BFRR (i.e., the common UL TCI state indication for both PUCCH and PUSCH), the UE may apply a transmit filter same as the receive filter for receiving the new beam to transmit the PUSCH(s) until the UE receives a TCI state/spatial relation information update for the PUSCH(s). Here, L could be different from K.

In yet another example, for the UL channels, the UE could receive from the network an indicator indicating whether the new beam q_new indicated in the common UL TCI state may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K symbols after receiving the BFRR (i.e., the common UL TCI state indication for both PUCCH and PUSCH), the UE may apply a transmit filter same as the receive filter for receiving the new beam to transmit the subsequent PUCCH(s) until the UE receives a TCI state/spatial relation information update for the PUCCH(s). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR, i.e., the common UL TCI state indication for both PUCCH and PUSCH via MAC CE or DCI for common beam indication, to transmit the subsequent PUSCH(s) until the UE receives a TCI state/spatial relation information update for the PUSCH(s).

If the one-bit indicator is set to “1,” L symbols after receiving the BFRR (i.e., the common UL TCI state indication for both PUCCH and PUSCH), the UE may apply a transmit filter same as the receive filter for receiving the new beam to transmit the PUSCH(s) until the UE receives a TCI state/spatial relation information update for the PUSCH(s). Here, L could be the same as or different from K.

For another example, L symbols after receiving the BFRR (i.e., the common UL TCI state indication for both PUCCH and PUSCH), the UE may apply a transmit filter same as the receive filter for receiving the new beam to transmit the subsequent PUSCH(s) until the UE receives a TCI state/spatial relation information update for the PUSCH(s). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR, i.e., the common UL TCI state indication for both PUCCH and PUSCH via MAC CE or DCI for common beam indication, to transmit the subsequent PUCCH(s) until the UE receives a TCI state/spatial relation information update for the PUCCH(s).

If the one-bit indicator is set to “1,” K symbols after receiving the BFRR (i.e., the common UL TCI state indication for both PUCCH and PUSCH), the UE may apply a transmit filter same as the receive filter for receiving the new beam to transmit the PUCCH(s) until the UE receives a TCI state/spatial relation information update for the PUCCH(s). Here, K could be the same as or different from L.

The UE could receive from the network an indicator indicating whether the new beam indicated in the BFRR, i.e., the common UL TCI state for both PUCCH and PUSCH, may be applied to at least one of PDCCH and PDSCH; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. For instance, the UE could receive from the network a one-bit indicator with “0”/absent indicating that the new beam may not be applied to the subsequent PDCCH and PDSCH transmissions, and “1” indicating that the new beam may be applied to at least one of subsequent PDCCH and PDSCH transmissions. If the new beam q_new indicated in the BFRR (i.e., the common UL TCI state indicated for both PUCCH and PUSCH) may be applied to at least one of PDCCH and PDSCH.

In one example, X symbols after receiving the BFRR (i.e., the common UL TCI state indication for both PUCCH and PUSCH), the UE may assume/expect that the network may apply/use the new beam to transmit the subsequent PDCCH(s) and PDSCH(s) until the UE receives a TCI state update for the PDCCH(s) or PDSCH(s). That is, X symbols after receiving the BFRR (i.e., the common UL TCI state indication for both PUCCH and PUSCH), the UE may apply the same receive filter as that for receiving the new beam to receive the DL channels PDCCH(s) and PDSCH(s) until the UE receives a TCI state update for the PDCCH(s) or PDSCH(s).

In another example, X symbols after receiving the BFRR (i.e., the common UL TCI state indication for both PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the common UL TCI state indication for both PUCCH and PUSCH), the UE may apply the same receive filter as that for receiving the new beam to receive the subsequent PDCCH(s) until the UE receives a TCI state update for the PDCCH(s). Furthermore, Y symbols after receiving the BFRR (i.e., the common UL TCI state indication for both PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the common UL TCI state indication for both PUCCH and PUSCH), the UE may apply the same receive filter as that for receiving the new beam to receive the subsequent PDSCH(s) until the UE receives a TCI state update for the PDSCH(s). Here, Y could be different from X.

In yet another example, the UE could receive from the network an indicator indicating whether the new beam q_new indicated in the common UL TCI state may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X symbols after receiving the BFRR (i.e., the common UL TCI state indication for both PUCCH and PUSCH), the UE may apply the same receive filter as that for receiving the new beam to receive the subsequent PDCCH(s) until the UE receives a TCI state update for the PDCCH(s). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR, i.e., the common UL TCI state indication for both PUCCH and PUSCH via MAC CE or DCI for common beam indication, to receive the subsequent PDSCH(s) until the UE receives a TCI state update for the PDSCH(s).

If the one-bit indicator is set to “1,” Y symbols after receiving the BFRR (i.e., the common UL TCI state indication for both PUCCH and PUSCH), the UE may apply the same receive filter as that for receiving the new beam to receive the PDSCH(s) until the UE receives a TCI state update for the PDSCH(s). Here, Y could be the same as or different from X.

For another example, Y symbols after receiving the BFRR (i.e., the common UL TCI state indication for both PUCCH and PUSCH), the UE may apply the same receive filter as that for receiving the new beam to receive the subsequent PDSCH(s) until the UE receives a TCI state update for the PDSCH(s). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR, i.e., the common UL TCI state indication for both PUCCH and PUSCH via MAC CE or DCI for common beam indication, to receive the subsequent PDCCH(s) until the UE receives a TCI state update for the PDCCH(s).

If the one-bit indicator is set to “1,” X symbols after receiving the BFRR (i.e., the common UL TCI state indication for both PUCCH and PUSCH), the UE may apply the same receive filter as that for receiving the new beam to receive the PDCCH(s) until the UE receives a TCI state update for the PDCCH(s). Here, X could be the same as or different from Y.

If the new beam q_new indicated in the BFRR (i.e., the common UL TCI state indicated for both PUCCH and PUSCH) may not be applied to either PDCCH or PDSCH, the UE may apply the same receive filter as that for receiving the PDCCH(s) or PDSCH(s) prior to receiving the BFRR to receive the subsequent PDCCH(s) or PDSCH(s) until the UE receives a TCI state update for the PDCCH(s) or PDSCH(s); alternatively, the UE may apply the same receive filter as that for receiving the BFRR, i.e., the common UL TCI state indication for both PUCCH and PUSCH via MAC CE or DCI for common beam indication, to receive the subsequent PDCCH(s) or PDSCH(s) until the UE receives a TCI state update for the PDCCH(s) or PDSCH(s).

The BFRR could be a joint DL and UL TCI state indication for all DL and UL channels such as PDSCH, PDCCH, PUSCH and PUCCH. The NBI RS corresponding to the new beam q_new is indicated as the QCL source RS in the joint TCI state. The UE could be indicated by the network the joint DL and UL TCI state via the MAC CE based or DCI based (with or without MAC CE activation) common beam indication strategy discussed herein.

In one example, for the DL channels, X symbols after receiving the BFRR (i.e., the joint DL and UL TCI state indication for PDCCH, PDSCH, PUCCH and PUSCH), the UE may assume/expect that the network may apply/use the new beam to transmit the subsequent PDCCH(s) and PDSCH(s) until the UE receives a TCI state update for the PDCCH(s) or PDSCH(s). That is, X symbols after receiving the BFRR (i.e., the joint DL and UL TCI state indication for PDCCH, PDSCH, PUCCH and PUSCH), the UE may apply the same receive filter as that for receiving the new beam to receive the DL channels PDCCH(s) and PDSCH(s) until the UE receives a TCI state update for the PDCCH(s) or PDSCH(s).

In another example, for the DL channels, X symbols after receiving the BFRR (i.e., the joint DL and UL TCI state indication for PDCCH, PDSCH, PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the joint DL and UL TCI state indication for PDCCH, PDSCH, PUCCH and PUSCH), the UE may apply the same receive filter as that for receiving the new beam to receive the PDCCH(s) until the UE receives a TCI state update for the PDCCH(s). Furthermore, Y symbols after receiving the BFRR (i.e., the joint DL and UL TCI state indication for PDCCH, PDSCH, PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the joint DL and UL TCI state indication for PDCCH, PDSCH, PUCCH and PUSCH), the UE may apply the same receive filter as that for receiving the new beam to receive the PDSCH(s) until the UE receives a TCI state update for the PDSCH(s). Here, Y could be different from X.

In yet another example, for the DL channels, the UE could receive from the network an indicator indicating whether the new beam q_new indicated in the joint DL and UL TCI state may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X symbols after receiving the BFRR (i.e., the joint DL and UL TCI state indication for PDCCH, PDSCH, PUCCH and PUSCH), the UE may apply the same receive filter as that for receiving the new beam to receive the subsequent PDCCH(s) until the UE receives a TCI state update for the PDCCH(s). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR, i.e., the joint DL and UL TCI state indication for PDCCH, PDSCH, PUCCH and PUSCH, to receive the subsequent PDSCH(s) until the UE receives a TCI state update for the PDSCH(s).

If the one-bit indicator is set to “1,” Y symbols after receiving the BFRR (i.e., the joint DL and UL TCI state indication for PDCCH, PDSCH, PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the joint DL and UL TCI state indication for PDCCH, PDSCH, PUCCH and PUSCH), the UE may apply the same receive filter as that for receiving the new beam to receive the PDSCH(s) until the UE receives a TCI state update for the PDSCH(s). Here, Y could be the same as or different from X.

For another example, Y symbols after receiving the BFRR (i.e., the joint DL and UL TCI state indication for PDCCH, PDSCH, PUCCH and PUSCH), the UE may apply the same receive filter as that for receiving the new beam to receive the subsequent PDSCH(s) until the UE receives a TCI state update for the PDSCH(s). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR, i.e., the joint DL and UL TCI state indication for PDCCH, PDSCH, PUCCH and PUSCH, to receive the subsequent PDCCH(s) until the UE receives a TCI state update for the PDCCH(s).

If the one-bit indicator is set to “1,” X symbols after receiving the BFRR (i.e., the joint DL and UL TCI state indication for PDCCH, PDSCH, PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the joint DL and UL TCI state indication for PDCCH, PDSCH, PUCCH and PUSCH), the UE may apply the same receive filter as that for receiving the new beam to receive the PDCCH(s) until the UE receives a TCI state update for the PDCCH(s). Here, X could be the same as or different from Y.

In one example, for the UL channels, K symbols after receiving the BFRR (i.e., the joint DL and UL TCI state indication for PDCCH, PDSCH, PUCCH and PUSCH), the UE may apply a transmit filter same as the receive filter for receiving the new beam to transmit the UL channels PUCCH(s) and PUSCH(s) until the UE receives a TCI state/spatial relation information update for the PUCCH(s) or PUSCH(s).

In another example, for the UL channels, K symbols after receiving the BFRR (i.e., the joint DL and UL TCI state indication for PDCCH, PDSCH, PUCCH and PUSCH), the UE may apply a transmit filter same as the receive filter for receiving the new beam to transmit the PUCCH(s) until the UE receives a TCI state/spatial relation update for the PUCCH(s). Furthermore, L symbols after receiving the BFRR (i.e., the joint DL and UL TCI state indication for PDCCH, PDSCH, PUCCH and PUSCH), the UE may apply a transmit filter same as the receive filter for receiving the new beam to transmit the PUSCH(s) until the UE receives a TCI state/spatial relation information update for the PUSCH(s). Here, L could be different from K.

In yet another example, for the UL channels, the UE could receive from the network an indicator indicating whether the new beam q_new indicated in the joint DL and UL TCI state may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K symbols after receiving the BFRR (i.e., the joint DL and UL TCI state indication for PDCCH, PDSCH, PUCCH and PUSCH), the UE may apply a transmit filter same as the receive filter for receiving the new beam to transmit the subsequent PUCCH(s) until the UE receives a TCI state/spatial relation information update for the PUCCH(s). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR, i.e., the joint DL and UL TCI state indication for PDCCH, PDSCH, PUCCH and PUSCH, to transmit the subsequent PUSCH(s) until the UE receives a TCI state/spatial relation information update for the PUSCH(s).

If the one-bit indicator is set to “1,” L symbols after receiving the BFRR (i.e., the joint DL and UL TCI state indication for PDCCH, PDSCH, PUCCH and PUSCH), the UE may apply a transmit filter same as the receive filter for receiving the new beam to transmit the PUSCH(s) until the UE receives a TCI state/spatial relation information update for the PUSCH(s). Here, L could be the same as or different from K.

For another example, L symbols after receiving the BFRR (i.e., the joint DL and UL TCI state indication for PDCCH, PDSCH, PUCCH and PUSCH), the UE may apply a transmit filter same as the receive filter for receiving the new beam to transmit the subsequent PUSCH(s) until the UE receives a TCI state/spatial relation information update for the PUSCH(s). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR, i.e., the joint DL and UL TCI state indication for PDCCH, PDSCH, PUCCH and PUSCH, to transmit the subsequent PUCCH(s) until the UE receives a TCI state/spatial relation information update for the PUCCH(s).

If the one-bit indicator is set to “1,” K symbols after receiving the BFRR (i.e., the joint DL and UL TCI state indication for PDCCH, PDSCH, PUCCH and PUSCH), the UE may apply a transmit filter same as the receive filter for receiving the new beam to transmit the PUCCH(s) until the UE receives a TCI state/spatial relation information update for the PUCCH(s). Here, K could be the same as or different from L.

In the discussed design examples, the UE could receive from the network separate indicators respectively indicating whether the new beam q_new indicated in the joint DL and UL TCI state may be applied to one or more of PDCCH and PDSCH and whether the new beam q_new indicated in the joint DL and UL TCI state may be applied to one or more of PUCCH and PUSCH. Similarly, the UE could receive from the network separate indicators respectively indicating whether the new beam q_new indicated in the joint DL and UL TCI state may be applied to one or more of PDCCH and PUCCH and whether the new beam q_new indicated in the joint DL and UL TCI state may be applied to one or more of PDSCH and PUSCH.

Alternatively, the UE could receive from a network a single indicator to indicate whether the new beam q_new indicated in the joint DL and UL TCI state may be applied to one or more of PDCCH, PDSCH, PUCCH and PUSCH. For instance, the UE could receive from the network a bitmap with each entry/bit position corresponding to a channel such as PDCCH, PDSCH, PUCCH or PUSCH. If an entry/bit position in the bitmap is enabled, e.g., set to “1,” the new beam q_new indicated in the joint DL and UL TCI state may be applied to the corresponding channel. The bitmap could comprise more than one entries/bit positions set to “1”s.

The BFRR could be separate DL TCI state indication for both PDCCH and PDSCH and UL TCI state indication for both PUCCH and PUSCH. The NBI RS corresponding to the new beam q_new could be indicated as the QCL source RS in the DL TCI state and/or UL TCI state. The UE could be indicated by the network the separate DL TCI state and UL TCI state via the MAC CE based or DCI based (with or without MAC CE activation) common beam indication strategy discussed herein.

The NBI RS corresponding to the new beam q_new is indicated as the QCL source RSs in both DL TCI state and UL TCI state.

In one example, for the DL channels, X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) and PDSCH(s) until the UE receives a TCI state update for the PDCCH(s) or PDSCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the DL channels PDCCH(s) and PDSCH(s) until the UE receives a TCI state update for the PDCCH(s) or PDSCH(s).

In another example, for the DL channels, X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDCCH(s) until the UE receives a TCI state update for the PDCCH(s). Furthermore, Y symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDSCH(s) until the UE receives a TCI state update for the PDSCH(s). Here, Y could be different from X.

In yet another example, for the DL channels, the UE could receive from the network an indicator indicating whether the new beam q_new indicated in the separate DL TCI state and UL TCI state may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDCCH(s) until the UE receives a TCI state update for the PDCCH(s). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR, i.e., the separate DL TCI state indication for both PDCCH and PDSCH and UL TCI state indication for both PUCCH and PUSCH, to receive the subsequent PDSCH(s) until the UE receives a TCI state update for the PDSCH(s).

If the one-bit indicator is set to “1,” Y symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDSCH(s) until the UE receives a TCI state update for the PDSCH(s). Here, Y could be the same as or different from X.

For another example, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDSCH(s) until the UE receives a TCI state update for the PDSCH(s). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR, i.e., the separate DL TCI state indication for both PDCCH and PDSCH and UL TCI state indication for both PUCCH and PUSCH, to receive the subsequent PDCCH(s) until the UE receives a TCI state update for the PDCCH(s).

If the one-bit indicator is set to “1,” X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDCCH(s) until the UE receives a TCI state update for the PDCCH(s). Here, X could be the same as or different from Y.

In one example, for the UL channels, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the UL channels PUCCH(s) and PUSCH(s) until the UE receives a TCI state/spatial relation information update for the PUCCH(s) or PUSCH(s).

In another example, for the UL channels, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUCCH(s) until the UE receives a TCI state/spatial relation update for the PUCCH(s). Furthermore, L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUSCH(s) until the UE receives a TCI state/spatial relation information update for the PUSCH(s). Here, L could be different from K.

In yet another example, for the UL channels, the UE could receive from the network an indicator indicating whether the new beam q_new indicated in the separate DL TCI state and UL TCI state may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUCCH(s) until the UE receives a TCI state/spatial relation information update for the PUCCH(s). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR, i.e., the separate DL TCI state indication for both PDCCH and PDSCH and UL TCI state indication for both PUCCH and PUSCH, to transmit the subsequent PUSCH(s) until the UE receives a TCI state/spatial relation information update for the PUSCH(s).

If the one-bit indicator is set to “1,” L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUSCH(s) until the UE receives a TCI state/spatial relation information update for the PUSCH(s). Here, L could be the same as or different from K.

For another example, L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUSCH(s) until the UE receives a TCI state/spatial relation information update for the PUSCH(s). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR, i.e., the separate DL TCI state indication for both PDCCH and PDSCH and UL TCI state indication for both PUCCH and PUSCH, to transmit the subsequent PUCCH(s) until the UE receives a TCI state/spatial relation information update for the PUCCH(s).

If the one-bit indicator is set to “1,” K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUCCH(s) until the UE receives a TCI state/spatial relation information update for the PUCCH(s). Here, K could be the same as or different from L.

In the discussed design examples, the UE could receive from the network separate indicators respectively indicating whether the new beam q_new indicated in the separate DL TCI state and UL TCI state may be applied to one or more of PDCCH and PDSCH and whether the new beam q_new indicated in the separate DL TCI state and UL TCI state may be applied to one or more of PUCCH and PUSCH. Similarly, the UE could receive from the network separate indicators respectively indicating whether the new beam q_new indicated in the separate DL TCI state and UL TCI state may be applied to one or more of PDCCH and PUCCH and whether the new beam q_new indicated in the separate DL TCI state and UL TCI state may be applied to one or more of PDSCH and PUSCH.

Alternatively, the UE could receive from a network a single indicator to indicate whether the new beam q_new indicated in the separate DL TCI state and UL TCI state may be applied to one or more of PDCCH, PDSCH, PUCCH and PUSCH. For instance, the UE could receive from the network a bitmap with each entry/bit position corresponding to a channel such as PDCCH, PDSCH, PUCCH or PUSCH. If an entry/bit position in the bitmap is enabled, e.g., set to “1,” the new beam q_new indicated in the separate DL TCI state and UL TCI state may be applied to the corresponding channel. The bitmap could comprise more than one entries/bit positions set to “1”s.

The NBI RS corresponding to the new beam q_new is indicated as the QCL source RS in the separate DL TCI state. A RS such as a SSB or a CSI-RS different from the NBI RS corresponding to the new beam q_new is indicated as the QCL source RS in the separate UL TCI state.

In one example, for the DL channels, X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) and PDSCH(s) until the UE receives a TCI state update for the PDCCH(s) or PDSCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the DL channels PDCCH(s) and PDSCH(s) until the UE receives a TCI state update for the PDCCH(s) or PDSCH(s).

In another example, for the DL channels, X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDCCH(s) until the UE receives a TCI state update for the PDCCH(s). Furthermore, Y symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDSCH(s) until the UE receives a TCI state update for the PDSCH(s). Here, Y could be different from X.

In yet another example, for the DL channels, the UE could receive from the network an indicator indicating whether the new beam q_new indicated in the separate DL TCI state may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDCCH(s) until the UE receives a TCI state update for the PDCCH(s). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR, i.e., the separate DL TCI state indication for both PDCCH and PDSCH and UL TCI state indication for both PUCCH and PUSCH, to receive the subsequent PDSCH(s) until the UE receives a TCI state update for the PDSCH(s). Optionally, the UE may apply the same receive filter as that for receiving the QCL source RS indicated in the separate UL TCI state to receive the subsequent PDSCH(s) until the UE receives a TCI state update for the PDSCH(s).

If the one-bit indicator is set to “1,” Y symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDSCH(s) until the UE receives a TCI state update for the PDSCH(s). Here, Y could be the same as or different from X.

For another example, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDSCH(s) until the UE receives a TCI state update for the PDSCH(s). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR, i.e., the separate DL TCI state indication for both PDCCH and PDSCH and UL TCI state indication for both PUCCH and PUSCH, to receive the subsequent PDCCH(s) until the UE receives a TCI state update for the PDCCH(s). Optionally, the UE may apply the same receive filter as that for receiving the QCL source RS indicated in the separate UL TCI state to receive the subsequent PDCCH(s) until the UE receives a TCI state update for the PDCCH(s).

If the one-bit indicator is set to “1,” X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDCCH(s) until the UE receives a TCI state update for the PDCCH(s). Here, X could be the same as or different from Y.

The UE could receive from the network an indicator indicating whether the new beam indicated in the BFRR, i.e., in the separate DL TCI state, may be applied to at least one of PUCCH and PUSCH; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. For instance, the UE could receive from the network a one-bit indicator with “0”/absent indicating that the new beam may not be applied to the subsequent PUCCH and PUSCH transmissions, and “1” indicating that the new beam may be applied to at least one of subsequent PUCCH and PUSCH transmissions.

If the new beam q_new indicated in the BFRR (i.e., in the separate DL TCI state) may be applied to at least one of PUCCH and PUSCH, in one example, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the UL channels PUCCH(s) and PUSCH(s) until the UE receives a TCI state/spatial relation information update for the PUCCH(s) or PUSCH(s).

If the new beam q_new indicated in the BFRR (i.e., in the separate DL TCI state) may be applied to at least one of PUCCH and PUSCH, in another example, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUCCH(s) until the UE receives a TCI state/spatial relation information update for the PUCCH(s). Furthermore, L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUSCH(s) until the UE receives a TCI state/spatial relation information update for the PUSCH(s). Here, L could be different from K.

If the new beam q_new indicated in the BFRR (i.e., in the separate DL TCI state) may be applied to at least one of PUCCH and PUSCH, in yet another example, the UE could receive from the network an indicator indicating whether the new beam q_new indicated in the separate DL TCI state may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUCCH(s) until the UE receives a TCI state/spatial relation information update for the PUCCH(s). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR, i.e., the separate DL TCI state indication for both PDCCH and PDSCH and UL TCI state indication for both PUCCH and PUSCH, to transmit the subsequent PUSCH(s) until the UE receives a TCI state/spatial relation information update for the PUSCH(s). Optionally, the UE may apply a transmit filter same as the receive filter for receiving the QCL source RS indicated in the separate UL TCI state to transmit the subsequent PUSCH(s) until the UE receives a TCI state/spatial relation information update for the PUSCH(s).

If the one-bit indicator is set to “1,” L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUSCH(s) until the UE receives a TCI state/spatial relation information update for the PUSCH(s). Here, L could be the same as or different from K.

For another example, L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUSCH(s) until the UE receives a TCI state/spatial relation information update for the PUSCH(s). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR, i.e., the separate DL TCI state indication for both PDCCH and PDSCH and UL TCI state indication for both PUCCH and PUSCH, to transmit the subsequent PUCCH(s) until the UE receives a TCI state/spatial relation information update for the PUCCH(s). Optionally, the UE may apply a transmit filter same as the receive filter for receiving the QCL source RS indicated in the separate UL TCI state to transmit the subsequent PUCCH(s) until the UE receives a TCI state/spatial relation information update for the PUCCH(s).

If the one-bit indicator is set to “1,” K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUCCH(s) until the UE receives a TCI state/spatial relation information update for the PUCCH(s). Here, K could be the same as or different from L.

If the new beam q_new indicated in the BFRR (i.e., in the separate DL TCI state) may not be applied to either PUCCH or PUSCH, the UE may apply a transmit filter same as the receive filter for receiving the PDCCH(s) or PDSCH(s) prior to receiving the BFRR to transmit the subsequent PUCCH(s) or PUSCH(s) until the UE receives a TCI state/spatial relation information update for the PUCCH(s) or PUSCH(s); alternatively, the UE may apply a transmit filter same as the receive filter for receiving the BFRR, i.e., the separate DL TCI state indication for both PDCCH and PDSCH and UL TCI state indication for both PUCCH and PUSCH, to transmit the subsequent PUCCH(s) or PUSCH(s) until the UE receives a TCI state/spatial relation information update for the PUCCH(s) or PUSCH(s); optionally, the UE may apply a transmit filter same as the receive filter for receiving the QCL source RS indicated in the separate UL TCI state to transmit the subsequent PUCCH(s) or PUSCH(s) until the UE receives a TCI state/spatial relation information update for the PUCCH(s) or PUSCH(s).

The NBI RS corresponding to the new beam q_new is indicated as the QCL source RS in the separate UL TCI state. A RS such as a SSB or a CSI-RS different from the NBI RS corresponding to the new beam q_new is indicated as the QCL source RS in the separate DL TCI state.

In one example, for the UL channels, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the UL channels PUCCH(s) and PUSCH(s) until the UE receives a TCI state/spatial relation information update for the PUCCH(s) or PUSCH(s).

In another example, for the UL channels, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUCCH(s) until the UE receives a TCI state/spatial relation update for the PUCCH(s). Furthermore, L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUSCH(s) until the UE receives a TCI state/spatial relation information update for the PUSCH(s). Here, L could be different from K.

In yet another example, for the UL channels, the UE could receive from the network an indicator indicating whether the new beam q_new indicated in the separate UL TCI state may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUCCH(s) until the UE receives a TCI state/spatial relation information update for the PUCCH(s). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR, i.e., the separate DL TCI state indication for both PDCCH and PDSCH and UL TCI state indication for both PUCCH and PUSCH, to transmit the subsequent PUSCH(s) until the UE receives a TCI state/spatial relation information update for the PUSCH(s). Optionally, the UE may apply a transmit filter same as the receive filter for receiving the QCL source RS indicated in the separate UL TCI state to transmit the subsequent PUSCH(s) until the UE receives a TCI state/spatial relation information update for the PUSCH(s).

If the one-bit indicator is set to “1,” L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUSCH(s) until the UE receives a TCI state/spatial relation information update for the PUSCH(s). Here, L could be the same as or different from K.

For another example, L symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the subsequent PUSCH(s) until the UE receives a TCI state/spatial relation information update for the PUSCH(s). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR, i.e., the separate DL TCI state indication for both PDCCH and PDSCH and UL TCI state indication for both PUCCH and PUSCH, to transmit the subsequent PUCCH(s) until the UE receives a TCI state/spatial relation information update for the PUCCH(s). Optionally, the UE may apply a transmit filter same as the receive filter for receiving the QCL source RS indicated in the separate UL TCI state to transmit the subsequent PUCCH(s) until the UE receives a TCI state/spatial relation information update for the PUCCH(s).

If the one-bit indicator is set to “1,” K symbols after receiving the BFRR (i.e., the separate DL TCI state indication for both PDCCH and PDSCH and UL TCI state indication for both PUCCH and PUSCH), the UE may apply a transmit filter same as the receive filter for receiving the new beam to transmit the PUCCH(s) until the UE receives a TCI state/spatial relation information update for the PUCCH(s). Here, K could be the same as or different from L.

The UE could receive from the network an indicator indicating whether the new beam indicated in the BFRR, i.e., in the separate UL TCI state, may be applied to at least one of PDCCH and PDSCH; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. For instance, the UE could receive from the network a one-bit indicator with “0”/absent indicating that the new beam may not be applied to the subsequent PDCCH and PDSCH transmissions, and “1” indicating that the new beam may be applied to at least one of subsequent PDCCH and PDSCH transmissions.

If the new beam q_new indicated in the BFRR (i.e., in the separate UL TCI state) may be applied to at least one of PDCCH and PDSCH, in one example, X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) and PDSCH(s) until the UE receives a TCI state update for the PDCCH(s) or PDSCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the DL channels PDCCH(s) and PDSCH(s) until the UE receives a TCI state update for the PDCCH(s) or PDSCH(s).

If the new beam q_new indicated in the BFRR (i.e., in the separate UL TCI state) may be applied to at least one of PDCCH and PDSCH, in another example, X symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDCCH(s) until the UE receives a TCI state update for the PDCCH(s). That is, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDCCH(s) until the UE receives a TCI state update for the PDCCH(s).

Furthermore, Y symbols after receiving the BFRR (i.e., the separate DL TCI state indication for both PDCCH and PDSCH and UL TCI state indication for both PUCCH and PUSCH), the UE may assume/expect that the network may apply/use the new beam to transmit the subsequent PDSCH(s) until the UE receives a TCI state update for the PDSCH(s). That is, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDSCH(s) until the UE receives a TCI state update for the PDSCH(s). Here, Y could be different from X.

If the new beam q_new indicated in the BFRR (i.e., in the separate UL TCI state) may be applied to at least one of PDCCH and PDSCH, in yet another example, the UE could receive from the network an indicator indicating whether the new beam q_new indicated in the separate UL TCI state may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDCCH(s) until the UE receives a TCI state update for the PDCCH(s). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR, i.e., the separate DL TCI state indication for both PDCCH and PDSCH and UL TCI state indication for both PUCCH and PUSCH, to receive the subsequent PDSCH(s) until the UE receives a TCI state update for the PDSCH(s). Optionally, the UE may apply the same receive filter as that for receiving the QCL source RS indicated in the separate UL TCI state to receive the subsequent PDSCH(s) until the UE receives a TCI state update for the PDSCH(s).

If the one-bit indicator is set to “1,” Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDSCH(s) until the UE receives a TCI state update for the PDSCH(s). Here, Y could be the same as or different from X.

For another example, Y symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the subsequent PDSCH(s) until the UE receives a TCI state update for the PDSCH(s). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR, i.e., the separate DL TCI state indication for both PDCCH and PDSCH and UL TCI state indication for both PUCCH and PUSCH, to receive the subsequent PDCCH(s) until the UE receives a TCI state update for the PDCCH(s). Optionally, the UE may apply the same receive filter as that for receiving the QCL source RS indicated in the separate UL TCI state to receive the subsequent PDCCH(s) until the UE receives a TCI state update for the PDCCH(s).

If the one-bit indicator is set to “1,” X symbols after receiving the BFRR (i.e., the separate DL TCI state indication for both PDCCH and PDSCH and UL TCI state indication for both PUCCH and PUSCH), the UE may apply the same receive filter as that for receiving the new beam to receive the PDCCH(s) until the UE receives a TCI state update for the PDCCH(s). Here, X could be the same as or different from Y.

If the new beam q_new indicated in the BFRR (i.e., in the separate UL TCI state) may not be applied to either PDCCH or PDSCH, the UE may apply the same receive filter as that for receiving the PDCCH(s) or PDSCH(s) prior to receiving the BFRR to receive the subsequent PDCCH(s) or PDSCH(s) until the UE receives a TCI state update for the PDCCH(s) or PDSCH(s); alternatively, the UE may apply the same receive filter as that for receiving the BFRR, i.e., the separate DL TCI state indication for both PDCCH and PDSCH and UL TCI state indication for both PUCCH and PUSCH, to receive the subsequent PDCCH(s) or PDSCH(s) until the UE receives a TCI state update for the PDCCH(s) or PDSCH(s). Optionally, the UE may apply the same receive filter as that for receiving the QCL source RS indicated in the separate UL TCI state to receive the subsequent PDCCH(s) or PDSCH(s) until the UE receives a TCI state update for the PDCCH(s) or PDSCH(s).

In the present disclosure, for at least the PCell or the PSCell, a UE can be provided a CORESET through a link to a search space set provided by recoverySearchSpaceld, as described in the 3GPP TS 38.213 clause 10.1, for monitoring PDCCH in the CORESET. If the UE is provided recoverySearchSpaceld, the UE does not expect to be provided another search space set for monitoring PDCCH in the CORESET associated with the search space set provided by recoverySearchSpaceld.

As discussed herein, in the present disclosure, the UE could be configured with/provided by the network a NBI RS set q1 of periodic CSI-RS resource configuration indexes or SSB indexes for radio link quality measurement and identifying potential new beam(s) to recover a beam failure. The UE expects single-port or two-port CSI-RS with frequency density equal to 1 or 3 REs per RB in the set q1. The UE could assess the radio link quality according to the set q1 of resource configurations against a threshold Qin. The UE may apply the Qin threshold to the L1-RSRP measurement obtained from a SSB in q1 and apply the Qin threshold to the L1-RSRP measurement obtained from a CSI-RS resource in q1 after scaling a respective CSI-RS reception power with a value provided by powerControlOffsetSS. The UE may identity the periodic CSI-RS resource configuration index or SSB index in the NBI RS set q1, denoted by q_new, that corresponds to the largest/highest measured L1-RSRP among those larger than or equal to the Qin threshold.

As discussed herein, in addition to (1) the unified/common TCI state indication/update for various DL and/or UL channels/signals such as PDCCH, PDSCH, PUCCH or PUSCH, the BFRR could also be in form of: (2) a (first) PDCCH reception in a search space set provided by recoverySearchSpaceId where the UE detects a DCI format with CRC scrambled by C-RNTI or MCS-C-RNTIfor the PCell or the PSCell, (3) a PDCCH reception that determines the completion of the contention based random access procedure for BFR as described in the 3GPP TS 38.321 for the PCell or the PSCell, or (4) a PDCCH reception with a DCI format scheduling a PUSCH transmission with a same HARQ process number as for the transmission of the PUSCH carrying the MAC CE for BFR and having a toggled NDI field value for the SCell. For (2), the UE is provided, in message 3 (Msg3) or message A (MsgA) of contention-based random-access procedure, a BFR MAC CE, and a PUCCH resource is provided with PUCCH-SpatialRelationInfo. For (4), the UE can provide in a first PUSCH MAC CE index(es) for at least corresponding SCell(s) with radio link quality worse than Q_{out,LR}, indication(s) of presence of q_{new} for corresponding SCell(s), and index(es) q_{new} for a periodic CSI-RS configuration or for a SS/PBCH block provided by higher layers, as described in [11, TS 38.321], if any, for corresponding SCell(s).

Various UE’s behaviors of resetting or updating DL and/or UL beams/spatial filters after receiving one or more of the above discussed BFRR formats/forms (1), (2), (3) or (4) are specified as follows, under the unified TCI framework, wherein the UE could be provided/configured/indicated by the network, e.g., in a MAC CE or DCI format 1_1 or 1_2 with or without DL assignment (e.g., by the TCI field in the beam indication DCI), a unified TCI state for transmission/reception of various DL/UL channels/signals such as PDCCH, PDSCH, CSI-RS, PUCCH, PUSCH or SRS.

In one example, X symbols after receiving the BFRR, the UE may at least apply the same receive filter as that for receiving the new beam to receive the subsequent PDCCH(s) until the UE receives a TCI state update for the PDCCH(s). That is, under the Rel. 17 unified TCI framework when a UE is configured with/provided by the network TCI-State_r17 indicating a unified TCI state, X symbols after receiving the BFRR, i.e., (i) X symbols from a last symbol of a PDCCH reception in a search space set provided by recoverySearchSpaceId where the UE detects a DCI format with CRC scrambled by C-RNTI or MCS-C-RNTI for the PCell or PSCell, or (ii) X symbols from a last symbol of a PDCCH reception that determines the completion of the contention based random access procedure for BFR as described in the 3GPP TS 38.321 for the PCell or the PSCell, or (iii) X symbols from a last symbol of a PDCCH reception with a DCI format scheduling a PUSCH transmission with a same HARQ process number as for the transmission of the PUSCH carrying the MAC CE for BFR and having a toggled NDI field value for the SCell.

For PDCCH(s): if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), the UE assumes the same antenna port quasi-collocation (QCL) parameters as the ones associated with index q_new of the NBI RS resource identified by the UE from the NBI RS beam set (e.g., denoted by q1) for monitoring PDCCH in all CORESETs including all UE-dedicated PDCCH receptions in a CC or in a set of configured CCs configured with one or more Rel. 17 TCI states/beams (e.g., provided by the higher layer parameter TCI-State_r17) activation or update.

For PDSCH(s): the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR to receive the subsequent PDSCH(s) until the UE receives a TCI state update for the PDSCH(s). That is, if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), the UE assumes the same antenna port QCL parameters as the ones associated with index q_new of the NBI RS resource identified by the UE from the NBI RS beam set (e.g., denoted by q1) for all PDSCH receptions including all UE-dedicated PDSCH receptions in a CC or in a set of configured CCs configured with one or more Rel. 17 TCI states/beams (e.g., provided by the higher layer TCI-State_r17) activation or update.

For PUCCH(s) or PUSCH(s): the UE may apply a transmit filter same as the receive filter for receiving the PDCCH(s) or PDSCH(s) prior to receiving the BFRR to transmit the subsequent PUCCH(s) or PUSCH(s) until the UE receives a TCI state/spatial relation information update for the PUCCH(s) or PUSCH(s). Alternatively, the UE may apply a transmit filter same as that for transmitting the last PRACH or the receive filter for receiving the BFRR to transmit the subsequent PUCCH(s) or PUSCH(s) until the UE receives a TCI state/spatial relation information update for the PUCCH(s) or PUSCH(s).

For PUCCH(s): if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), the UE transmits PUCCH including all of dedicated PUCCHs (or PUCCH resources) in a CC or in a set of configured CCs configured with one or more Rel. 17 TCI states/beams (e.g., provided by the higher layer parameter TCI-State_rl7) activation or update using a spatial filter x, and/or a power determined as described in the 3GPP TS 38.213 clause 7.2.1 with the UL power control parameters (such as q_u, q_d, closed loop index 1) associated with the Rel. 17 TCI state associated with index q_new, e.g., q_u=0, q_d=q_new and closed loop index 1=0 or 1, wherein: (1) in one example, the spatial filter x could correspond to a same spatial filter as for the last PRACH transmission for cases (i) or (ii) in the present disclosure; and (2) in another example, the spatial filter x could correspond to a same spatial filter as the one associated with index q_new of the NBI RS resource identified by the UE from the NBIRS beam set (e.g., denoted by q1) for case (iii) in the present disclosure.

For PUSCH(s): if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), the UE transmits PUSCH including all dynamic-grant/configured-grant based PUSCHs (or PUSCH resources) in a CC or in a set of configured CCs configured with one or more Rel. 17 TCI states/beams (e.g., provided by the higher layer parameter TCI-State_r17) activation or update using spatial filter x, and/or a power determined as described in the 3GPP TS 38.213 clause 7.2.1 with the UL power control parameters (such as q_u, q_d, closed loop index 1) associated with the Rel. 17 TCI state associated with index q_new, e.g., q_u=0, q_d=q_new and closed loop index 1=0 or 1, wherein: (1) in one example, the spatial filter x could correspond to a same spatial filter as for the last PRACH transmission for cases (i) or (ii) in the present disclosure; and (2) in another example, the spatial filter x could correspond to a same spatial filter as the one associated with index q_new of the NBI RS resource identified by the UE from the NBI RS beam set (e.g., denoted by q1) for case (iii) in the present disclosure.

For other signals/channels than PDCCH/PDSCH including UE-dedicated PDCCH(s)/PDSCH(s) and/or PUCCH/PUSCH including dynamic-grant/configured-grant based PUSCH(s) and dedicated PUCCH(s), e.g., aperiodic CSI-RS resource from a CSI-RS resource set sharing the same indicated TCI state as for the PDCCH/PDSCH and SRS sharing the same indicated TCI state as for the PUCCH/PUSCH: if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), following example can be considered.

In one example, the UE assumes the same antenna port quasi-collocation (QCL) parameters as the ones associated with index q_new of the NBI RS resource identified by the UE from the NBI RS beam set (e.g., denoted by q1) for other signals/channels receptions sharing the same indicated Rel. 17 TCI state/beam (e.g., provided by the higher layer parameter TCI-State_r17) as for the PDCCH/PDSCH including the UE-dedicated PDCCH/PDSCH receptions in a CC or in a set of configured CCs configured with one or more Rel. 17 TCI states/beams (e.g., provided by the higher layer parameter TCI-State_r17) activation or update.

In another example, the UE assumes the same antenna port quasi-collocation (QCL) parameters as the ones associated with index q_new of the NBI RS resource identified by the UE from the NBI RS beam set (e.g., denoted by q1) for other signals/channels receptions sharing the same indicated Rel. 17 TCI state/beam (e.g., provided by the higher layer parameter TCI-State_r17) as for the PUCCH/PUSCH including the dynamic-grant/configured-grant based PUSCH and all of dedicated PUCCH resources in a CC or in a set of configured CCs configured with one or more Rel. 17 TCI states/beams (e.g., provided by the higher layer parameter TCI-State_r17) activation or update.

In yet another example, the UE transmits other signals/channels sharing the same indicated Rel. 17 TCI state/beam (e.g., provided by the higher layer parameter TCI-State_r17) as for the PDCCH/PDSCH including the UE-dedicated PDCCH/PDSCH receptions in a CC or in a set of configured CCs configured with one or more Rel. 17 TCI states/beams (e.g., provided by the higher layer parameter TCI-State_r17) activation or update using spatial filter x, wherein: (1) in one example, the spatial filter x could correspond to a same spatial filter as for the last PRACH transmission for cases (i) or (ii) in the present disclosure; and (2) in another example, the spatial filter x could correspond to a same spatial filter as the one associated with index q_new of the NBI RS resource identified by the UE from the NBI RS beam set (e.g., denoted by q1) for case (iii) in the present disclosure.

In yet another example, the UE transmits other signals/channels sharing the same indicated Rel. 17 TCI state/beam (e.g., provided by the higher layer parameter TCI-State_r17) as for the PUCCH/PUSCH including the dynamic-grant/configured-grant based PUSCH and all of dedicated PUCCH resources in a CC or in a set of configured CCs configured with one or more Rel. 17 TCI states/beams (e.g., provided by the higher layer parameter TCI-State_r17) activation or update using spatial filter x, wherein: (1) in one example, the spatial filter x could correspond to a same spatial filter as for the last PRACH transmission for cases (i) or (ii) in the present disclosure; and (2) in another example, the spatial filter x could correspond to a same spatial filter as the one associated with index q_new of the NBI RS resource identified by the UE from the NBI RS beam set (e.g., denoted by q1) for case (iii) in the present disclosure.

The value of X could correspond to 28, i.e., 28 symbols. Furthermore, the subcarrier spacing (SCS) for the X=28 symbols could correspond to one or more of: (1) the smallest of the SCS configurations of the active DL BWP for the PDCCH reception and of the active DL BWP(s) of the serving cell; or (2) the smallest of the SCS configurations of all the signal(s)/channels sharing the same indicated Rel. 17 TCI state/beam (e.g., provided by the higher layer parameter TCI-State_r17).

Furthermore, at least for case (i) in the present disclosure, after the UE detects a DCI format with CRC scrambled by C-RNTI or MCS-C-RNTI in the search space set provided by recoverySearchSpaceld, the UE continues to monitor PDCCH candidates in the search space set provided by recoverySearchSpaceld until the UE receives DCI indication (e.g., DCI format 1_1 or 1_2 with or without DL assignment), MAC CE activation command or RRC reconfiguration for a Rel. 17 unified TCI state.

In another example, X symbols after receiving the BFRR, the UE may at least apply the same receive filter as that for receiving the new beam to receive the subsequent PDCCH(s) until the UE receives a TCI state update for the PDCCH(s). That is, under the Rel. 17 unified TCI framework when a UE is configured with/provided by the network TCI-State_r17 indicating a unified TCI state, X symbols after receiving the BFRR, i.e., (i) X symbols from a last symbol of a PDCCH reception in a search space set provided by recoverySearchSpaceId where the UE detects a DCI format with CRC scrambled by C-RNTI or MCS-C-RNTI for the PCell or PSCell, or (ii) X symbols from a last symbol of a PDCCH reception that determines the completion of the contention based random access procedure for BFR as described in the 3GPP TS 38.321 for the PCell or the PSCell, or (iii) X symbols from a last symbol of a PDCCH reception with a DCI format scheduling a PUSCH transmission with a same HARQ process number as for the transmission of the PUSCH carrying the MAC CE for BFR and having a toggled NDI field value for the SCell.

For PDCCH(s): if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), for a CC from a set of G≥1 CCs configured with one or more Rel. 17 TCI states/beams (e.g., provided by the higher layer parameter TCI-State_r17) activation or update, the UE assumes the same antenna port quasi-collocation (QCL) parameters as the ones associated with a RS resource (e.g., a SSB resource/SSB index or a CSI-RS resource/CSI-RS resource configuration index) in the CC for monitoring PDCCH in all CORESETs including all UE-dedicated PDCCH receptions in the CC, wherein the RS resource in the CC is associated with/linked to the index q_new. For instance, q_new could correspond to the index of the RS resource in the NBI RS beam set q1 configured to the UE for new/candidate beam identification in the CC. The UE applies the procedure/assumption for monitoring PDCCH in all CORESETs including all UE-dedicated PDCCH receptions across all the G≥1 CCs configured with one or more Rel. 17 TCI states/beams (e.g., provided by the higher layer parameter TCI-State_r17) activation or update.

For PDSCH(s): the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR to receive the subsequent PDSCH(s) until the UE receives a TCI state update for the PDSCH(s). That is, if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), for a CC from a set of G≥1 CCs configured with one or more Rel. 17 TCI states/beams (e.g., provided by the higher layer parameter TCI-State_r17) activation or update, the UE assumes the same antenna port QCL parameters as the ones associated with the RS resource (e.g., a SSB resource/index or a CSI-RS resource/CSI-RS resource configuration index) in the CC for all PDSCH receptions including all UE-dedicated PDSCH receptions in the CC, wherein the RS resource in the CC is associated with/linked to the index q_new.

For instance, q_new could correspond to the index of the RS resource in the NBI RS beam set q1 configured to the UE for new/candidate beam identification in the CC. The UE applies the procedure/assumption for all PDSCH receptions including UE-dedicated PDSCH receptions across all the G≥1 CCs configured with one or more Rel. 17 TCI states/beams (e.g., provided by the higher layer parameter TCI-State_r17) activation or update.

For PUCCH(s) or PUSCH(s): the UE may apply a transmit filter same as the receive filter for receiving the PDCCH(s) or PDSCH(s) prior to receiving the BFRR to transmit the subsequent PUCCH(s) or PUSCH(s) until the UE receives a TCI state/spatial relation information update for the PUCCH(s) or PUSCH(s). Alternatively, the UE may apply a transmit filter same as the receive filter for receiving the BFRR to transmit the subsequent PUCCH(s) or PUSCH(s) until the UE receives a TCI state/spatial relation information update for the PUCCH(s) or PUSCH(s).

For PUCCH(s): if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), for a CC from a set of G≥1 CCs configured with one or more Rel. 17 TCI states/beams (e.g., provided by the higher layer parameter TCI-State_r17) activation or update, the UE transmits PUCCH including all of dedicated PUCCHs (or PUCCH resources) in the CC using spatial filter x, wherein: (1) in one example, the spatial filter x could correspond to a same spatial filter as for the last PRACH transmission in the CC for cases (i) or (ii) in the present disclosure; and (2) in another example, the spatial filter x could correspond to a same spatial filter as the one associated with the RS resource (e.g., a SSB index/SSB resource or a CSI-RS resource/CSI-RS resource configuration index) in the CC.

The RS resource in the CC could be associated with/linked to the index q_new such that q_new could correspond to the index of the RS resource in the NBI RS beam set q1 configured to the UE for new/candidate beam identification in the CC, and/or a power determined as described in the 3GPP TS 38.213 clause 7.2.1 with the UL power control parameters (such as q_u, q_d, closed loop index 1) associated with the Rel. 17 TCI state associated with the RS resource (e.g., a SSB index/SSB resource or a CSI-RS resource/CSI-RS resource configuration index) in the CC. For instance, q_u=0, q_d=q_new, and closed loop index 1=0 or 1. The UE applies the procedure/assumption to transmit PUCCH including all of dedicated PUCCHs (or PUCCH resources) across all the G≥1 CCs configured with one or more Rel. 17 TCI states/beams (e.g., provided by the higher layer parameter TCI-State_r17) activation or update.

For PUSCH(s): if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), for a CC from a set of G≥1 CCs configured with one or more Rel. 17 TCI states/beams (e.g., provided by the higher layer parameter TCI-State_r17) activation or update, the UE transmits PUSCH including all dynamic-grant/configured-grant based PUSCHs (or PUSCH resources) in the CC using spatial filter x, wherein: (1) in one example, the spatial filter x could correspond to a same spatial filter as for the last PRACH transmission in the CC for cases (i) or (ii) in the present disclosure; and (2) in another example, the spatial filter x could correspond to a same spatial filter as the one associated with the RS resource (e.g., a SSB index/SSB resource or a CSI-RS resource/CSI-RS resource configuration index) in the CC.

The RS resource in the CC could be associated with/linked to the index q_new such that q_new could correspond to the index of the RS resource in the NBI RS beam set q1 configured to the UE for new/candidate beam identification in the CC, and/or a power determined as described in the 3GPP TS 38.213 clause 7.2.1 with the UL power control parameters (such as q_u, q_d, closed loop index 1) associated with the Rel. 17 TCI state associated with the RS resource (e.g., a SSB index/SSB resource or a CSI-RS resource/CSI-RS resource configuration index) in the CC. For instance, q_u=0, q_d=q_new, and closed loop index 1=0 or 1. The UE applies the procedure/assumption to transmit PUSCH including all dynamic-grant/configured-grant based PUSCHs (or PUSCH resources) across all the G≥1 CCs configured with one or more Rel. 17 TCI states/beams (e.g., provided by the higher layer parameter TCI-State_r17) activation or update.

For other signals/channels than PDCCH/PDSCH including UE-dedicated PDCCH(s)/PDSCH(s) and/or PUCCH/PUSCH including dynamic-grant/configured-grant based PUSCH(s) and dedicated PUCCH(s), e.g., aperiodic CSI-RS resource from a CSI-RS resource set sharing the same indicated TCI state as for the PDCCH/PDSCH and SRS sharing the same indicated TCI state as for the PUCCH/PUSCH: if the UE receives or is configured a Rel. 17 unified TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), following examples can be considered.

In one example, for a CC from a set of G≥1 CCs configured with one or more Rel. 17 TCI states/beams (e.g., provided by the higher layer parameter TCI-State_r17) activation or update, the UE assumes the same antenna port quasi-collocation (QCL) parameters as the ones associated with the RS resource (e.g., a SSB index/SSB resource or a CSI-RS resource/CSI-RS resource configuration index) in the CC for other signals/channels receptions sharing the same indicated Rel. 17 TCI state/beam (e.g., provided by the higher layer parameter TCI-state_r17) as for the PDCCH/PDSCH including the UE-dedicated PDCCH/PDSCH receptions in the CC, wherein the RS resource in the CC is associated with/linked to the index q_new. For instance, q_new could correspond to the index of the RS resource in the NBI RS beam set q1 configured to the UE for new/candidate beam identification in the CC. The UE applies the procedure/assumption for other signals/channels receptions sharing the same indicated Rel. 17 TCI state/beam (e.g., provided by the higher layer parameter TCI-State_r17) as for the PDCCH/PDSCH including the UE-dedicated PDCCH/PDSCH receptions across all the G≥1 CCs configured with one or more Rel. 17 TCI states/beams (e.g., provided by the higher layer parameter TCI-State_r17) activation or update.

In another example, for a CC from a set of G≥1 CCs configured with one or more Rel. 17 TCI states/beams (e.g., provided by the higher layer parameter TCI-State_r17) activation or update, the UE assumes the same antenna port quasi-collocation (QCL) parameters as the ones associated with the RS resource (e.g., a SSB index/SSB resource or a CSI-RS resource/CSI-RS resource configuration index) in the CC for other signals/channels receptions sharing the same indicated Rel. 17 TCI state/beam (e.g., provided by the higher layer parameter TCI-State_r17) as for the PUCCH/PUSCH including the dynamic-grant/configured-grant based PUSCH and all of dedicated PUCCH resources in the CC, wherein the RS resource in the CC is associated with/linked to the index q_new. For instance, q_new could correspond to the index of the RS resource in the NBI RS beam set q1 configured to the UE for new/candidate beam identification in the CC. The UE applies the procedure/assumption for other signals/channels receptions sharing the same indicated Rel. 17 TCI state/beam (e.g., provided by the higher layer parameter TCI-State_r17) as for the PUCCH/PUSCH including the dynamic-grant/configured-grant based PUSCH and all of dedicated PUCCH resources across all the G≥1 CCs configured with one or more Rel. 17 TCI states/beams (e.g., provided by the higher layer parameter TCI-State_r17) activation or update.

In yet another example, for a CC from a set of G≥1 CCs configured with one or more Rel. 17 TCI states/beams (e.g., provided by the higher layer parameter TCI-State_r17) activation or update, the UE transmits other signals/channels sharing the same indicated Rel. 17 TCI state/beam (e.g., provided by the higher layer parameter TCI-State_r17) as for the PDCCH/PDSCH including the UE-dedicated PDCCH/PDSCH receptions in the CC using spatial filter x, wherein: (1) in one example, the spatial filter x could correspond to a same spatial filter as for the last PRACH transmission in the CC for cases (i) or (ii) in the present disclosure; and (2) in another example, the spatial filter x could correspond to a same spatial filter as the one associated with the RS resource (e.g., a SSB index/SSB resource or a CSI-RS resource/CSI-RS resource configuration index) in the CC, where the RS resource is associated with/linked to the index q_new. For instance, q_new could correspond to the index of the RS resource in the NBI RS beam set q1 configured to the UE for new/candidate beam identification in the CC.

The UE applies the procedure/assumption to transmit other signals/channels sharing the same indicated Rel. 17 TCI state/beam (e.g., provided by the higher layer parameter TCI-State_r17) as for the PDCCH/PDSCH including the UE-dedicated PDCCH/PDSCH receptions across all the G≥1 CCs configured with one or more Rel. 17 TCI states/beams (e.g., provided by the higher layer parameter TCI-State_r17) activation or update.

In yet another example, for a CC from a set of G≥1 CCs configured with one or more Rel. 17 TCI states/beams (e.g., provided by the higher layer parameter TCI-State_r17) activation or update, the UE transmits other signals/channels sharing the same indicated Rel. 17 TCI state/beam (e.g., provided by the higher layer parameter TCI-State_r17) as for the PUCCH/PUSCH including the dynamic-grant/configured-grant based PUSCH and all of dedicated PUCCH resources in the CC using spatial filter x, wherein: (1) in one example, the spatial filter x could correspond to a same spatial filter as for the last PRACH transmission in the CC for cases (i) or (ii) in the present disclosure; and (2) In another example, the spatial filter x could correspond to a same spatial filter as the one associated with the RS resource (e.g., a SSB index/SSB resource or a CSI-RS resource/CSI-RS resource configuration index) in the CC, where the RS resource is associated with/linked to the index q_new. For instance, q_new could correspond to the index of the RS resource in the NBI RS beam set q1 configured to the UE for new/candidate beam identification in the CC.

The UE applies the procedure/assumption to transmit other signals/channels sharing the same indicated Rel. 17 TCI state/beam (e.g., provided by the higher layer parameter TCI-State_r17) as for the PUCCH/PUSCH including the dynamic-grant/configured-grant based PUSCH and all of dedicated PUCCH resources across all the G≥1 CCs configured with one or more Rel. 17 TCI states/beams (e.g., provided by the higher layer parameter TCI-State_r17) activation or update.

The value of X could correspond to 28, i.e., 28 symbols. Furthermore, the subcarrier spacing (SCS) for the X=28 symbols could correspond to one or more of: (1) the smallest of the SCS configurations of the active DL BWP for the PDCCH reception and of the active DL BWP(s) of the serving cell; or (2) the smallest of the SCS configurations of all the signal(s)/channels sharing the same indicated Rel. 17 TCI state/beam (e.g., provided by the higher layer parameter TCI-State_r17).

Furthermore, at least for case (i) in the present disclosure, after the UE detects a DCI format with CRC scrambled by C-RNTI or MCS-C-RNTI in the search space set provided by recoverySearchSpaceld, the UE continues to monitor PDCCH candidates in the search space set provided by recoverySearchSpaceld until the UE receives DCI indication (e.g., DCI format 1_1 or 1_2 with or without DL assignment), MAC CE activation command or RRC reconfiguration for a Rel. 17 unified TCI state.

In yet another example, under the Rel. 17 unified TCI framework when a UE is configured with/provided by the network TCI-State_r17 indicating a unified TCI state, X symbols after receiving the BFRR, i.e., (i) X symbols from a last symbol of a PDCCH reception in a search space set provided by recoverySearchSpaceId where the UE detects a DCI format with CRC scrambled by C-RNTI or MCS-C-RNTI for the PCell or PSCell, or (ii) X symbols from a last symbol of a PDCCH reception that determines the completion of the contention based random access procedure for BFR as described in the 3GPP TS 38.321 for the PCell or the PSCell, or (iii) X symbols from a last symbol of a PDCCH reception with a DCI format scheduling a PUSCH transmission with a same HARQ process number as for the transmission of the PUSCH carrying the MAC CE for BFR and having a toggled NDI field value for the SCell, following example can be considered for the PUCCH(s) and PUSCH(s).

For PUCCH(s): if the UE receives or is configured a joint DL and UL TCI state via the Rel. 17 TCI state/beam indication (e.g., provided by the higher layer parameter TCI-State_r17) and/or the UE identifies a new beam, i.e., q_new, the UE could transmit PUCCH including all of dedicated PUCCHs (or PUCCH resources) in a CC or in a set of configured CCs configured with one or more Rel. 17 TCI states/beams (e.g., provided by the higher layer parameter TCI-State_r17) activation or update using a same spatial filter as the one associated with index q_new of the NBI RS resource identified by the UE from the NBI RS beam set (e.g., denoted by q1), and/or a power determined as described in the 3GPP TS 38.213 clause 7.2.1 with the UL power control parameters (such as q_u, q_d, closed loop index 1) associated with the Rel. 17 TCI state associated with index q_new, e.g., q_u=0, q_d=q_new, closed loop index 1=0 or 1.

For PUCCH(s): if the UE receives or is configured separate DL/UL TCI state(s) via the Rel. 17 TCI state/beam indication (e.g., provided by the higher layer parameter TCI-State_r17) and/or the UE cannot identify any new beam, the UE could transmit PUCCH including all of dedicated PUCCHs (or PUCCH resources) in a CC or in a set of configured CCs configured with one or more Rel. 17 TCI states/beams (e.g., provided by the higher layer parameter TCI-State_r17) activation or update using a same spatial filter as the one used for transmitting the last PRACH, and/or a power determined as described in the 3GPP TS 38.213 clause 7.2.1 with the UL power control parameters q_u=0, q_d=q_new and closed loop index 1=0.

For PUSCH(s): if the UE receives or is configured a joint DL and UL TCI state via the Rel. 17 TCI state/beam indication (e.g., provided by the higher layer parameter TCI-State_r17) and/or the UE identifies a new beam, i.e., q_new, the UE could transmit PUSCH including all dynamic-grant/configured-grant based PUSCHs (or PUSCH resources) in a CC or in a set of configured CCs configured with one or more Rel. 17 TCI states/beams (e.g., provided by the higher layer parameter TCI-State_r17) activation or update using a same spatial filter as the one associated with index q_new of the NBI RS resource identified by the UE from the NBI RS beam set (e.g., denoted by q1), and/or a power determined as described in the 3GPP TS 38.213 clause 7.2.1 with the UL power control parameters (such as q_u, q_d, closed loop index 1) associated with the Rel. 17 TCI state associated with index q_new, e.g., q_u=0, q_d=q new, closed loop index 1=0 or 1.

For PUSCH(s): if the UE receives or is configured separate DL/UL TCI state(s) via the Rel. 17 TCI state/beam indication (e.g., provided by the higher layer parameter TCI-State_r17) and/or the UE cannot identify any new beam, the UE could transmit PUSCH including all dynamic-grant/configured-grant based PUSCHs (or PUSCH resources) in a CC or in a set of configured CCs configured with one or more Rel. 17 TCI states/beams (e.g., provided by the higher layer parameter TCI-State_r17) activation or update using a same spatial filter as the one used for transmitting the last PRACH, and/or a power determined as described in the 3GPP TS 38.213 clause 7.2.1 with the UL power control parameters q_u=0, q_d=q_new and closed loop index 1=0.

For other signals/channels than PDCCH/PDSCH including UE-dedicated PDCCH(s)/PDSCH(s) and/or PUCCH/PUSCH including dynamic-grant/configured-grant based PUSCH(s) and dedicated PUCCH(s), e.g., aperiodic CSI-RS resource from a CSI-RS resource set sharing the same indicated TCI state as for the PDCCH/PDSCH and SRS sharing the same indicated TCI state as for the PUCCH/PUSCH, following example can be considered.

In one example, if the UE receives or is configured a joint DL and UL TCI state via the Rel. 17 TCI state/beam indication (e.g., provided by the higher layer parameter TCI-State_r17) and/or the UE identifies a new beam, i.e., q_new, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in a CC or in a set of configured CCs configured with one or more Rel. 17 TCI states/beams (e.g., provided by the higher layer parameter TCI-State_r17) activation or update using a same spatial filter as the one associated with index q_new of the NBI RS resource identified by the UE from the NBI RS beam set (e.g., denoted by q1).

In another example, if the UE receives or is configured separate DL/UL TCI state(s) via the Rel. 17 TCI state/beam indication (e.g., provided by the higher layer parameter TCI-State_r17) and/or the UE cannot identify any new beam, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in a CC or in a set of configured CCs configured with one or more Rel. 17 TCI states/beams (e.g., provided by the higher layer parameter TCI-State_r17) activation or update using a same spatial filter as the one used for transmitting the last PRACH.

The value of X could correspond to 28, i.e., 28 symbols. Furthermore, the subcarrier spacing (SCS) for the X=28 symbols could correspond to one or more of: (1) the smallest of the SCS configurations of the active DL BWP for the PDCCH reception and of the active DL BWP(s) of the serving cell; or (2) the smallest of the SCS configurations of all the signal(s)/channels sharing the same indicated Rel. 17 TCI state/beam (e.g., provided by the higher layer parameter TCI-State_r17).

In yet another example, under the Rel. 17 unified TCI framework when a UE is configured with/provided by the network TCI-State_r17 indicating a unified TCI state, X symbols after receiving the BFRR, i.e., (i) X symbols from a last symbol of a PDCCH reception in a search space set provided by recoverySearchSpaceId where the UE detects a DCI format with CRC scrambled by C-RNTI or MCS-C-RNTI for the PCell or PSCell, or (ii) X symbols from a last symbol of a PDCCH reception that determines the completion of the contention based random access procedure for BFR as described in the 3GPP TS 38.321 for the PCell or the PSCell, or (iii) X symbols from a last symbol of a PDCCH reception with a DCI format scheduling a PUSCH transmission with a same HARQ process number as for the transmission of the PUSCH carrying the MAC CE for BFR and having a toggled NDI field value for the SCell, following example can be considered for the PUCCH(s) and PUSCH(S).

For PUCCH(s): if the UE receives or is configured a joint DL and UL TCI state via the Rel. 17 TCI state/beam indication (e.g., provided by the higher layer parameter TCI-State_r17) and/or the UE identifies a new beam, i.e., q_new, for a CC from a set of G≥1 CCs configured with one or more Rel. 17 TCI states/beams (e.g., provided by the higher layer parameter TCI-State_r17) activation or update, the UE could transmit PUCCH including all of dedicated PUCCHs (or PUCCH resources) in the CC using a same spatial filter as the one associated with a RS resource (e.g., a SSB index/SSB resource or a CSI-RS resource/CSI-RS resource configuration index) in the CC, and/or a power determined as described in the 3GPP TS 38.213 clause 7.2.1 with the UL power control parameters (such as q_u, q_d, closed loop index 1) associated with the Rel. 17 TCI state associated with the RS resource (e.g., a SSB index/SSB resource or a CSI-RS resource/CSI-RS resource configuration index) in the CC, wherein the RS resource in the CC is associated with/linked to the index q_new.

For instance, q_u=0, q_d=q_new, closed loop index 1=0 or 1, and q_new could correspond to the index of the RS resource in the NBI RS beam set q1 configured to the UE for new/candidate beam identification in the CC. The UE applies the procedure/assumption to transmit PUCCH including all of dedicated PUCCHs (or PUCCH resources) across all the G≥1 CCs configured with one or more Rel. 17 TCI states/beams (e.g., provided by the higher layer parameter TCI-State_r17) activation or update.

For PUCCH(s): if the UE receives or is configured separate DL/UL TCI state(s) via the Rel. 17 TCI state/beam indication (e.g., provided by the higher layer parameter TCI-State_r17) and/or the UE cannot identify any new beam, for a CC from a set of G≥1 CCs configured with one or more Rel. 17 TCI states/beams (e.g., provided by the higher layer parameter TCI-State_r17) activation or update, the UE could transmit PUCCH including all of dedicated PUCCHs (or PUCCH resources) in the CC using a same spatial filter as the one used for transmitting the last PRACH in the CC, and/or a power determined as described in the 3GPP TS 38.213 clause 7.2.1 with the UL power control parameters q_u=0, q_d=q_new and closed loop index 1=0. The UE applies the procedure/assumption to transmit PUCCH including all of dedicated PUCCHs (or PUCCH resources) across all the G≥1 CCs configured with one or more Rel. 17 TCI states/beams (e.g., provided by the higher layer parameter TCI-State_r17) activation or update.

For PUSCH(s): if the UE receives or is configured a joint DL and UL TCI state via the Rel. 17 TCI state/beam indication (e.g., provided by the higher layer parameter TCI-State_r17) and/or the UE identifies a new beam, i.e., q_new, for a CC from a set of G≥1 CCs configured with one or more Rel. 17 TCI states/beams (e.g., provided by the higher layer parameter TCI-State_r17) activation or update, the UE could transmit PUSCH including all dynamic-grant/configured-grant based PUSCHs (or PUSCH resources) in the CC using a same spatial filter as the one associated with the RS resource (e.g., a SSB index/SSB resource or a CSI-RS resource/CSI-RS resource configuration index) in the CC, and/or a power determined as described in the 3GPP TS 38.213 clause 7.2.1 with the UL power control parameters (such as q_u, q_d, closed loop index 1) associated with the Rel. 17 TCI state associated with the RS resource (e.g., a SSB index/SSB resource or a CSI-RS resource/CSI-RS resource configuration index) in the CC, where the RS resource is associated with/linked to the index q_new. For instance, q_u=0, q_d=q_new, closed loop index 1=0 or 1, and q_new could correspond to the index of the RS resource in the NBI RS beam set q1 configured to the UE for new/candidate beam identification in the CC. The UE applies the procedure/assumption to transmit PUSCH including all dynamic-grant/configured-grant based PUSCHs (or PUSCH resources) across all the G≥1 CCs configured with one or more Rel. 17 TCI states/beams (e.g., provided by the higher layer parameter TCI-State_r17) activation or update.

For PUSCH(s): if the UE receives or is configured separate DL/UL TCI state(s) via the Rel. 17 TCI state/beam indication (e.g., provided by the higher layer parameter TCI-State_r17) and/or the UE cannot identify any new beam, for a CC from a set of G≥1 CCs configured with one or more Rel. 17 TCI states/beams (e.g., provided by the higher layer parameter TCI-State_r17) activation or update, the UE could transmit PUSCH including all dynamic-grant/configured-grant based PUSCHs (or PUSCH resources) in the CC using a same spatial filter as the one used for transmitting the last PRACH in the CC, and/or a power determined as described in the 3GPP TS 38.213 clause 7.2.1 with the UL power control parameters q_u=0, q_d=q_new and closed loop index 1=0. The UE applies the procedure/assumption to transmit PUSCH including all dynamic-grant/configured-grant based PUSCHs (or PUSCH resources) across all the G≥1 CCs configured with one or more Rel. 17 TCI states/beams (e.g., provided by the higher layer parameter TCI-State_r17) activation or update.

For other signals/channels than PDCCH/PDSCH including UE-dedicated PDCCH(s)/PDSCH(s) and/or PUCCH/PUSCH including dynamic-grant/configured-grant based PUSCH(s) and dedicated PUCCH(s), e.g., aperiodic CSI-RS resource from a CSI-RS resource set sharing the same indicated TCI state as for the PDCCH/PDSCH and SRS sharing the same indicated TCI state as for the PUCCH/PUSCH, following examples can be considered.

In one example, if the UE receives or is configured a joint DL and UL TCI state via the Rel. 17 TCI state/beam indication (e.g., provided by the higher layer parameter TCI-State_r17) and/or the UE identifies a new beam, i.e., q_new, for a CC from a set of G≥1 CCs configured with one or more Rel. 17 TCI states/beams (e.g., provided by the higher layer parameter TCI-State_r17) activation or update, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in the CC using a same spatial filter as the one associated with index q_new of the NBI RS resource identified by the UE from the NBI RS beam set (e.g., denoted by q1). The UE applies the procedure/assumption to transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources across all the G≥1 CCs configured with one or more Rel. 17 TCI states/beams (e.g., provided by the higher layer parameter TCI-State_r17) activation or update.

In another example, if the UE receives or is configured separate DL/UL TCI state(s) via the Rel. 17 TCI state/beam indication (e.g., provided by the higher layer parameter TCI-State_r17) and/or the UE cannot identify any new beam, for a CC from a set of G≥1 CCs configured with one or more Rel. 17 TCI states/beams (e.g., provided by the higher layer parameter TCI-State_r17) activation or update, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in the CC using a same spatial filter as the one used for transmitting the last PRACH in the CC. The UE applies the procedure/assumption to transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources across all the G≥1 CCs configured with one or more Rel. 17 TCI states/beams (e.g., provided by the higher layer parameter TCI-State_r17) activation or update.

The value of X could correspond to 28, i.e., 28 symbols. Furthermore, the subcarrier spacing (SCS) for the X=28 symbols could correspond to one or more of: (1) the smallest of the SCS configurations of the active DL BWP for the PDCCH reception and of the active DL BWP(s) of the serving cell; or (2) the smallest of the SCS configurations of all the signal(s)/channels sharing the same indicated Rel. 17 TCI state/beam (e.g., provided by the higher layer parameter TCI-State_r17).

In yet another example, under the Rel. 17 unified TCI framework when a UE is configured with/provided by the network TCI-State_r17 indicating a unified TCI state, X symbols after receiving the BFRR, i.e., (i) X symbols from a last symbol of a PDCCH reception in a search space set provided by recoverySearchSpaceId where the UE detects a DCI format with CRC scrambled by C-RNTI or MCS-C-RNTI for the PCell or PSCell, or (ii) X symbols from a last symbol of a PDCCH reception that determines the completion of the contention based random access procedure for BFR as described in the 3GPP TS 38.321 for the PCell or the PSCell, or (iii) X symbols from a last symbol of a PDCCH reception with a DCI format scheduling a PUSCH transmission with a same HARQ process number as for the transmission of the PUSCH carrying the MAC CE for BFR and having a toggled NDI field value for the SCell, following examples can be considered for the PUCCH(S) and the PUSCH(S).

For PUCCH(s): if the UE receives or is configured a Rel. 17 TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), and/or the UE identifies a new beam, i.e., q_new, the UE could transmit PUCCH including all of dedicated PUCCHs (or PUCCH resources) in a CC or in a set of configured CCs configured with one or more Rel. 17 TCI states/beams (e.g., provided by the higher layer parameter TCI-State_r17) activation or update using a same spatial filter as the one associated with index q_new of the NBI RS resource identified by the UE from the NBI RS beam set (e.g., denoted by q1) for transmitting the last PRACH, and/or a power determined as described in the 3GPP TS 38.213 clause 7.2.1 with the UL power control parameters (such as q_u, q_d, closed loop index 1) associated with the Rel. 17 TCI state associated with index q_new, e.g., q_u=0, q_d=q_new, closed loop index 1=0 or 1.

For PUCCH(s): if the UE cannot identify any new beam, the UE could transmit PUCCH including all of dedicated PUCCHs (or PUCCH resources) in a CC or in a set of configured CCs configured with one or more Rel. 17 TCI states/beams (e.g., provided by the higher layer parameter TCI-State_r17) activation or update using a same spatial filter as the one used for transmitting the last PRACH, and/or a power determined as described in the 3GPP TS 38.213 clause 7.2.1 with the UL power control parameters q_u=0, q_d=q_new and closed loop index 1=0.

For PUSCH(s): if the UE receives or is configured a Rel. 17 TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), and/or the UE identifies a new beam, i.e., q_new, the UE could transmit PUSCH including all dynamic-grant/configured-grant based PUSCHs (or PUSCH resources) in a CC or in a set of configured CCs configured with one or more Rel. 17 TCI states/beams (e.g., provided by the higher layer parameter TCI-State_r17) activation or update using a same spatial filter as the one associated with index q_new of the NBI RS resource identified by the UE from the NBI RS beam set (e.g., denoted by q1) for transmitting the last PRACH, and/or a power determined as described in the 3GPP TS 38.213 clause 7.2.1 with the UL power control parameters (such as q_u, q_d, closed loop index 1) associated with the Rel. 17 TCI state associated with index q_new, e.g., q_u=0, q_d=q_new, closed loop index 1=0 or 1.

For PUSCH(s): if the UE cannot identify any new beam, the UE could transmit PUSCH including all dynamic-grant/configured-grant based PUSCHs (or PUSCH resources) in a CC or in a set of configured CCs configured with one or more Rel. 17 TCI states/beams (e.g., provided by the higher layer parameter TCI-State_r17) activation or update using a same spatial filter as the one used for transmitting the last PRACH, and/or a power determined as described in the 3GPP TS 38.213 clause 7.2.1 with the UL power control parameters q_u=0, q_d=q_new and closed loop index 1=0.

For other signals/channels than PDCCH/PDSCH including UE-dedicated PDCCH(s)/PDSCH(s) and/or PUCCH/PUSCH including dynamic-grant/configured-grant based PUSCH(s) and dedicated PUCCH(s), e.g., aperiodic CSI-RS resource from a CSI-RS resource set sharing the same indicated TCI state as for the PDCCH/PDSCH and SRS sharing the same indicated TCI state as for the PUCCH/PUSCH, following example can be considered.

In one example, if the UE receives or is configured a Rel. 17 TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17) and/or the UE identifies a new beam, i.e., q_new, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in a CC or in a set of configured CCs configured with one or more Rel. 17 TCI states/beams (e.g., provided by the higher layer parameter TCI-State_r17) activation or update using a same spatial filter as the one associated with index q_new of the NBI RS resource identified by the UE from the NBI RS beam set (e.g., denoted by q1) for transmitting the last PRACH.

In another example, if the UE cannot identify any new beam, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in a CC or in a set of configured CCs configured with one or more Rel. 17 TCI states/beams (e.g., provided by the higher layer parameter TCI-State_r17) activation or update using a same spatial filter as the one used for transmitting the last PRACH.

The value of X could correspond to 28, i.e., 28 symbols. Furthermore, the subcarrier spacing (SCS) for the X=28 symbols could correspond to one or more of: (1) the smallest of the SCS configurations of the active DL BWP for the PDCCH reception and of the active DL BWP(s) of the serving cell; or (2) the smallest of the SCS configurations of all the signal(s)/channels sharing the same indicated Rel. 17 TCI state/beam (e.g., provided by the higher layer parameter TCI-State_r17).

In yet another example, under the Rel. 17 unified TCI framework when a UE is configured with/provided by the network TCI-State_r17 indicating a unified TCI state, X symbols after receiving the BFRR, i.e., (i) X symbols from a last symbol of a PDCCH reception in a search space set provided by recoverySearchSpaceId where the UE detects a DCI format with CRC scrambled by C-RNTI or MCS-C-RNTI for the PCell or PSCell, or (ii) X symbols from a last symbol of a PDCCH reception that determines the completion of the contention based random access procedure for BFR as described in the 3GPP TS 38.321 for the PCell or the PSCell, or (iii) X symbols from a last symbol of a PDCCH reception with a DCI format scheduling a PUSCH transmission with a same HARQ process number as for the transmission of the PUSCH carrying the MAC CE for BFR and having a toggled NDI field value for the SCell, following example can be considered for the PUCCH(S) and the PUSCH(S).

For PUCCH(s): if the UE receives or is configured a Rel. 17 TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), and/or the UE identifies a new beam, i.e., q_new, for a CC from a set of G≥1 CCs configured with one or more Rel. 17 TCI states/beams (e.g., provided by the higher layer parameter TCI-State_r17) activation or update, the UE could transmit PUCCH including all of dedicated PUCCHs (or PUCCH resources) in the CC using a same spatial filter as the one associated with a RS resource (e.g., a SSB index/SSB resource or a CSI-RS resource/CSI-RS resource configuration index) in the CC for transmitting the last PRACH in the CC, and/or a power determined as described in the 3GPP TS 38.213 clause 7.2.1 with the UL power control parameters (such as q_u, q_d, closed loop index 1) associated with the Rel. 17 TCI state associated with the RS resource (e.g., a SSB index/SSB resource or a CSI-RS resource/CSI-RS resource configuration index) in the CC, wherein the RS resource in the CC is associated with/linked to the index q_new.

For instance, q_u=0, q_d=q_new, closed loop index 1=0 or 1, and q_new could correspond to the index of the RS resource in the NBI RS beam set q1 configured to the UE for new/candidate beam identification in the CC. The UE applies the procedure/assumption to transmit PUCCH including all of dedicated PUCCHs (or PUCCH resources) across all the G≥1 CCs configured with one or more Rel. 17 TCI states/beams (e.g., provided by the higher layer parameter TCI-State_r17) activation or update.

For PUCCH(s): if the UE cannot identify any new beam, for a CC from a set of G≥1 CCs configured with one or more Rel. 17 TCI states/beams (e.g., provided by the higher layer parameter TCI-State_r17) activation or update, the UE could transmit PUCCH including all of dedicated PUCCHs (or PUCCH resources) in the CC using a same spatial filter as the one used for transmitting the last PRACH in the CC, and/or a power determined as described in the 3GPP TS 38.213 clause 7.2.1 with the UL power control parameters q_u=0, q_d=q_new and closed loop index 1=0. The UE applies the procedure/assumption to transmit PUCCH including all of dedicated PUCCHs (or PUCCH resources) across all the G≥1 CCs configured with one or more Rel. 17 TCI states/beams (e.g., provided by the higher layer parameter TCI-State_r17) activation or update.

For PUSCH(s): if the UE receives or is configured a Rel. 17 TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17), and/or the UE identifies a new beam, i.e., q_new, for a CC from a set of G≥1 CCs configured with one or more Rel. 17 TCI states/beams (e.g., provided by the higher layer parameter TCI-State_r17) activation or update, the UE could transmit PUSCH including all dynamic-grant/configured-grant based PUSCHs (or PUSCH resources) in the CC using a same spatial filter as the one associated with the RS resource (e.g., a SSB index/SSB resource or a CSI-RS resource/CSI-RS resource configuration index) in the CC for transmitting the last PRACH in the CC, and/or a power determined as described in the 3GPP TS 38.213 clause 7.2.1 with the UL power control parameters (such as q_u, q_d, closed loop index 1) associated with the Rel. 17 TCI state associated with the RS resource (e.g., a SSB index/SSB resource or a CSI-RS resource/CSI-RS resource configuration index) in the CC, where the RS resource is associated with/linked to the index q_new.

For instance, q_u=0, q_d=q_new, closed loop index 1=0 or 1, and q_new could correspond to the index of the RS resource in the NBI RS beam set q1 configured to the UE for new/candidate beam identification in the CC. The UE applies the procedure/assumption to transmit PUSCH including all dynamic-grant/configured-grant based PUSCHs (or PUSCH resources) across all the G≥1 CCs configured with one or more Rel. 17 TCI states/beams (e.g., provided by the higher layer parameter TCI-State_r17) activation or update.

For PUSCH(s): if the UE cannot identify any new beam, for a CC from a set of G≥1 CCs configured with one or more Rel. 17 TCI states/beams (e.g., provided by the higher layer parameter TCI-State_r17) activation or update, the UE could transmit PUSCH including all dynamic-grant/configured-grant based PUSCHs (or PUSCH resources) in the CC using a same spatial filter as the one used for transmitting the last PRACH in the CC, and/or a power determined as described in the 3GPP TS 38.213 clause 7.2.1 with the UL power control parameters q_u=0, q_d=q_new and closed loop index 1=0. The UE applies the procedure/assumption to transmit PUSCH including all dynamic-grant/configured-grant based PUSCHs (or PUSCH resources) across all the G≥1 CCs configured with one or more Rel. 17 TCI states/beams (e.g., provided by the higher layer parameter TCI-State_r17) activation or update.

For other signals/channels than PDCCH/PDSCH including UE-dedicated PDCCH(s)/PDSCH(s) and/or PUCCH/PUSCH including dynamic-grant/configured-grant based PUSCH(s) and dedicated PUCCH(s), e.g., aperiodic CSI-RS resource from a CSI-RS resource set sharing the same indicated TCI state as for the PDCCH/PDSCH and SRS sharing the same indicated TCI state as for the PUCCH/PUSCH, following examples can be considered.

In one example, if the UE receives or is configured a Rel. 17 TCI state/beam indication (e.g., the UE is configured with a DL TCI state or an UL TCI state or a joint DL and UL TCI state or a separate DL TCI state and a separate UL TCI state via the Rel. 17 TCI state/beam indication, e.g., provided by the higher layer parameter TCI-State_r17) and/or the UE identifies a new beam, i.e., q_new, for a CC from a set of G≥1 CCs configured with one or more Rel. 17 TCI states/beams (e.g., provided by the higher layer parameter TCI-State_r17) activation or update, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in the CC using a same spatial filter as the one associated with index q_new of the NBI RS resource identified by the UE from the NBI RS beam set (e.g., denoted by q1) for transmitting the last PRACH in the CC.

The UE applies the procedure/assumption to transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources across all the G≥1 CCs configured with one or more Rel. 17 TCI states/beams (e.g., provided by the higher layer parameter TCI-State_r17) activation or update.

In another example, if the UE cannot identify any new beam, for a CC from a set of G≥1 CCs configured with one or more Rel. 17 TCI states/beams (e.g., provided by the higher layer parameter TCI-State_r17) activation or update, the UE could transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources in the CC using a same spatial filter as the one used for transmitting the last PRACH in the CC. The UE applies the procedure/assumption to transmit other signals/channels sharing the same Rel. 17 TCI state/beam (e.g., provided by the higher layer parameter TCI-State_r17) as for the PUCCH/PUSCH including the dynamic-grant/configured-grant based PUSCHs and all of dedicated PUCCH resources across all the G≥1 CCs configured with one or more Rel. 17 TCI states/beams (e.g., provided by the higher layer parameter TCI-State_r17) activation or update.

The value of X could correspond to 28, i.e., 28 symbols. Furthermore, the subcarrier spacing (SCS) for the X=28 symbols could correspond to one or more of: (1) the smallest of the SCS configurations of the active DL BWP for the PDCCH reception and of the active DL BWP(s) of the serving cell; or (2) the smallest of the SCS configurations of all the signal(s)/channels sharing the same indicated Rel. 17 TCI state/beam (e.g., provided by the higher layer parameter tci-StateId_r17).

In yet another example, Y symbols after receiving the BFRR, the UE may apply the same receive filter as that for receiving the new beam to receive the subsequent PDSCH(s) until the UE receives a TCI state update for the PDSCH(s).

For PDCCH(s): the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR to receive the subsequent PDCCH(s) until the UE receives a TCI state update for the PDCCH(s).

For PUCCH(s) or PUSCH(s): the UE may apply a transmit filter same as the receive filter for receiving the PDCCH(s) or PDSCH(s) prior to receiving the BFRR to transmit the subsequent PUCCH(s) or PUSCH(s) until the UE receives a TCI state/spatial relation information update for the PUCCH(s) or PUSCH(s). Alternatively, the UE may apply a transmit filter same as the receive filter for receiving the BFRR to transmit the subsequent PUCCH(s) or PUSCH(s) until the UE receives a TCI state/spatial relation information update for the PUCCH(s) or PUSCH(s).

In yet another example, K symbols after receiving the BFRR, the UE may apply a transmit filter same as the receive filter for receiving the new beam to transmit the subsequent PUCCH(s) until the UE receives a TCI state/spatial relation information update for the PUCCH(s).

For PDCCH(s) or PDSCH(s): the UE may apply the same receive filter as that for receiving the PDCCH(s) or PDSCH(s) prior to receiving the BFRR to receive the subsequent PDCCH(s) or PDSCH(s) until the UE receives a TCI state update for the PDCCH(s) or PDSCH(s). Alternatively, the UE may apply the same receive filter as that for receiving the BFRR to receive the subsequent PDCCH(s) or PDSCH(s) until the UE receives a TCI state update for the PDCCH(s) or PDSCH(s).

For PUSCH(s): the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR to transmit the subsequent PUSCH(s) until the UE receives a TCI state/spatial relation information update for the PUSCH(s).

In yet another example, L symbols after receiving the BFRR, the UE may apply a transmit filter same as the receive filter for receiving the new beam to transmit the subsequent PUSCH(s) until the UE receives a TCI state/spatial relation information update for the PUSCH(s).

For PDCCH(s) or PDSCH(s): the UE may apply the same receive filter as that for receiving the PDCCH(s) or PDSCH(s) prior to receiving the BFRR to receive the subsequent PDCCH(s) or PDSCH(s) until the UE receives a TCI state update for the PDCCH(s) or PDSCH(s). Alternatively, the UE may apply the same receive filter as that for receiving the BFRR to receive the subsequent PDCCH(s) or PDSCH(s) until the UE receives a TCI state update for the PDCCH(s) or PDSCH(s).

For PUCCH(s): the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR to transmit the subsequent PUCCH(s) until the UE receives a TCI state/spatial relation information update for the PUCCH(s).

In yet another example, X symbols after receiving the BFRR, the UE may apply the same receive filter as that for receiving the new beam to receive the subsequent PDCCH(s) until the UE receives a TCI state update for the PDCCH(s). Furthermore, Y symbols after receiving the BFRR, the UE may apply the same receive filter as that for receiving the new beam to receive the subsequent PDSCH(s) until the UE receives a TCI state update for the PDSCH(s).

For PUCCH(s) or PUSCH(s): the UE may apply a transmit filter same as the receive filter for receiving the PDCCH(s) or PDSCH(s) prior to receiving the BFRR to transmit the subsequent PUCCH(s) or PUSCH(s) until the UE receives a TCI state/spatial relation information update for the PUCCH(s) or PUSCH(s). Alternatively, the UE may apply a transmit filter same as the receive filter for receiving the BFRR to transmit the subsequent PUCCH(s) or PUSCH(s) until the UE receives a TCI state/spatial relation information update for the PUCCH(s) or PUSCH(s).

In yet another example, X symbols after receiving the BFRR, the UE may apply the same receive filter as that for receiving the new beam to receive the subsequent PDCCH(s) until the UE receives a TCI state update for the PDCCH(s). Furthermore, K symbols after receiving the BFRR, the UE may apply a transmit filter same as the receive filter for receiving the new beam to transmit the subsequent PUCCH(s) until the UE receives a TCI state/spatial relation information update for the PUCCH(s).

For PDSCH(s): the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR to receive the subsequent PDSCH(s) until the UE receives a TCI state update for the PDSCH(s).

For PUSCH(s): the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR to transmit the subsequent PUSCH(s) until the UE receives a TCI state/spatial relation information update for the PUSCH(s).

In yet another example, X symbols after receiving the BFRR, the UE may apply the same receive filter as that for receiving the new beam to receive the subsequent PDCCH(s) until the UE receives a TCI state update for the PDCCH(s). Furthermore, L symbols after receiving the BFRR, the UE may apply a transmit filter same as the receive filter for receiving the new beam to transmit the subsequent PUSCH(s) until the UE receives a TCI state/spatial relation information update for the PUSCH(s).

For PDSCH(s): the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR to receive the subsequent PDSCH(s) until the UE receives a TCI state update for the PDSCH(s).

For PUCCH(s): the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR to transmit the subsequent PUCCH(s) until the UE receives a TCI state/spatial relation information update for the PUCCH(s).

In yet another example, X symbols after receiving the BFRR, the UE may apply the same receive filter as that for receiving the new beam to receive the subsequent PDCCH(s) until the UE receives a TCI state update for the PDCCH(s). Furthermore, Y symbols after receiving the BFRR, the UE may apply the same receive filter as that for receiving the new beam to receive the subsequent PDSCH(s) until the UE receives a TCI state update for the PDSCH(s). In addition, K symbols after receiving the BFRR, the UE may apply a transmit filter same as the receive filter for receiving the new beam to transmit the subsequent PUCCH(s) until the UE receives a TCI state/spatial relation information update for the PUCCH(s).

For PUSCH(s): the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR to transmit the subsequent PUSCH(s) until the UE receives a TCI state/spatial relation information update for the PUSCH(s).

In yet another example, X symbols after receiving the BFRR, the UE may apply the same receive filter as that for receiving the new beam to receive the subsequent PDCCH(s) until the UE receives a TCI state update for the PDCCH(s). Furthermore, Y symbols after receiving the BFRR, the UE may apply the same receive filter as that for receiving the new beam to receive the subsequent PDSCH(s) until the UE receives a TCI state update for the PDSCH(s). In addition, L symbols after receiving the BFRR, the UE may apply a transmit filter same as the receive filter for receiving the new beam to transmit the subsequent PUSCH(s) until the UE receives a TCI state/spatial relation information update for the PUSCH(s).

For PUCCH(s): the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR to transmit the subsequent PUCCH(s) until the UE receives a TCI state/spatial relation information update for the PUCCH(s).

In yet another example, X symbols after receiving the BFRR, the UE may apply the same receive filter as that for receiving the new beam to receive the subsequent PDCCH(s) until the UE receives a TCI state update for the PDCCH(s). Furthermore, K symbols after receiving the BFRR, the UE may apply a transmit filter same as the receive filter for receiving the new beam to transmit the subsequent PUCCH(s) until the UE receives a TCI state update for the PUCCH(s). In addition, L symbols after receiving the BFRR, the UE may apply a transmit filter same as the receive filter for receiving the new beam to transmit the subsequent PUSCH(s) until the UE receives a TCI state/spatial relation information update for the PUSCH(s).

For PDSCH(s): the UE may apply the same receive filter as that for receiving the PDCCH(s) or PDSCH(s) prior to receiving the BFRR to receive the subsequent PDSCH(s) until the UE receives a TCI state update for the PDSCH(s). Alternatively, the UE may apply the same receive filter as that for receiving the BFRR to receive the subsequent PDSCH(s) until the UE receives a TCI state update for the PDSCH(s).

In yet another example, Y symbols after receiving the BFRR, the UE may apply the same receive filter as that for receiving the new beam to receive the subsequent PDSCH(s) until the UE receives a TCI state update for the PDSCH(s). Furthermore, K symbols after receiving the BFRR, the UE may apply a transmit filter same as the receive filter for receiving the new beam to transmit the subsequent PUCCH(s) until the UE receives a TCI state/spatial relation information update for the PUCCH(s).

For PDCCH(s): the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR to receive the subsequent PDCCH(s) until the UE receives a TCI state update for the PDCCH(s).

For PUSCH(s): the UE may apply a transmit filter same as the receive filter for receiving the PDCCH(s) or PDSCH(s) prior to receiving the BFRR to transmit the subsequent PUSCH(s) until the UE receives a TCI state/spatial relation information update for the PUSCH(s). Alternatively, the UE may apply a transmit filter same as the receive filter for receiving the BFRR to transmit the subsequent PUSCH(s) until the UE receives a TCI state/spatial relation information update for the PUSCH(s).

In yet another example, Y symbols after receiving the BFRR, the UE may apply the same receive filter as that for receiving the new beam to receive the subsequent PDSCH(s) until the UE receives a TCI state update for the PDSCH(s). Furthermore, L symbols after receiving the BFRR, the UE may apply a transmit filter same as the receive filter for receiving the new beam to transmit the subsequent PUSCH(s) until the UE receives a TCI state/spatial relation information update for the PUSCH(s).

For PDCCH(s): the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR to receive the subsequent PDCCH(s) until the UE receives a TCI state update for the PDCCH(s).

For PUCCH(s): the UE may apply a transmit filter same as the receive filter for receiving the PDCCH(s) or PDSCH(s) prior to receiving the BFRR to transmit the subsequent PUCCH(s) until the UE receives a TCI state/spatial relation information update for the PUCCH(s). Alternatively, the UE may apply a transmit filter same as the receive filter for receiving the BFRR to transmit the subsequent PUCCH(s) until the UE receives a TCI state/spatial relation information update for the PUCCH(s).

In yet another example, Y symbols after receiving the BFRR, the UE may apply the same receive filter as that for receiving the new beam to receive the subsequent PDSCH(s) until the UE receives a TCI state update for the PDSCH(s). Furthermore, K symbols after receiving the BFRR, the UE may apply a transmit filter same as the receive filter for receiving the new beam to transmit the subsequent PUCCH(s) until the UE receives a TCI state update for the PUCCH(s). In addition, L symbols after receiving the BFRR, the UE may apply a transmit filter same as the receive filter for receiving the new beam to transmit the subsequent PUSCH(s) until the UE receives a TCI state/spatial relation information update for the PUSCH(s).

For PDCCH(s): the UE may apply the same receive filter as that for receiving the PDCCH(s) or PDSCH(s) prior to receiving the BFRR to receive the subsequent PDCCH(s) until the UE receives a TCI state update for the PDCCH(s). Alternatively, the UE may apply the same receive filter as that for receiving the BFRR to receive the subsequent PDCCH(s) until the UE receives a TCI state update for the PDCCH(s).

In yet another example, K symbols after receiving the BFRR, the UE may apply a transmit filter same as that for receiving the new beam to transmit the subsequent PUCCH(s) until the UE receives a TCI state/spatial relation information update for the PUCCH(s). Furthermore, L symbols after receiving the BFRR, the UE may apply a transmit filter same as the receive filter for receiving the new beam to transmit the subsequent PUSCH(s) until the UE receives a TCI state/spatial relation information update for the PUSCH(s).

For PDCCH(s) or PDSCH(s): the UE may apply the same receive filter as that for receiving the PDCCH(s) or PDSCH(s) prior to receiving the BFRR to receive the subsequent PDCCH(s) or PDSCH(s) until the UE receives a TCI state update for the PDCCH(s) or PDSCH(s). Alternatively, the UE may apply the same receive filter as that for receiving the BFRR to receive the subsequent PDCCH(s) or PDSCH(s) until the UE receives a TCI state update for the PDCCH(s) or PDSCH(s).

In yet another example, X symbols after receiving the BFRR, the UE may apply the same receive filter as that for receiving the new beam to receive the subsequent PDCCH(s) until the UE receives a TCI state update for the PDCCH(s). Furthermore, Y symbols after receiving the BFRR, the UE may apply the same receive filter as that for receiving the new beam to receive the subsequent PDSCH(s) until the UE receives a TCI state update for the PDSCH(s). In addition, K symbols after receiving the BFRR, the UE may apply a transmit filter same as the receive filter for receiving the new beam to transmit the subsequent PUCCH(s) until the UE receives a TCI state update for the PUCCH(s). Also, L symbols after receiving the BFRR, the UE may apply a transmit filter same as the receive filter for receiving the new beam to transmit the subsequent PUSCH(s) until the UE receives a TCI state/spatial relation information update for the PUSCH(s).

Various methods of configuring/indicating the values of X, Y, K, and L are presented below.

In one example, the values of X, Y, K, and L are fixed in the system specifications. For example, the values of X, Y, K, and L could be the same. For another example, the values of X, Y, K and L could be all different. Yet for another example, X=Y and K=L. Yet for another example, X=K and Y=L. The value of X, Y, K or L could be equal to 28 (symbols). Furthermore, the values of X, Y, K, and L could depend on BFRR format. That is, for different BFRR formats such as a TCI state indication, an uplink grant or a dedicated BFR-CORESET discussed herein, the values of {X, Y, K, L} could be different.

In another example, the UE could be indicated by the network one or more of X, Y, K, and L; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

In yet another example, the UE could autonomously determine one or more of X, Y, K and L.

In yet another example, the values of one or more of X, Y, K and L could be determined as the first slot that is at least BeamAppTime_r17 symbols after the last symbol of a first PUCCH, which is defined according to: when the UE would transmit the last symbol of the first PUCCH with HARQ-ACK information corresponding to the DCI carrying the TCI State indication and without DL assignment, or corresponding to the PDSCH scheduled by the DCI carrying the TCI State indication, and if the indicated TCI State is different from the previously indicated one, the UE would apply the indicated TCI State starting from the first slot that is at least BeamAppTime_r17 symbols after the last symbol of the first PUCCH. The first slot and the BeamAppTime_r17 symbols are both determined on the carrier with the smallest SCS among the carrier(s) applying the beam indication.

X, Y, K, or L could be the number of symbols after an end of the ACK for the BFRR. Alternatively, X, Y, K, or L could be the number of symbols after an end of the BFRR. Other options of counting X, Y, K, or L may not be excluded.

The discussed BFR procedures such as UE’s behaviors after receiving from the network the BFRR can be extended to a multi-transmission reception point (multi-TRP) system, wherein the UE could simultaneously receive from different TRPs various RSs/channels such as SSBs, NZP CSI-RSs, PDCCHs or PDSCHs. In this disclosure, a TRP can represent a collection of measurement antenna ports, measurement RS resources and/or control resource sets (CORESETs).

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; or (5) a plurality of CORESETs associated with a TRP-specific index/indicator/identity.

Furthermore, different TRPs could broadcast/be associated with different physical cell identities (PCIs) and one or more TRPs in the system could broadcast/be associated with different PCIs from that of serving cell/TRP.

This disclosure considers various design aspects for beam failure recovery (BFR) in a multi-TRP system. Specifically, the beam updating, and therefore, the corresponding UE’s behaviors, after the UE has received from the network the BFRR in a multi-TRP system are specified. The beam updating follows the unified TCI framework specified in the 3GPP Rel. 17, wherein a common beam indication is applied to all DL and UL channels in the multi-TRP system.

As described in the U.S. Pat. Application No. 17/584,239 as incorporated by reference herein in its entirety, a unified TCI framework could indicate/include N≥ 1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s).

There could be various design options/channels to indicate to the UE a beam (i.e., a TCI state) for the transmission/reception of a PDCCH or a PDSCH. As described in the U.S. Pat. Application No. 17/584,239 as incorporated by reference herein in its entirety.

In one example, a MAC CE could be used to indicate to the UE a beam (i.e., a TCI state and/or a TCI state ID) for the transmission/reception of a PDCCH or a PDSCH.

In another example, a DCI could be used to indicate to the UE a beam (i.e., a TCI state and/or a TCI state ID) for the transmission/reception of a PDCCH or a PDSCH.

For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.

For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.

Yet for another example, a custom/purpose designed DCI format could be used to indicate to the UE a beam (i.e., a TCI state and/or a TCI state ID) for the transmission/reception of a PDCCH or a PDSCH.

Furthermore, in the U.S. Pat. Applications No. 17/449,602 and No. 17/451,611, respectively, which are incorporated by reference herein in their entirety, various means of associating BFD RS beams/resources, NBI RS beams/resources, PUCCH resources to convey the BFRQ in form of SR and etc. with different TRPs in the multi-TRP system are specified.

As discussed in the U.S. Pat. Applications No. 17/449,602 and No. 17/451,611, respectively, which are incorporated by reference herein in their entirety, after the UE has sent to the network a BFRQ for a failed TRP (e.g., a failed BFD RS beam set) in the multi-TRP system, the UE may monitor for a BFRR to the BFRQ. Based on the Rel. 15/16 BFR, the BFRR could be a TCI state indication for a PDCCH from a CORESET associated with the failed TRP (or failed BFD RS set), wherein the QCL source RS in the TCI state is a SSB or a CSI-RS corresponding to the NBI RS selected/identified by the UE as the new beam q_new. Here, the selected NBIRS may be from the NBI RS set associated with the failed TRP (or failed BFD RS set) in the multi-TRP system.

Under the unified TCI framework, the BFRR for the multi-TRP BFR could be a common TCI state indication for PDCCH, PDSCH, PUCCH or PUSCH associated with the failed TRP (or failed BFD RS set). The QCL source RS in the common TCI state is also a SSB or a CSI-RS corresponding to the NBI RS selected/identified by the UE as the new beam q_new, wherein the selected NBI RS is from the NBI RS set associated with the failed TRP (or failed BFD RS set) in the multi-TRP system. In this case (multi-TRP BFR), the BFRR may be addressed to the UE for the failed TRP, i.e., for the failed BFD RS set. In the following, various channels to convey the common TCI state indication for BFRR are presented for the multi-TRP operation.

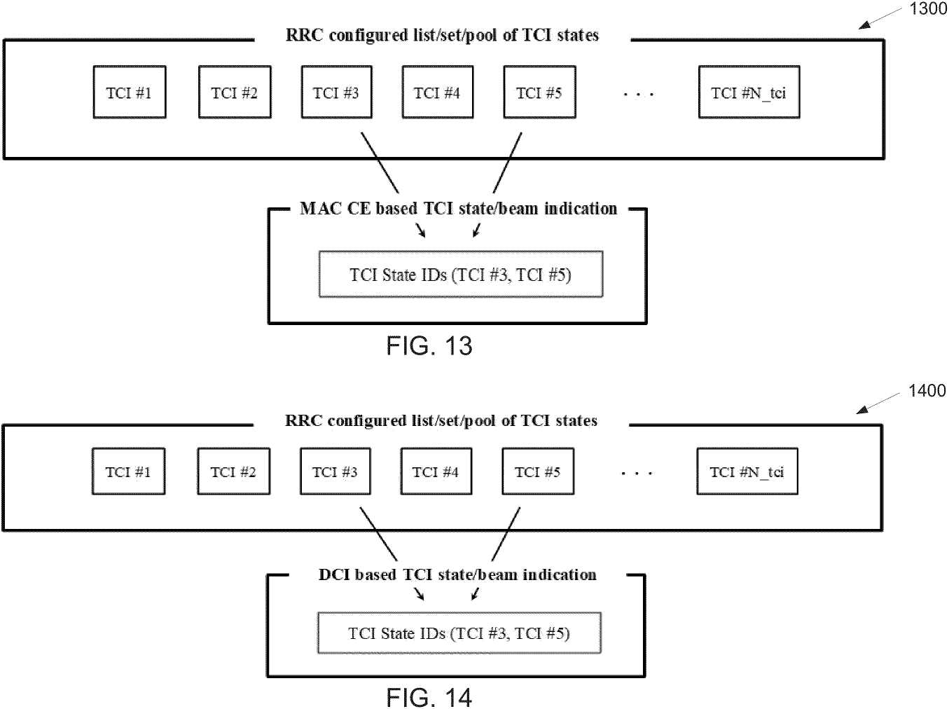

FIG. 13 illustrates an example of MAC CE based unified/common TCI state/beam indication/update as a format/form of BFRR for the multi-TRP operation 1300 according to embodiments of the present disclosure. An embodiment of the MAC CE based unified/common TCI state/beam indication/update as a format/form of BFRR for the multi-TRP operation 1300 shown in FIG. 13 is for illustration only.

In FIG. 13, an example of MAC CE based TCI state/beam indication for the multi-TRP operation is presented. As illustrated in FIG. 13, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE commands (as the BFRR) to indicate one or more (new) beam(s) (i.e., the TCI state(s)) for the transmission/reception of the PDCCH(s), PDSCH(s), PUCCH(s) or PUSCH(s).

The MAC CE for common TCI state/beam indication (as the BFRR) could indicate/include N≥ 1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s).

FIG. 14 illustrates an example of DCI based unified/common TCI state/beam indication/update as a format/form of BFRR for the multi-TRP operation 1400 according to embodiments of the present disclosure. An embodiment of the DCI based unified/common TCI state/beam indication/update as a format/form of BFRR for the multi-TRP operation 1400 shown in FIG. 14 is for illustration only.

In FIG. 14, an example of DCI based common TCI state/beam indication for the multi-TRP operation is presented. As illustrated in FIG. 9, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more DCIs (as the BFRR) to indicate one or more (new) beam(s) (i.e., the TCI state(s)) for the transmission/reception of the PDCCH(s), PDSCH(s), PUSCH(s) or PUCCH(s).

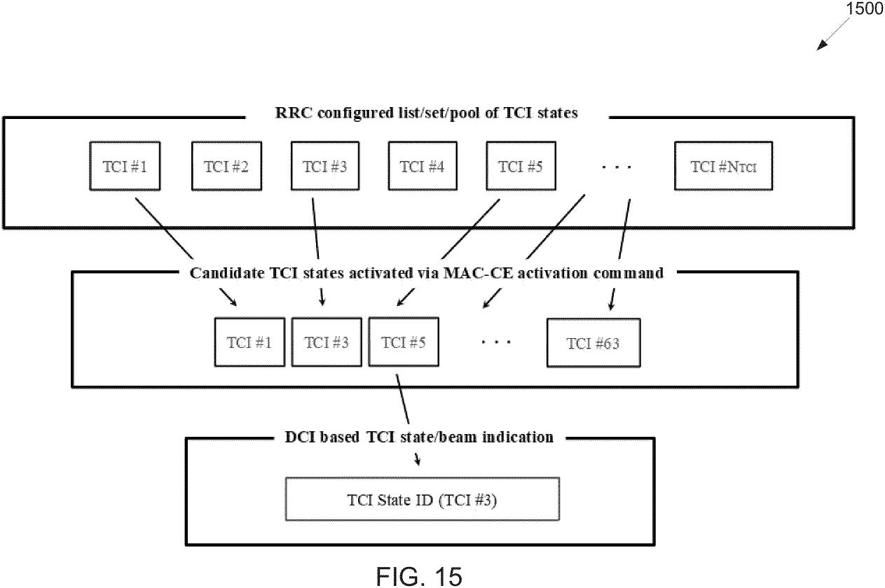

FIG. 15 illustrates an example of DCI based unified/common TCI state/beam indication/update (with MAC CE based TCI states activation) as a format/form of BFRR for the multi-TRP operation 1500 according to embodiments of the present disclosure. An embodiment of the DCI based unified/common TCI state/beam indication/update (with MAC CE based TCI states activation) as a format/form of BFRR for the multi-TRP operation 1500 shown in FIG. 15 is for illustration only.

In FIG. 15, an example of DCI based common TCI state/beam indication (with MAC CE activated TCI states) for the multi-TRP operation is presented. As illustrated in FIG. 15, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE activation commands activating one or more TCI states from the higher layer configured list/pool of TCI states, e.g., up to eight TCI states could be activated by a MAC CE activation command. The UE could receive from the network one or more DCIs for beam indication (as the BFRR) to indicate one or more (new) beam(s) (i.e., the TCI state(s)) from the MAC CE activated TCI state(s)/beam(s) for the transmission/reception of the PDCCH(s), PDSCH(s), PUCCH(s) or PUSCH(s).

As described herein, a DCI used to indicate to the UE a beam (i.e., a TCI state and/or a TCI state ID) for the transmission/reception of a PDCCH or a PDSCH could be at least one of the following examples.

In one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.

In another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.

Yet in another example, a custom/purpose designed DCI format could be used to indicate to the UE a beam (i.e., a TCI state and/or a TCI state ID) for the transmission/reception of a PDCCH or a PDSCH.

Furthermore, the DCI for common TCI state/beam indication (as the BFRR) could indicate/include N≥ 1 DL TCI states and/or M≥ 1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s).

As discussed herein, N≥ 1 DL TCI states and/or M≥ 1 UL TCI states could be indicated in the MAC CE or DCI based common TCI state/beam indication for BFRR for the multi-TRP operation. Furthermore, the UE could be configured/indicated by the network a list/set/pool of TRP-specific index/ID values such as CORESETPoolIndex values, PCIs or other TRP-specific higher layer signaling index/ID values to represent the TRPs in the multi-TRP system.

In addition, as described in the U.S. Pat. Applications, No. 17/449,602 and No. 17/451,611, as incorporated by reference herein as in their entirety, more than one BFD RS sets each comprising/including at least one BFD RS beam/resource could be configured for the multi-TRP BFR. If only N≥ 1 DL TCI states and/or their corresponding/associated TCI state IDs are indicated in the MAC CE or DCI based common TCI state/beam indication for BFRR following examples can be considered.

In one example D.1, among the N≥1 DL TCI states, the first DL TCI state (or DL TCI state 1) could correspond to/be associated with the first TRP-specific index/ID value in the list/set/pool of TRP-specific index/ID values such as CORESETPoolIndex values, PCIs or other TRP-specific higher layer signaling index/ID values, the second DL TCI state (or DL TCI state 2) could correspond to/be associated with the second TRP-specific index/ID value in the list/set/pool of TRP-specific index/ID values such as CORESETPoolIndex values, PCIs or other TRP-specific higher layer signaling index/ID values, and so on, and the N-th DL TCI state (or DL TCI state N) could correspond to/be associated with the N-th TRP-specific index/ID value in the list/set/pool of TRP-specific index/ID values such as CORESETPoolIndex values, PCIs or other TRP-specific higher layer signaling index/ID values. That is, the n-th DL TCI state (or DL TCI state n) could correspond to/be associated with the n-th TRP-specific index/ID value in the list/set/pool of TRP-specific index/ID values such as CORESETPoolIndex values, PCIs or other TRP-specific higher layer signaling index/ID values, where n=1, 2,..., N.

For example, the n-th DL TCI state (or DL TCI state n) could correspond to/be associated with the n-th PCI value in the list/set/pool of PCIs, where n=1, 2. For another example, for N=2, the n-th DL TCI state (or DL TCI state n) could correspond to/be associated with the n-th CORESETPoolIndex value in the list/set/pool of CORESETPoolIndex values, where n=1, 2.

In another example D.2, among the N≥1 DL TCI states, the DL TCI state with the lowest (or the highest) TCI state ID value could correspond to/be associated with the first TRP-specific index/ID value in the list/set/pool of TRP-specific index/ID values such as CORESETPoolIndex values, PCIs or other TRP-specific higher layer signaling index/ID values, the DL TCI state with the second lowest (or the second highest) TCI state ID value could correspond to/be associated with the second TRP-specific index/ID value in the list/set/pool of TRP-specific index/ID values such as CORESETPoolIndex values, PCIs or other TRP-specific higher layer signaling index/ID values, and so on, and the DL TCI state with the highest (or the lowest) TCI state ID value could correspond to/be associated with the N-th TRP-specific index/ID value in the list/set/pool of TRP-specific index/ID values such as CORESETPoolIndex values, PCIs or other TRP-specific higher layer signaling index/ID values. That is, the DL TCI state with the n-th lowest (or highest) TCI state ID value could correspond to/be associated with the n-th TRP-specific index/ID value in the list/set/pool of TRP-specific index/ID values such as CORESETPoolIndex values, PCIs or other TRP-specific higher layer signaling index/ID values, where n=1, 2,..., N.

For example, the DL TCI state with the n-th lowest (or highest) TCI state ID value could correspond to/be associated with the n-th PCI value in the list/set/pool of PCIs, where n=1, 2. For another example, for N=2, the DL TCI state with the n-th lowest (or highest) TCI state ID value could correspond to/be associated with the n-th CORESETPoolIndex value in the list/set/pool of CORESETPoolIndex values, where n=1, 2.

In yet another example D.3, among the N≥1 DL TCI states, the first DL TCI state (or DL TCI state 1) could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the second DL TCI state (or DL TCI state 2) could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the N-th DL TCI state (or DL TCI state N) could correspond to/be associated with the N-th lowest (or the N-th highest) TRP-specific index/ID value in the list/set/pool of TRP-specific index/ID values such as CORESETPoolIndex values, PCIs or other TRP-specific higher layer signaling index/ID values. That is, the n-th DL TCI state (or DL TCI state n) could correspond to/be associated with the n-th lowest (or highest) TRP-specific index/ID value in the list/set/pool of TRP-specific index/ID values such as CORESETPoolIndex values, PCIs or other TRP-specific higher layer signaling index/ID values, where n=1, 2,..., N.

For example, the n-th DL TCI state (or DL TCI state n) could correspond to/be associated with the n-th lowest (or highest) PCI value in the list/set/pool of PCIs, where n=1, 2.

For another example, for N=2, the n-th DL TCI state (or DL TCI state n) could correspond to/be associated with CORESETPoolIndex value n - 1, where n=1, 2.

In yet another example D.4, among the N≥ 1 DL TCI states, the DL TCI state with the lowest (or the highest) TCI state ID value could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the DL TCI state with the second lowest (or the second highest) TCI state ID value could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the DL TCI state with the highest (or the lowest) TCI state ID value could correspond to/be associated with the N-th lowest (or highest) TRP-specific index/ID value in the list/set/pool of TRP-specific index/ID values such as CORESETPoolIndex values, PCIs or other TRP-specific higher layer signaling index/ID values. That is, the DL TCI state with the n-th lowest (or highest) TCI state ID value could correspond to/be associated with the n-th lowest (or highest) TRP-specific index/ID value in the list/set/pool of TRP-specific index/ID values such as CORESETPoolIndex values, PCIs or other TRP-specific higher layer signaling index/ID values, where n=1, 2,..., N.

For example, the DL TCI state with the n-th lowest (or highest) TCI state ID value could correspond to/be associated with the n-th lowest (or highest) PCI value in the list/set/pool of PCIs, where n=1, 2. For another example, for N=2, the DL TCI state with the n-th lowest (or highest) TCI state ID value could correspond to/be associated with CORESETPoolIndex value n - 1, where n=1, 2.

In yet another example D.5, among the N≥ 1 DL TCI states, the first DL TCI state (or DL TCI state 1) could correspond to/be associated with the first BFD RS set (or BFD RS set 1), the second DL TCI state (or DL TCI state 2) could correspond to/be associated with the second BFD RS set (or BFD RS set 2), and so on, and the N-th DL TCI state (or DL TCI state N) could correspond to/by associated the N-th BFD RS set (or BFD RS set N). That is, the n-th DL TCI state (or DL TCI state n) could correspond to/be associated with the n-th BFD RS set (or BFD RS set n), where n=1, 2,..., N.

In yet another example D.6, among the N≥ 1 DL TCI states, the DL TCI state with the lowest (or the highest) TCI state ID value could correspond to/be associated with the first BFD RS set (or BFD RS set 1), the DL TCI state with the second lowest (or the second highest) TCI state ID value could correspond to/be associated with the second BFD RS set (or BFD RS set 2), and so on, and the DL TCI state with the highest (or the lowest) TCI state ID value could correspond to/be associated with the N-th BFD RS set (or BFD RS set N). That is, the DL TCI state with the n-th lowest (or highest) TCI state ID value could correspond to/be associated with the n-th BFD RS set (or BFD RS set n), where n=1, 2,..., N.

In yet another example D.7, among the N≥1 DL TCI states, the first DL TCI state (or DL TCI state 1) could correspond to/be associated with the BFD RS set with the lowest (or the highest) BFD RS set ID value, the second DL TCI state (or DL TCI state 2) could correspond to/be associated with the BFD RS set with the second lowest (or the second highest) BFD RS set ID value, and so on, and the N-th DL TCI state (or DL TCI state N) could correspond to/be associated with the BFD RS set with the N-th lowest (or the N-th highest) BFD RS set ID value. That is, the n-th DL TCI state (or DL TCI state n) could correspond to/be associated with the BFD RS set with the n-th lowest (or highest) BFD RS set ID value, where n=1, 2,..., N.

In yet another example D.8, among the N≥1 DL TCI states, the DL TCI state with the lowest (or the highest) TCI state ID value could correspond to/be associated with the BFD RS set with the lowest (or the highest) BFD RS set ID, the DL TCI state with the second lowest (or the second highest) TCI state ID value could correspond to/be associated with the BFD RS set with the second lowest (or the second highest) BFD RS set ID value, and so on, and the DL TCI state with the highest (or the lowest) TCI state ID value could correspond to/be associated with the BFD RS set with the N-th lowest (or highest) BFD RS set ID value. That is, the DL TCI state with the n-th lowest (or highest) TCI state ID value could correspond to/be associated with the BFD RS set with the n-th lowest (or highest) BFD RS set ID value, where n=1, 2,..., N.

In yet another example D.9, the UE could be explicitly indicated by the network the association between the N≥1 DL TCI states and the TRPs in the multi-TRP system or the N≥1 DL TCI states and the configured BFD RS sets; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

If only M≥1 UL TCI states and/or their corresponding/associated TCI state IDs are indicated in the MAC CE or DCI based common TCI state/beam indication for BFRR, following examples can be considered.

In one example U.1, among the M≥1 UL TCI states, the first UL TCI state (or UL TCI state 1) could correspond to/be associated with the first TRP-specific index/ID value in the list/set/pool of TRP-specific index/ID values such as CORESETPoolIndex values, PCIs or other TRP-specific higher layer signaling index/ID values, the second UL TCI state (or UL TCI state 2) could correspond to/be associated with the second TRP-specific index/ID value in the list/set/pool of TRP-specific index/ID values such as CORESETPoolIndex values, PCIs or other TRP-specific higher layer signaling index/ID values, and so on, and the M-th UL TCI state (or UL TCI state M) could correspond to/be associated with the M-th TRP-specific index/ID value in the list/set/pool of TRP-specific index/ID values such as CORESETPoolIndex values, PCIs or other TRP-specific higher layer signaling index/ID values. That is, the m-th UL TCI state (or UL TCI state m) could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2,..., M.

For example, the m-th UL TCI state (or UL TCI state m) could correspond to/be associated with the m-th PCI value in the list/set/pool of PCIs, where m=1, 2. For another example, for M=2, the m-th UL TCI state (or UL TCI state m) could correspond to/be associated with the m-th CORESETPoolIndex value in the list/set/pool of CORESETPoolIndex values, where m=1, 2.

In another example U.2, among the M≥1 UL TCI states, the UL TCI state with the lowest (or the highest) TCI state ID value could correspond to/be associated with the first TRP-specific index/ID value in the list/set/pool of TRP-specific index/ID values such as CORESETPoolIndex values, PCIs or other TRP-specific higher layer signaling index/ID values, the UL TCI state with the second lowest (or the second highest) TCI state ID value could correspond to/be associated with the second TRP-specific index/ID value in the list/set/pool of TRP-specific index/ID values such as CORESETPoolIndex values, PCIs or other TRP-specific higher layer signaling index/ID values, and so on, and the UL TCI state with the highest (or the lowest) TCI state ID value could correspond to/be associated with the M-th TRP-specific index/ID value in the list/set/pool of TRP-specific index/ID values such as CORESETPoolIndex values, PCIs or other TRP-specific higher layer signaling index/ID values. That is, the UL TCI state with the m-th lowest (or highest) TCI state ID value could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2,..., M.

For example, the UL TCI state with the m-th lowest (or highest) TCI state ID value could correspond to/be associated with the m-th PCI value in the list/set/pool of PCIs, where m=1, 2. For another example, for M=2, the UL TCI state with the m-th lowest (or highest) TCI state ID value could correspond to/be associated with the m-th CORESETPoolIndex value in the list/set/pool of CORESETPoolIndex values, where m=1, 2.

In yet another example U.3, among the M≥1 UL TCI states, the first UL TCI state (or UL TCI state 1) could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the second UL TCI state (or UL TCI state 2) could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the M-th UL TCI state (or UL TCI state M) could correspond to/be associated with the M-th lowest (or the M-th highest) TRP-specific index/ID value in the list/set/pool of TRP-specific index/ID values such as CORESETPoolIndex values, PCIs or other TRP-specific higher layer signaling index/ID values. That is, the m-th UL TCI state (or UL TCI state m) could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2,..., M.

For example, the m-th UL TCI state (or UL TCI state m) could correspond to/be associated with the m-th lowest (or highest) PCI value in the list/set/pool of PCIs, where m=1, 2. For another example, for M=2, the m-th UL TCI state (or UL TCI state m) could correspond to/be associated with CORESETPoolIndex value m - 1, where m=1, 2.

In yet another example U.4, among the M≥1 UL TCI states, the UL TCI state with the lowest (or the highest) TCI state ID value could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the UL TCI state with the second lowest (or the second highest) TCI state ID value could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the UL TCI state with the highest (or the lowest) TCI state ID value could correspond to/be associated with the M-th lowest (or highest) TRP-specific index/ID value in the list/set/pool of TRP-specific index/ID values such as CORESETPoolIndex values, PCIs or other TRP-specific higher layer signaling index/ID values. That is, the UL TCI state with the m-th lowest (or highest) TCI state ID value could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2,..., M.

For example, the UL TCI state with the m-th lowest (or highest) TCI state ID value could correspond to/be associated with the m-th lowest (or highest) PCI value in the list/set/pool of PCIs, where m=1, 2. For another example, for M=2, the UL TCI state with the m-th lowest (or highest) TCI state ID value could correspond to/be associated with CORESETPoolIndex value m - 1, where m=1, 2.

In yet another example U.5, among the M≥1 UL TCI states, the first UL TCI state (or UL TCI state 1) could correspond to/be associated with the first BFD RS set (or BFD RS set 1), the second UL TCI state (or UL TCI state 2) could correspond to/be associated with the second BFD RS set (or BFD RS set 2), and so on, and the M-th UL TCI state (or UL TCI state M) could correspond to be associated the M-th BFD RS set (or BFD RS set M). That is, the m-th UL TCI state (or UL TCI state m) could correspond to/be associated with the m-th BFD RS set (or BFD RS set m), where m=1, 2,..., M.

In yet another example U.6, among the M≥1 UL TCI states, the UL TCI state with the lowest (or the highest) TCI state ID value could correspond to/be associated with the first BFD RS set (or BFD RS set 1), the UL TCI state with the second lowest (or the second highest) TCI state ID value could correspond to/be associated with the second BFD RS set (or BFD RS set 2), and so on, and the UL TCI state with the highest (or the lowest) TCI state ID value could correspond to/be associated with the M-th BFD RS set (or BFD RS set M). That is, the UL TCI state with the m-th lowest (or highest) TCI state ID value could correspond to/be associated with the m-th BFD RS set (or BFD RS set m), where m=1, 2,..., M.

In yet another example U.7, among the M≥1 UL TCI states, the first UL TCI state (or UL TCI state 1) could correspond to/be associated with the BFD RS set with the lowest (or the highest) BFD RS set ID value, the second UL TCI state (or UL TCI state 2) could correspond to/be associated with the BFD RS set with the second lowest (or the second highest) BFD RS set ID value, and so on, and the M-th UL TCI state (or UL TCI state M) could correspond to/be associated with the BFD RS set with the M-th lowest (or the M-th highest) BFD RS set ID value. That is, the m-th UL TCI state (or UL TCI state m) could correspond to/be associated with the BFD RS set with the m-th lowest (or highest) BFD RS set ID value, where m=1, 2,..., M.

In yet another example U.8, among the M≥1 UL TCI states, the UL TCI state with the lowest (or the highest) TCI state ID value could correspond to/be associated with the BFD RS set with the lowest (or the highest) BFD RS set ID, the UL TCI state with the second lowest (or the second highest) TCI state ID value could correspond to/be associated with the BFD RS set with the second lowest (or the second highest) BFD RS set ID value, and so on, and the UL TCI state with the highest (or the lowest) TCI state ID value could correspond to/be associated with the BFD RS set with the M-th lowest (or highest) BFD RS set ID value. That is, the UL TCI state with the m-th lowest (or highest) TCI state ID value could correspond to/be associated with the BFD RS set with the m-th lowest (or highest) BFD RS set ID value, where m=1, 2,..., M.

In yet another example U.9, the UE could be explicitly indicated by the network the association between the M≥1 UL TCI states and the TRPs in the multi-TRP system or the M≥1 UL TCI states and the configured BFD RS sets; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

If N=M≥1 joint DL and UL TCI states and/or their corresponding/associated TCI state IDs are indicated in the MAC CE or DCI based common TCI state/beam indication for BFRR, following examples can be considered.

In one example J.1, among the M≥1 joint DL and UL TCI states, the first joint DL and UL TCI state (or joint DL and UL TCI state 1) could correspond to/be associated with the first TRP-specific index/ID value in the list/set/pool of TRP-specific index/ID values such as CORESETPoolIndex values, PCIs or other TRP-specific higher layer signaling index/ID values, the second joint DL and UL TCI state (or joint DL and UL TCI state 2) could correspond to/be associated with the second TRP-specific index/ID value in the list/set/pool of TRP-specific index/ID values such as CORESETPoolIndex values, PCIs or other TRP-specific higher layer signaling index/ID values, and so on, and the M-th joint DL and UL TCI state (or joint DL and UL TCI state M) could correspond to/be associated with the M-th TRP-specific index/ID value in the list/set/pool of TRP-specific index/ID values such as CORESETPoolIndex values, PCIs or other TRP-specific higher layer signaling index/ID values. That is, the m-th joint DL and UL TCI state (or joint DL and UL TCI state m) could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2,..., M.

For example, the m-th joint DL and UL TCI state (or joint DL and UL TCI state m) could correspond to/be associated with the m-th PCI value in the list/set/pool of PCIs, where m=1, 2. For another example, for M=2, the m-th joint DL and UL TCI state (or joint DL and UL TCI state m) could correspond to/be associated with the m-th CORESETPoolIndex value in the list/set/pool of CORESETPoolIndex values, where m=1, 2.

In another example J.2, among the M≥1 joint DL and UL TCI states, the joint DL and UL TCI state with the lowest (or the highest) TCI state ID value could correspond to/be associated with the first TRP-specific index/ID value in the list/set/pool of TRP-specific index/ID values such as CORESETPoolIndex values, PCIs or other TRP-specific higher layer signaling index/ID values, the joint DL and UL TCI state with the second lowest (or the second highest) TCI state ID value could correspond to/be associated with the second TRP-specific index/ID value in the list/set/pool of TRP-specific index/ID values such as CORESETPoolIndex values, PCIs or other TRP-specific higher layer signaling index/ID values, and so on, and the joint DL and UL TCI state with the highest (or the lowest) TCI state ID value could correspond to/be associated with the M-th TRP-specific index/ID value in the list/set/pool of TRP-specific index/ID values such as CORESETPoolIndex values, PCIs or other TRP-specific higher layer signaling index/ID values. That is, the joint DL and UL TCI state with the m-th lowest (or highest) TCI state ID value could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2,..., M.

For example, the joint DL and UL TCI state with the m-th lowest (or highest) TCI state ID value could correspond to/be associated with the m-th PCI value in the list/set/pool of PCIs, where m=1, 2. For another example, for M=2, the joint DL and UL TCI state with the m-th lowest (or highest) TCI state ID value could correspond to/be associated with the m-th CORESETPoolIndex value in the list/set/pool of CORESETPoolIndex values, where m=1, 2.

In yet another example J.3, among the M≥1 joint DL and UL TCI states, the first joint DL and UL TCI state (or joint DL and UL TCI state 1) could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the second joint DL and UL TCI state (or joint DL and UL TCI state 2) could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the M-th joint DL and UL TCI state (or joint DL and UL TCI state M) could correspond to/be associated with the M-th lowest (or the M-th highest) TRP-specific index/ID value in the list/set/pool of TRP-specific index/ID values such as CORESETPoolIndex values, PCIs or other TRP-specific higher layer signaling index/ID values. That is, the m-th joint DL and UL TCI state (or joint DL and UL TCI state m) could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2,..., M.

For example, the m-th joint DL and UL TCI state (or joint DL and UL TCI state m) could correspond to/be associated with the m-th lowest (or highest) PCI value in the list/set/pool of PCIs, where m=1, 2. For another example, for M=2, the m-th joint DL and UL TCI state (or joint DL and UL TCI state m) could correspond to/be associated with CORESETPoolIndex value m - 1, where m=1, 2.

In yet another example J.4, among the M≥1 joint DL and UL TCI states, the joint DL and UL TCI state with the lowest (or the highest) TCI state ID value could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the joint DL and UL TCI state with the second lowest (or the second highest) TCI state ID value could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the joint DL and UL TCI state with the highest (or the lowest) TCI state ID value could correspond to/be associated with the M-th lowest (or highest) TRP-specific index/ID value in the list/set/pool of TRP-specific index/ID values such as CORESETPoolIndex values, PCIs or other TRP-specific higher layer signaling index/ID values. That is, the joint DL and UL TCI state with the m-th lowest (or highest) TCI state ID value could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2,..., M.

For example, the joint DL and UL TCI state with the m-th lowest (or highest) TCI state ID value could correspond to/be associated with the m-th lowest (or highest) PCI value in the list/set/pool of PCIs, where m=1, 2. For another example, for M=2, the joint DL and UL TCI state with the m-th lowest (or highest) TCI state ID value could correspond to/be associated with CORESETPoolIndex value m - 1, where m=1, 2.

In yet another example J.5, among the M≥1 joint DL and UL TCI states, the first joint DL and UL TCI state (or joint DL and UL TCI state 1) could correspond to/be associated with the first BFD RS set (or BFD RS set 1), the second joint DL and UL TCI state (or joint DL and UL TCI state 2) could correspond to/be associated with the second BFD RS set (or BFD RS set 2), and so on, and the M-th joint DL and UL TCI state (or joint DL and UL TCI state M) could correspond to be associated the M-th BFD RS set (or BFD RS set M). That is, the m-th joint DL and UL TCI state (or UL TCI state m) could correspond to/be associated with the m-th BFD RS set (or BFD RS set m), where m=1, 2,..., M.

In yet another example J.6, among the M≥1 joint DL and UL TCI states, the joint DL and UL TCI state with the lowest (or the highest) TCI state ID value could correspond to/be associated with the first BFD RS set (or BFD RS set 1), the joint DL and UL TCI state with the second lowest (or the second highest) TCI state ID value could correspond to/be associated with the second BFD RS set (or BFD RS set 2), and so on, and the joint DL and UL TCI state with the highest (or the lowest) TCI state ID value could correspond to/be associated with the M-th BFD RS set (or BFD RS set M). That is, the joint DL and UL TCI state with the m-th lowest (or highest) TCI state ID value could correspond to/be associated with the m-th BFD RS set (or BFD RS set m), where m=1, 2,..., M.

In yet another example J.7, among the M≥1 joint DL and UL TCI states, the first joint DL and UL TCI state (or joint DL and UL TCI state 1) could correspond to/be associated with the BFD RS set with the lowest (or the highest) BFD RS set ID value, the second joint DL and UL TCI state (or joint DL and UL TCI state 2) could correspond to/be associated with the BFD RS set with the second lowest (or the second highest) BFD RS set ID value, and so on, and the M-th joint DL and UL TCI state (or joint DL and UL TCI state M) could correspond to/be associated with the BFD RS set with the M-th lowest (or the M-th highest) BFD RS set ID value. That is, the m-th joint DL and UL TCI state (or joint DL and UL TCI state m) could correspond to/be associated with the BFD RS set with the m-th lowest (or highest) BFD RS set ID value, where m=1, 2,..., M.

In yet another example J.8, among the M≥1 joint DL and UL TCI states, the joint DL and UL TCI state with the lowest (or the highest) TCI state ID value could correspond to/be associated with the BFD RS set with the lowest (or the highest) BFD RS set ID, the joint DL and UL TCI state with the second lowest (or the second highest) TCI state ID value could correspond to/be associated with the BFD RS set with the second lowest (or the second highest) BFD RS set ID value, and so on, and the joint DL and UL TCI state with the highest (or the lowest) TCI state ID value could correspond to/be associated with the BFD RS set with the M-th lowest (or highest) BFD RS set ID value. That is, the joint DL and UL TCI state with the m-th lowest (or highest) TCI state ID value could correspond to/be associated with the BFD RS set with the m-th lowest (or highest) BFD RS set ID value, where m=1, 2,..., M.

In yet another example J.9, the UE could be explicitly indicated by the network the association between the M≥1 joint DL and UL TCI states and the TRPs in the multi-TRP system or the M≥1 joint DL and UL TCI states and the configured BFD RS sets; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

If separate N ≥ 1 DL TCI states and M ≥ 1 separate UL TCI states and/or their corresponding/associated TCI state IDs are indicated in the MAC CE or DCI based common TCI state/beam indication for BFRR: (1) the association between the separate N≥1 DL TCI states and the TRPs in the multi-TRP system and the association between the separate N≥1 DL TCI states and the BFD RS sets could follow those specified in the examples D.1, D.2, D.3, D.4, D.5, D.6, D.7, D.8, or D.9; and (2) the association between the separate M≥1 UL TCI states and the TRPs in the multi-TRP system and the association between the separate M≥1 UL TCI states and the BFD RS sets could follow those specified in the examples U.1, U.2, U.3, U.4, U.5, U.6, U.7, U.8, or U.9.

The BFRR could be in form of one or more DL TCI states indicated via the aforementioned MAC CE/DCI based common beam indication. The UE could select one or more NBI RS resources and report to the network their indices in their respective NBI RS sets. Each selected NBI RS is from a NBI RS set associated with a failed BFD RS set, wherein according to the U.S. Pat. Application No. 17/449,602 and No. 17/451,611, respectively, as incorporated by reference herein in their entirety, a BFD RS set is said to be failed if the maximum number of beam failure instance (BFI) count associated with the BFD RS set is achieved. One or more of the reported NBI RSs, i.e., one or more of the reported new beams q_new’s, could be indicated as the QCL source RSs in the one or more DL TCI states indicated via the MAC CE/DCI based common beam indication.

In one example, the UE is indicated by the network N≥1 DL TCI states in the common beam indication for BFRR each corresponding to/associated with a TRP in the multi-TRP system or a configured BFD RS set. Furthermore, all of the reported NBI RSs, i.e., all of the reported new beams q_new’s, are indicated as the QCL source RSs in their corresponding/associated DL TCI states in the common beam indication for BFRR. For instance, a reported NBI RS, i.e., a reported new beam, from a NBI RS set n, may be indicated as the QCL source RS in the DL TCI state corresponding to/associated with the failed BFD RS set (e.g., BFD RS set n) corresponding to/associated with the NBI RS set n, where n∈{1, 2,..., N}.

In another example, the UE could be indicated by the network N≥1 DL TCI states in the common beam indication for BFRR each corresponding to/associated with a TRP in the multi-TRP system or a configured BFD RS set. Furthermore, a subset of all the reported NBI RSs, i.e., a subset of all the reported new beams q_new’s, are indicated as the QCL source RSs in their corresponding/associated DL TCI states in the common beam indication for BFRR. For instance, a reported NBI RS, i.e., a reported new beam, e.g., from a NBI RS set n, is indicated as the QCL source RS in the DL TCI state corresponding to/associated with the failed BFD RS set (e.g., BFD RS set n) corresponding to/associated with the NBI RS set n, where n∈{ 1, 2,..., N}. In addition, a reported NBI RS, i.e., a reported new beam, e.g., from a NBI RS set n′, is not indicated as the QCL source RS in the DL TCI state corresponding to/associated with the failed BFD RS set (e.g., BFD RS set n′) corresponding to/associated with the NBI RS set n, where n∈{ 1, 2,..., N} and n′ ≠n.

In yet another example, the UE is indicated by the network only the DL TCI state(s) indicating the reported NBI RS(s), i.e., the new beam(s), as the QCL source RS(s) in the common beam indication for BFRR. That is, the UE is indicated by the network only the DL TCI state(s) associated with the failed BFD RS set(s). For example, the UE could first report to the network a total of G≥1 NBI RS resource indices as the new beams selected from G≥1 NBI RS sets each corresponding to/associated with a failed BFD RS set. The UE could then be indicated by the network G≥1 DL TCI states in the common beam indication for BFRR each indicating a reported NBI RS as the QCL source RS.

Alternatively, the UE could be indicated by the network G′ ≥ 1 DL TCI states in the common beam indication for BFRR each indicating a reported NBI RS as the QCL source RS. In this case, G'≤G such that the G′ NBI RSs indicated in the G′ DL TCI states is a subset of the total reported G NBI RSs. The UE could be indicated by the network the association between the indicated G (or G′) DL TCI states (and therefore, the NBI RSs indicated therein) and the N TRPs in the multi-TRP system or the N BFD RS sets. For instance, the UE could receive from the network a bitmap of length N with each entry/bit position in the bitmap corresponding to a DL TCI state associated with a TRP in the multi-TRP system or a configured BFD RS set. If an entry/bit position is enabled, e.g., set to “1,” the corresponding DL TCI state is indicated in the common beam indication for BFRR. The bitmap could comprise G (or G') “1”s. The G (or G') indicated DL TCI states are sorted according to the order of the enabled entries/bit positions (i.e., “1”s) in the bitmap.

A DL TCI state indicated in the common beam for BFRR could be for both PDCCH and PDSCH. The UE could be indicated by the network N≥1 DL TCI states via the MAC CE based or DCI based (with or without MAC CE activation) common beam indication strategy discussed herein. The BFRR for the (failed) BFD RS set p corresponds to the common DL TCI state p for both PDCCH and PDSCH indicating the NBI RS/new beam selected from the NBI RS set p associated with the (failed) BFD RS set p as the QCL source RS, where p∈{1, 2,..., N}.

For the DL channels, in one example, X_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI). That is, X_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply the same receive filter as that for receiving the new beam selected from the NBI RS set p to receive the DL channels PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI). Here, the NBI RS set p is associated with the BFD RS set p and p∈{1, 2,..., N}.

For the DL channels, in another example, X_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). That is, X_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Furthermore, Y_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may assume/expect that the network may apply/use the new beam selected by the UE from the NBIRS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). That is, Y_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be different from X_p, the NBI RS set p is associated with the BFD RS set p, and p∈{1, 2,..., N}.

For the DL channels, in yet another example, the UE could receive from the network an indicator indicating whether the new beam q_new indicated in the common DL TCI state p∈{1, 2,..., N} may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p. In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the common DL TCI state p for both PDCCH and PDSCH indicating the NBI RS/new beam selected from the NBI RS set p associated with the failed BFD RS set p, to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

If the one-bit indicator is set to “1,” Y_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may assume/expect that the network may apply/use the new beam selected by the UE from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). That is, Y_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be the same as or different from X_p, the NBI RS set p is associated with the BFD RS set p, and p∈{1, 2,..., N}.

For another example, Y_p symbols after receiving the BFRR for the failed BFD RS set p (i.e., the common DL TCI state p for both PDCCH and PDSCH indicating the NBIRS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p, i.e., the common DL TCI state p for both PDCCH and PDSCH indicating the NBI RS/new beam selected from the NBI RS set p associated with the failed BFD RS set p, to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

If the one-bit indicator is set to “1,” X_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). That is, X_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Here, X_p could be the same as or different from Y_p, the NBI RS set p is associated with the BFD RS set p, and p∈{1, 2,..., N}.

The UE could receive from the network an indicator indicating whether the new beam indicated in the BFRR for the failed BFD RS set p, i.e., the common DL TCI state p for both PDCCH and PDSCH indicating the NBI RS/new beam selected from the NBI RS set p associated with the failed BFD RS set p, may be applied to at least one of PUCCH and PUSCH associated with the BFD RS set p (or the corresponding TRP/TRP-specific index/ID value such as CORESETPoolIndex or PCI); this indication could be via higher layer (RRC) or/and MAC CE or/and DCI based signaling or/and any combination of at least two of RRC, MAC CE and DCI based signaling; this indication could be via a separate (dedicated) parameter or joint with another parameter. For instance, the UE could receive from the network a one-bit indicator with “0”/absent indicating that the new beam may not be applied to the subsequent PUCCH and PUSCH transmissions, and “1” indicating that the new beam may be applied to at least one of subsequent PUCCH and PUSCH transmissions. If the new beam q_new indicated in the BFRR for the failed BFD RS set p (i.e., the common DL TCI state p for both PDCCH and PDSCH indicating the NBI RS/new beam selected from the NBI RS set p associated with the failed BFD RS set p) may be applied to at least one of PUCCH and PUSCH associated with the BFD RS set p (or the corresponding TRP/TRP-specific index/ID value such as CORESETPoolIndex or PCI), following examples can be considered.

In one example, K_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply a transmit filter same as the receive filter for receiving the new beam selected from the NBI RS set p to transmit the UL channels PUCCH(s) and PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

In another example, K_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Furthermore, L_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be different from K_p, the NBIRS set p is associated with the BFD RS set p, and p∈{1, 2,..., N}.

In yet another example, the UE could receive from the network an indicator indicating whether the new beam q_new indicated in the common DL TCI state p∈{1, 2,..., N} may be applied to the PUCCH or PUSCH or both; this indication could be via higher layer (RRC) or/and MAC CE or/and DCI based signaling or/and any combination of at least two of RRC, MAC CE and DCIbased signaling; this indication could be via a separate (dedicated) parameter or joint with another parameter.

For example, K_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the common DL TCI state p for both PDCCH and PDSCH indicating the NBIRS/new beam selected from the NBIRS set p associated with the failed BFD RS set p, to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

If the one-bit indicator is set to “1,” L_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be the same as or different from K_p, the NBI RS set p is associated with the BFD RS set p, and p∈{1, 2,..., N}.

For another example, L_p symbols after receiving the BFRR for the failed BFD RS set p (i.e., the common DL TCI state p for both PDCCH and PDSCH indicating the NBIRS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the common DL TCI state p for both PDCCH and PDSCH indicating the NBI RS/new beam selected from the NBI RS set p associated with the failed BFD RS set p, to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

If the one-bit indicator is set to “1,” K_p symbols after receiving the BFRR for the failed BFD RS set p (i.e., the common DL TCI state p for both PDCCH and PDSCH indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Here, K_p could be the same as or different from L_p, the NBI RS set p is associated with the BFD RS set p, and p∈{1, 2,..., N}.

If the new beam q_new indicated in the BFRR for the failed BFD RS set p (i.e., the common DL TCI state p for both PDCCH and PDSCH indicating the NBI RS/new beam selected from the NBI RS set p associated with the failed BFD RS set p) may not be applied to either PUCCH or PUSCH associated with the BFD RS set p (or the corresponding TRP/TRP-specific index/ID value such as CORESETPoolIndex or PCI), the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI); alternatively, the UE may apply a transmit filter same as the receive filter for receiving the BFRR for the failed BFD RS set p, i.e., the common DL TCI state p for both PDCCH and PDSCH indicating the NBI RS/new beam selected from the NBI RS set p associated with the failed BFD RS set p, to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

For the DL TCI state q∈{1, 2,..., N} not indicating any new beam and for DL channels, following examples can be considered.

For example, the UE may apply the same receive filter as that for receiving the PDCCH(s) or PDSCH(s) associated with the BFD RS set q (or the corresponding TRP/TRP-specific index/ID value such as CORESETPoolIndex or PCI) prior to receiving the BFRR to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For another example, the UE may apply the same receive filter as that for receiving the BFRR for the BFD RS set q, i.e., the common DL TCI state q for both PDCCH and PDSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For yet another example, the UE may apply the same receive filter as that for receiving the QCL source RS/beam indicated in the common DL TCI state q for both PDCCH and PDSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For the DL TCI state q∈{1, 2,..., N} not indicating any new beam and for UL channels, following examples can be considered.

For example, the UE may apply a transmit filter same as the receive filter for receiving the PDCCH(s) or PDSCH(s) associated with the BFD RS set q (or the corresponding TRP/TRP-specific index/ID value such as CORESETPoolIndex or PCI) prior to receiving the BFRR to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For another example, the UE may apply a transmit filter same as the receive filter for receiving the BFRR for the BFD RS set q, i.e., the common DL TCI state q for both PDCCH and PDSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For yet another example, the UE may apply a transmit filter same as that for receiving the QCL source RS/beam indicated in the common DL TCI state q for both PDCCH and PDSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

In a multi-TRP system, one or more CORESETs could be associated with the same BFD RS set. For example, configuration/indication of a CORESET, e.g., the higher layer parameter ControlResourceSet, could include/comprise the associated BFD RS set index/ID. For another example, a CORESET associated with CORESETPoolIndex n - 1 could be associated with the BFD RS set n, where in this case, n=1, 2. Hence, a PDCCH from a CORESET associated with the BFD RS set n, and the corresponding PDSCH or PUSCH scheduled by the PDCCH, may be associated with the BFD RS set n, where n∈{1, 2,..., N}. Furthermore, one or more PUCCH resource settings or one or more PUCCH resource sets could be associated with the same BFD RS set.

For example, configuration/indication of a PUCCH resource setting, e.g., the higher layer parameter PUCCH-Config, could include/comprise the associated BFD RS set index/ID. For another example, configuration/indication of a PUCCH resource set, e.g., the higher layer parameter PUCCH-ResourceSet, could include/comprise the associated BFD RS set index/ID. Yet for another example, a PUCCH resource set with the PUCCH resource set ID (pucch-ResourceSetId) value n could be associated with the BFD RS set n, where n=1, 2,..., N. Hence, a PUCCH configured in a PUCCH resource setting or a PUCCH resource set associated with the BFD RS set n may be associated with the BFD RS set n, where n∈{1, 2,..., N}.

In a multi-TRP system, one or more CORESETs could be associated with the same TRP-specific index/ID value such as CORESETPoolIndex value, PCI or any other TRP-specific higher layer signaling index value. For example, configuration/indication of a CORESET, e.g., the higher layer parameter ControlResourceSet, could include/comprise the associated TRP-specific index/ID value such as PCI. For another example, a CORESET is associated with a CORESETPoolIndex n — 1, e.g., by incorporating/including the CORESETPoolIndex value in the configuration/indication of the CORESET (e.g., via the higher layer parameter ControlResrouceSet), where in this case, n=1, 2. Hence, a PDCCH from a CORESET associated with the TRP-specific index/ID value x (x = n — 1 for CORESETPoolIndex with n=1, 2) and the corresponding PDSCH or PUSCH scheduled by the PDCCH, may be associated with the TRP-specific index/ID value x (x = n — 1 for CORESETPoolIndex with n=1, 2). Furthermore, one or more PUCCH resource settings or one or more PUCCH resource sets could be associated with the same TRP-specific index/ID value such as CORESETPoolIndex value, PCI or any other TRP-specific higher layer signaling index value. For example, configuration/indication of a PUCCH resource setting, e.g., the higher layer parameter PUCCH-Config, could include/comprise the associated TRP-specific index/ID value. For another example, configuration/indication of a PUCCH resource set, e.g., the higher layer parameter PUCCH-ResourceSet, could include/comprise the associated TRP-specific index/ID value. Yet for another example, a PUCCH resource set with the PUCCH resource set ID (pucch-ResourceSetId) value n could be associated with CORESETPoolIndex n — 1, where n=1, 2. Hence, a PUCCH configured in a PUCCH resource setting or a PUCCH resource set associated with the TRP-specific index/ID value x (x = n — 1 for CORESETPoolIndex with n=1, 2) may be associated with the TRP-specific index/ID value x (x = n — 1 for CORESETPoolIndex with n=1, 2).

The BFRR could be in form of one or more UL TCI states indicated via the aforementioned MAC CE/DCI based common beam indication. The UE could select one or more NBI RS resources and report to the network their indices in their respective NBI RS sets. Each selected NBI RS is from a NBI RS set associated with a failed BFD RS set, wherein according to the U.S. Pat. Application No. 17/449,602 and No. 17/451,611, respectively, as incorporated by reference herein in their entirety, a BFD RS set is said to be failed if the maximum number of beam failure instance (BFI) count associated with the BFD RS set is achieved. One or more of the reported NBI RSs, i.e., one or more of the reported new beams q_new’s, could be indicated as the QCL source RSs in the one or more UL TCI states indicated via the MAC CE/DCIbased common beam indication.

In one example, the UE is indicated by the network M≥1 UL TCI states in the common beam indication for BFRR each corresponding to/associated with a TRP in the multi-TRP system or a configured BFD RS set. Furthermore, all of the reported NBI RSs, i.e., all of the reported new beams q_new’s, are indicated as the QCL source RSs in their corresponding/associated UL TCI states in the common beam indication for BFRR. For instance, a reported NBI RS, i.e., a reported new beam, from a NBI RS set m, may be indicated as the QCL source RS in the UL TCI state corresponding to/associated with the failed BFD RS set (e.g., BFD RS set m) corresponding to/associated with the NBI RS set m, where m∈{1, 2,..., M}.

In another example, the UE could be indicated by the network M≥1 UL TCI states in the common beam indication for BFRR each corresponding to/associated with a TRP in the multi-TRP system or a configured BFD RS set. Furthermore, a subset of all the reported NBI RSs, i.e., a subset of all the reported new beams q_new’s, are indicated as the QCL source RSs in their corresponding/associated UL TCI states in the common beam indication for BFRR. For instance, a reported NBI RS, i.e., a reported new beam, e.g., from a NBI RS set m, is indicated as the QCL source RS in the UL TCI state corresponding to/associated with the failed BFD RS set (e.g., BFD RS set m) corresponding to/associated with the NBI RS set m, where m∈{1, 2,..., M}. In addition, a reported NBI RS, i.e., a reported new beam, e.g., from a NBI RS set m′, is not indicated as the QCL source RS in the UL TCI state corresponding to/associated with the failed BFD RS set (e.g., BFD RS set m′) corresponding to/associated with the NBI RS set m′, where m∈{1, 2,..., M} and m'≠m.

In yet another example, the UE is indicated by the network only the UL TCI state(s) indicating the reported NBI RS(s), i.e., the new beam(s), as the QCL source RS(s) in the common beam indication for BFRR. That is, the UE is indicated by the network only the UL TCI state(s) associated with the failed BFD RS set(s). For example, the UE could first report to the network a total of G≥1 NBI RS resource indices as the new beams selected from G≥1 NBI RS sets each corresponding to/associated with a failed BFD RS set. The UE could then be indicated by the network G≥1 UL TCI states in the common beam indication for BFRR each indicating a reported NBI RS as the QCL source RS.

Alternatively, the UE could be indicated by the network G'≥1 UL TCI states in the common beam indication for BFRR each indicating a reported NBI RS as the QCL source RS. In this case, G'≤G such that the G′ NBI RSs indicated in the G′ UL TCI states is a subset of the total reported G NBI RSs. The UE could be indicated by the network the association between the indicated G (or G′) UL TCI states (and therefore, the NBI RSs indicated therein) and the M TRPs in the multi-TRP system or the M BFD RS sets. For instance, the UE could receive from the network a bitmap of length M with each entry/bit position in the bitmap corresponding to a UL TCI state associated with a TRP in the multi-TRP system or a configured BFD RS set. If an entry/bit position is enabled, e.g., set to “1,” the corresponding UL TCI state is indicated in the common beam indication for BFRR. The bitmap could comprise G (or G') “1”s. The G (or G') indicated UL TCI states are sorted according to the order of the enabled entries/bit positions (i.e., “1”s) in the bitmap.

An UL TCI state indicated in the common beam for BFRR could be for both PUCCH and PUSCH. The UE could be indicated by the network M≥1 UL TCI states via the MAC CE based or DCI based (with or without MAC CE activation) common beam indication strategy discussed herein. The BFRR for the (failed) BFD RS set p corresponds to the common UL TCI state p for both PUCCH and PUSCH indicating the NBI RS/new beam selected from the NBI RS set p associated with the (failed) BFD RS set p as the QCL source RS, where p∈{1, 2,..., M}.

For the UL channels, in one example, K_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the UL channels PUCCH(s) and PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

For the UL channels, in another example, K_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation update for the PUCCH(s) associated with the BFD RS set p (or the corresponding TRP/TRP-specific index/ID value such as CORESETPoolIndex or PCI).

Furthermore, L_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be different from K_p, the NBIRS set p is associated with the BFD RS set p, and p∈{1, 2,..., M}.

For the UL channels, in yet another example, the UE could receive from the network an indicator indicating whether the new beam q_new indicated in the common UL TCI state p∈{1, 2,..., M} may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the common UL TCI state p for both PUCCH and PUSCH indicating the NBIRS/new beam selected from the NBIRS set p associated with the failed BFD RS set p, to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

If the one-bit indicator is set to “1,” L_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be the same as or different from K_p, the NBI RS set p is associated with the BFD RS set p, and p∈{1, 2,..., M}.

For another example, L_p symbols after receiving the BFRR for the failed BFD RS set p (i.e., the common UL TCI state p for both PUCCH and PUSCH indicating the NBIRS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the common UL TCI state p for both PUCCH and PUSCH indicating the NBIRS/new beam selected from the NBIRS set p associated with the failed BFD RS set p, to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

If the one-bit indicator is set to “1,” K_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Here, K_p could be the same as or different from L_p, the NBI RS set p is associated with the BFD RS set p, and p∈{1, 2,..., M}.

The UE could receive from the network an indicator indicating whether the new beam indicated in the BFRR for the failed BFD RS set p, i.e., the common UL TCI state p for both PUCCH and PUSCH indicating the NBI RS/new beam selected from the NBI RS set p associated with the failed BFD RS set p, may be applied to at least one of PDCCH and PDSCH associated with the BFD RS set p (or the corresponding TRP/TRP-specific index/ID value such as CORESETPoolIndex or PCI); this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For instance, the UE could receive from the network a one-bit indicator with “0”/absent indicating that the new beam may not be applied to the subsequent PDCCH and PDSCH transmissions, and “1” indicating that the new beam may be applied to at least one of subsequent PDCCH and PDSCH transmissions. If the new beam q_new indicated in the BFRR for the failed BFD RS set p (i.e., the common UL TCI state p for both PUCCH and PUSCH indicating the NBI RS/new beam selected from the NBI RS set p associated with the failed BFD RS set p) may be applied to at least one of PDCCH and PDSCH associated with the BFD RS set p (or the corresponding TRP/TRP-specific index/ID value such as CORESETPoolIndex or PCI), following examples can be considered.

In one example, X_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI). That is, X_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply the same receive filter as that for receiving the new beam selected from the NBI RS set p to receive the DL channels PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

In another example, X_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, Y_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may assume/expect that the network may apply/use the new beam selected from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be different from X_p, the NBI RS set p is associated with the BFD RS set p, and p∈{1, 2,..., M}.

In yet another example, the UE could receive from the network an indicator indicating whether the new beam q_new indicated in the common UL TCI state p∈{1, 2,..., M} may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or j oint with another parameter.

For example, X_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the common UL TCI state p for both PUCCH and PUSCH indicating the NBI RS/new beam selected from the NBI RS set p associated with the failed BFD RS set p, to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

If the one-bit indicator is set to “1,” Y_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be the same as or different from X_p, the NBI RS set p is associated with the BFD RS set p, and p∈{1, 2,..., M}.

For another example, Y_p symbols after receiving the BFRR for the failed BFD RS set p (i.e., the common UL TCI state p for both PUCCH and PUSCH indicating the NBIRS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the common UL TCI state p for both PUCCH and PUSCH indicating the NBI RS/new beam selected from the NBI RS set p associated with the failed BFD RS set p, to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

If the one-bit indicator is set to “1,” X_p symbols after receiving the BFRR for the failed BFD RS set p (i.e., the common UL TCI state p for both PUCCH and PUSCH indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Here, X_p could be the same as or different from Y_p, the NBI RS set p is associated with the BFD RS set p, and p∈{1, 2,..., M}.

If the new beam q_new indicated in the BFRR for the failed BFD RS set p (i.e., the common UL TCI state p for both PUCCH and PUSCH indicating the NBI RS/new beam selected from the NBI RS set p associated with the failed BFD RS set p) may not be applied to either PDCCH or PDSCH, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI); alternatively, the UE may apply the same receive filter as that for receiving the BFRR for the failed BFD RS set p, i.e., the common UL TCI state p for both PUCCH and PUSCH indicating the NBI RS/new beam selected from the NBI RS set p associated with the failed BFD RS set p, to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

For the UL TCI state q∈{1, 2,..., M} not indicating any new beam and for DL channels, following examples can be considered.

For example, the UE may apply the same receive filter as that for receiving the PDCCH(s) or PDSCH(s) associated with the BFD RS set q (or the corresponding TRP/TRP-specific index/ID value such as CORESETPoolIndex or PCI) prior to receiving the BFRR to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For another example, the UE may apply the same receive filter as that for receiving the BFRR for the BFD RS set q, i.e., the common UL TCI state q for both PUCCH and PUSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For yet another example, the UE may apply the same receive filter as that for receiving the QCL source RS/beam indicated in the common UL TCI state q for both PUCCH and PUSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For the UL TCI state q∈{1, 2,..., M} not indicating any new beam and for UL channels, following examples can be considered.

For example, the UE may apply a transmit filter same as the receive filter for receiving the PDCCH(s) or PDSCH(s) associated with the BFD RS set q (or the corresponding TRP/TRP-specific index/ID value such as CORESETPoolIndex or PCI) prior to receiving the BFRR to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For another example, the UE may apply a transmit filter same as the receive filter for receiving the BFRR for the BFD RS set q, i.e., the common UL TCI state q for both PUCCH and PUSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For yet another example, the UE may apply a transmit filter same as that for receiving the QCL source RS/beam indicated in the common UL TCI state q for both PUCCH and PUSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

In a multi-TRP system, one or more CORESETs could be associated with the same BFD RS set. For example, configuration/indication of a CORESET, e.g., the higher layer parameter ControlResourceSet, could include/comprise the associated BFD RS set index/ID. For another example, a CORESET associated with CORESETPoolIndex m - 1 could be associated with the BFD RS set m, where in this case, m=1, 2. Hence, a PDCCH from a CORESET associated with the BFD RS set m, and the corresponding PDSCH or PUSCH scheduled by the PDCCH, may be associated with the BFD RS set m, where m∈{1, 2,..., M}. Furthermore, one or more PUCCH resource settings or one or more PUCCH resource sets could be associated with the same BFD RS set. For example, configuration/indication of a PUCCH resource setting, e.g., the higher layer parameter PUCCH-Config, could include/comprise the associated BFD RS set index/ID.

For another example, configuration/indication of a PUCCH resource set, e.g., the higher layer parameter PUCCH-ResourceSet, could include/comprise the associated BFD RS set index/ID. Yet for another example, a PUCCH resource set with the PUCCH resource set ID (pucch-ResourceSetId) value m could be associated with the BFD RS set m, where m=1, 2,..., M. Hence, a PUCCH configured in a PUCCH resource setting or a PUCCH resource set associated with the BFD RS set m may be associated with the BFD RS set m, where m∈{1, 2,..., M}.

In a multi-TRP system, one or more CORESETs could be associated with the same TRP-specific index/ID value such as CORESETPoolIndex value, PCI or any other TRP-specific higher layer signaling index value. For example, configuration/indication of a CORESET, e.g., the higher layer parameter ControlResourceSet, could include/comprise the associated TRP-specific index/ID value such as PCI. For another example, a CORESET is associated with a CORESETPoolIndex m –1, e.g., by incorporating/including the CORESETPoolIndex value in the configuration/indication of the CORESET (e.g., via the higher layer parameter ControlResrouceSet), where in this case, m=1, 2. Hence, a PDCCH from a CORESET associated with the TRP-specific index/ID value x (x = m — 1 for CORESETPoolIndex with m=1, 2) and the corresponding PDSCH or PUSCH scheduled by the PDCCH, may be associated with the TRP-specific index/ID value x (x = m — 1 for CORESETPoolIndex with m=1, 2).

Furthermore, one or more PUCCH resource settings or one or more PUCCH resource sets could be associated with the same TRP-specific index/ID value such as CORESETPoolIndex value, PCI or any other TRP-specific higher layer signaling index value. For example, configuration/indication of a PUCCH resource setting, e.g., the higher layer parameter PUCCH-Config, could include/comprise the associated TRP-specific index/ID value. For another example, configuration/indication of a PUCCH resource set, e.g., the higher layer parameter PUCCH-ResourceSet, could include/comprise the associated TRP-specific index/ID value. Yet for another example, a PUCCH resource set with the PUCCH resource set ID (pucch-ResourceSetId) value m could be associated with CORESETPoolIndex m - 1, where m=1, 2. Hence, a PUCCH configured in a PUCCH resource setting or a PUCCH resource set associated with the TRP-specific index/ID value x (x = m — 1 for CORESETPoolIndex with m=1, 2) may be associated with the TRP-specific index/ID value x (x = m — 1 for CORESETPoolIndex with m=1, 2).

The BFRR could be in form of one or more joint DL and UL TCI states indicated via the aforementioned MAC CE/DCI based common beam indication. The UE could select one or more NBI RS resources and report to the network their indices in their respective NBI RS sets. Each selected NBI RS is from a NBI RS set associated with a failed BFD RS set, wherein according to the U.S. Pat. Application No. 17/449,602 and No. 17/451,611, respectively, as incorporated by reference herein in their entirety, a BFD RS set is said to be failed if the maximum number of beam failure instance (BFI) count associated with the BFD RS set is achieved. One or more of the reported NBI RSs, i.e., one or more of the reported new beams q_new’s, could be indicated as the QCL source RSs in the one or more joint DL and UL TCI states indicated via the MAC CE/DCI based common beam indication.

In one example, the UE is indicated by the network M≥1 joint DL and UL TCI states in the common beam indication for BFRR each corresponding to/associated with a TRP in the multi-TRP system or a configured BFD RS set. Furthermore, all of the reported NBI RSs, i.e., all of the reported new beams q_new’s, are indicated as the QCL source RSs in their corresponding/associated joint DL and UL TCI states in the common beam indication for BFRR. For instance, a reported NBI RS, i.e., a reported new beam, from a NBI RS set m, may be indicated as the QCL source RS in the joint DL and UL TCI state corresponding to/associated with the failed BFD RS set (e.g., BFD RS set m) corresponding to/associated with the NBI RS set m, where m∈{1, 2,..., M}.

In another example, the UE could be indicated by the network M≥1 joint DL and UL TCI states in the common beam indication for BFRR each corresponding to/associated with a TRP in the multi-TRP system or a configured BFD RS set. Furthermore, a subset of all the reported NBI RSs, i.e., a subset of all the reported new beams q_new’s, are indicated as the QCL source RSs in their corresponding/associated joint DL and UL TCI states in the common beam indication for BFRR. For instance, a reported NBI RS, i.e., a reported new beam, e.g., from a NBI RS set m, is indicated as the QCL source RS in the joint DL and UL TCI state corresponding to/associated with the failed BFD RS set (e.g., BFD RS set m) corresponding to/associated with the NBI RS set m, where m∈{1, 2,..., M}. In addition, a reported NBI RS, i.e., a reported new beam, e.g., from a NBI RS set m′, is not indicated as the QCL source RS in the joint DL and UL TCI state corresponding to/associated with the failed BFD RS set (e.g., BFD RS set m′) corresponding to/associated with the NBI RS set m′, where m’∈{1, 2,..., M} and m’≠m.

In yet another example, the UE is indicated by the network only the joint DL and UL TCI state(s) indicating the reported NBI RS(s), i.e., the new beam(s), as the QCL source RS(s) in the common beam indication for BFRR. That is, the UE is indicated by the network only the joint DL and UL TCI state(s) associated with the failed BFD RS set(s). For example, the UE could first report to the network a total of G≥1 NBI RS resource indices as the new beams selected from G≥1 NBI RS sets each corresponding to/associated with a failed BFD RS set. The UE could then be indicated by the network G≥1 joint DL and UL TCI states in the common beam indication for BFRR each indicating a reported NBI RS as the QCL source RS.

Alternatively, the UE could be indicated by the network G’≥1 joint DL and UL TCI states in the common beam indication for BFRR each indicating a reported NBI RS as the QCL source RS. In this case, G’≤G such that the G′ NBI RSs indicated in the G′ joint DL and UL TCI states is a subset of the total reported G NBI RSs. The UE could be indicated by the network the association between the indicated G (or G′) joint DL and UL TCI states (and therefore, the NBI RSs indicated therein) and the M TRPs in the multi-TRP system or the M BFD RS sets. For instance, the UE could receive from the network a bitmap of length M with each entry/bit position in the bitmap corresponding to a joint DL and UL TCI state associated with a TRP in the multi-TRP system or a configured BFD RS set. If an entry/bit position is enabled, e.g., set to “1,” the corresponding joint DL and UL TCI state is indicated in the common beam indication for BFRR. The bitmap could comprise G (or G') “1”s. The G (or G') indicated joint DL and UL TCI states are sorted according to the order of the enabled entries/bit positions (i.e., “1”s) in the bitmap.

A joint DL and UL TCI state indicated in the common beam for BFRR could be for PDCCH, PDSCH, PUCCH and PUSCH. The UE could be indicated by the network M≥1 joint DL and UL TCI states via the MAC CE based or DCI based (with or without MAC CE activation) common beam indication strategy discussed herein. The BFRR for the (failed) BFD RS set p corresponds to the joint DL and UL TCI state p for PDCCH, PDSCH, PUCCH and PUSCH indicating the NBI RS/new beam selected from the NBI RS set p associated with the (failed) BFD RS set p as the QCL source RS, where p∈{1, 2,..., M}.

For the DL channels, in one example, X_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply the same receive filter as that for receiving the new beam selected from the NBI RS set p to receive the DL channels PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

For the DL channels, in another example, X_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, Y_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may assume/expect that the network may apply/use the new beam selected by the UE from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply the same receive filter as that for receiving the new beam selected from the NBI RS set p to receive the PDSCH(s) associated with BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be different from X_p, the NBI RS set p is associated with the BFD RS set p, and p∈{1, 2,..., M}.

For the DL channels, in yet another example, the UE could receive from the network an indicator indicating whether the new beam q_new indicated in the joint DL and UL TCI state p∈{1, 2,..., M} may be applied to the PDCCH or PDSCH or both; this indication could be via higher layer (RRC) or/and MAC CE or/and DCI based signaling or/and any combination of at least two of RRC, MAC CE and DCIbased signaling; this indication could be via a separate (dedicated) parameter or joint with another parameter.

For example, X_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the joint DL and UL TCI state p for PDCCH, PDSCH, PUCCH and PUSCH indicating the NBI RS/new beam selected from the NBI RS set p associated with the failed BFD RS set p, to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

If the one-bit indicator is set to “1,” Y_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may assume/expect that the network may apply/use the new beam selected by the UE from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be the same as or different from X_p, the NBI RS set p is associated with the BFD RS set p, and p∈{1, 2,..., M}.

For another example, Y_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p, i.e., the joint DL and UL TCI state p for PDCCH, PDSCH, PUCCH and PUSCH indicating the NBI RS/new beam selected from the NBI RS set p associated with the failed BFD RS set p, to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

If the one-bit indicator is set to “1,” X_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Here, X_p could be the same as or different from Y_p, the NBI RS set p is associated with the BFD RS set p, and p∈{1, 2,..., M}.

For the UL channels, in one example, K_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the UL channels PUCCH(s) and PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

For the UL channels, in another example, K_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation update for the PUCCH(s) associated with the BFD RS set p (or the corresponding TRP/TRP-specific index/ID value such as CORESETPoolIndex or PCI). Furthermore, L_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be different from K_p, the NBI RS set p is associated with the BFD RS set p, and p∈{1, 2,..., M}.

For the UL channels, in yet another example, the UE could receive from the network an indicator indicating whether the new beam q_new indicated in the joint DL and UL TCI state p∈{1, 2,..., M} may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Alternatively, the UE may apply a transmit filter same as the receive filter for receiving the BFRR for the failed BFD RS set p, i.e., the joint DL and UL TCI state p for PDCCH, PDSCH, PUCCH and PUSCH indicating the NBI RS/new beam selected from the NBI RS set p associated with the failed BFD RS set p, to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

If the one-bit indicator is set to “1,” L_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be the same as or different from K_p, the NBI RS set p is associated with the BFD RS set p, and p∈{1, 2,..., M}.

For another example, L_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the joint DL and UL TCI state p for PDCCH, PDSCH, PUCCH and PUSCH indicating the NBI RS/new beam selected from the NBI RS set p associated with the failed BFD RS set p, to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

If the one-bit indicator is set to “1,” K_p symbols after receiving the BFRR for the failed BFD RS set p (i.e., the joint DL and UL TCI state p for PDCCH, PDSCH, PUCCH and PUSCH indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Here, K_p could be the same as or different from L_p, the NBI RS set p is associated with the BFD RS set p, and p∈{1, 2,..., M}.

In the discussed design examples, the UE could receive from the network separate indicators respectively indicating whether the new beam q_new indicated in the joint DL and UL TCI state p∈{1, 2,..., M} may be applied to one or more of PDCCH and PDSCH associated with the BFD RS set p (or the corresponding TRP/TRP-specific index/ID value such as CORESETPoolIndex or PCI) and whether the new beam q_new indicated in the joint DL and UL TCI state p∈{1, 2,..., M} may be applied to one or more of PUCCH and PUSCH associated with the BFD RS set p (or the corresponding TRP/TRP-specific index/ID value such as CORESETPoolIndex or PCI).

Similarly, the UE could receive from the network separate indicators respectively indicating whether the new beam q_new indicated in the joint DL and UL TCI state p∈{1, 2,..., M} may be applied to one or more of PDCCH and PUCCH associated with the BFD RS set p (or the corresponding TRP/TRP-specific index/ID value such as CORESETPoolIndex or PCI) and whether the new beam q_new indicated in the joint DL and UL TCI state p∈{1, 2,..., M} may be applied to one or more of PDSCH and PUSCH associated with the BFD RS set p (or the corresponding TRP/TRP-specific index/ID value such as CORESETPoolIndex or PCI).

Alternatively, the UE could receive from a network a single indicator to indicate whether the new beam q_new indicated in the joint DL and UL TCI state p∈{1, 2,..., M} may be applied to one or more of PDCCH, PDSCH, PUCCH and PUSCH associated with the BFD RS set p (or the corresponding TRP/TRP-specific index/ID value such as CORESETPoolIndex or PCI). For instance, the UE could receive from the network a bitmap with each entry/bit position corresponding to a channel such as PDCCH, PDSCH, PUCCH or PUSCH. If an entry/bit position in the bitmap is enabled, e.g., set to “1,” the new beam q_new indicated in the joint DL and UL TCI state p∈{1, 2,..., M} may be applied to the corresponding channel associated with the BFD RS set p (or the corresponding TRP/TRP-specific index/ID value such as CORESETPoolIndex or PCI). The bitmap could comprise more than one entries/bit positions set to “1”s.

For the joint DL and UL TCI state q∈{1, 2,..., M} not indicating any new beam and for DL channels, following examples can be considered.

For example, the UE may apply the same receive filter as that for receiving the PDCCH(s) or PDSCH(s) associated with the BFD RS set q (or the corresponding TRP/TRP-specific index/ID value such as CORESETPoolIndex or PCI) prior to receiving the BFRR to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For another example, the UE may apply the same receive filter as that for receiving the BFRR for the BFD RS set q, i.e., the joint DL and UL TCI state q for PDCCH, PDSCH, PUCCH and PUSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For yet another example, the UE may apply the same receive filter as that for receiving the QCL source RS/beam indicated in the joint DL and UL TCI state q for PDCCH, PDSCH, PUCCH and PUSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI)

For the joint DL and UL TCI state q∈{1, 2,..., M} not indicating any new beam and for UL channels, following examples can be considered.

For example, the UE may apply a transmit filter same as the receive filter for receiving the PDCCH(s) or PDSCH(s) associated with the BFD RS set q (or the corresponding TRP/TRP-specific index/ID value such as CORESETPoolIndex or PCI) prior to receiving the BFRR to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For another example, the UE may apply a transmit filter same as the receive filter for receiving the BFRR for the BFD RS set q, i.e., the joint DL and UL TCI state q for PDCCH, PDSCH, PUCCH and PUSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For yet another example, the UE may apply a transmit filter same as that for receiving the QCL source RS/beam indicated in the joint DL and UL TCI state q for PDCCH, PDSCH, PUCCH and PUSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

In a multi-TRP system, one or more CORESETs could be associated with the same BFD RS set. For example, configuration/indication of a CORESET, e.g., the higher layer parameter ControlResourceSet, could include/comprise the associated BFD RS set index/ID. For another example, a CORESET associated with CORESETPoolIndex m - 1 could be associated with the BFD RS set m, where in this case, m=1, 2. Hence, a PDCCH from a CORESET associated with the BFD RS set m, and the corresponding PDSCH or PUSCH scheduled by the PDCCH, may be associated with the BFD RS set m, where m∈{1, 2,..., M}. Furthermore, one or more PUCCH resource settings or one or more PUCCH resource sets could be associated with the same BFD RS set.

For example, configuration/indication of a PUCCH resource setting, e.g., the higher layer parameter PUCCH-Config, could include/comprise the associated BFD RS set index/ID. For another example, configuration/indication of a PUCCH resource set, e.g., the higher layer parameter PUCCH-ResourceSet, could include/comprise the associated BFD RS set index/ID. Yet for another example, a PUCCH resource set with the PUCCH resource set ID (pucch-ResourceSetId) value m could be associated with the BFD RS set m, where m=1, 2,..., M. Hence, a PUCCH configured in a PUCCH resource setting or a PUCCH resource set associated with the BFD RS set m may be associated with the BFD RS set m, where m∈{1, 2,..., M}.

In a multi-TRP system, one or more CORESETs could be associated with the same TRP-specific index/ID value such as CORESETPoolIndex value, PCI or any other TRP-specific higher layer signaling index value. For example, configuration/indication of a CORESET, e.g., the higher layer parameter ControlResourceSet, could include/comprise the associated TRP-specific index/ID value such as PCI. For another example, a CORESET is associated with a CORESETPoolIndex m - 1, e.g., by incorporating/including the CORESETPoolIndex value in the configuration/indication of the CORESET (e.g., via the higher layer parameter ControlResrouceSet), where in this case, m=1, 2. Hence, a PDCCH from a CORESET associated with the TRP-specific index/ID value x (x = m — 1 for CORESETPoolIndex with m=1, 2) and the corresponding PDSCH or PUSCH scheduled by the PDCCH, may be associated with the TRP-specific index/ID value x (x = m — 1 for CORESETPoolIndex with m=1, 2). Furthermore, one or more PUCCH resource settings or one or more PUCCH resource sets could be associated with the same TRP-specific index/ID value such as CORESETPoolIndex value, PCI or any other TRP-specific higher layer signaling index value.

For example, configuration/indication of a PUCCH resource setting, e.g., the higher layer parameter PUCCH-Config, could include/comprise the associated TRP-specific index/ID value. For another example, configuration/indication of a PUCCH resource set, e.g., the higher layer parameter PUCCH-ResourceSet, could include/comprise the associated TRP-specific index/ID value. Yet for another example, a PUCCH resource set with the PUCCH resource set ID (pucch-ResourceSetId) value m could be associated with CORESETPoolIndex m – 1, where m=1, 2. Hence, a PUCCH configured in a PUCCH resource setting or a PUCCH resource set associated with the TRP-specific index/ID value x (x = m – 1 for CORESETPoolIndex with m=1, 2) may be associated with the TRP-specific index/ID value x (x = m – 1 for CORESETPoolIndex with m=1, 2).

The BFRR could be in form of one or more separate DL and UL TCI states indicated via the aforementioned MAC CE/DCI based common beam indication. The UE could select one or more NBI RS resources and report to the network their indices in their respective NBI RS sets. Each selected NBI RS is from a NBI RS set associated with a failed BFD RS set, wherein according to the U.S. Pat. Application No. 17/449,602 and 17/451,611, respectively, as incorporated by reference herein in their entirety, a BFD RS set is said to be failed if the maximum number of beam failure instance (BFI) count associated with the BFD RS set is achieved. One or more of the reported NBI RSs, i.e., one or more of the reported new beams q_new’s, could be indicated as the QCL source RSs in the one or more separate DL and UL TCI states indicated via the MAC CE/DCI based common beam indication.

In one example, the UE is indicated by the network N≥1 separate DL TCI states in the common beam indication for BFRR each corresponding to/associated with a TRP in the multi-TRP system or a configured BFD RS set, and M≥1 separate UL TCI states in the common beam indication for BFRR each corresponding to/associated with a TRP in the multi-TRP system or a configured BFD RS set. Furthermore, all of the reported NBI RSs, i.e., all of the reported new beams q_new’s, are indicated as the QCL source RSs in their corresponding/associated separate DL and UL TCI states in the common beam indication for BFRR. For instance, a reported NBI RS, i.e., a reported new beam, from a NBI RS set m, may be indicated as the QCL source RS in the separate DL TCI state corresponding to/associated with the failed BFD RS set (e.g., BFD RS set m) corresponding to/associated with the NBI RS set m, and the separate UL TCI state corresponding to/associated with the failed BFD RS set (e.g., BFD RS set m) corresponding to/associated with the NBI RS set m, where m∈{1, 2,..., N} or m∈{1, 2,..., M}.

In another example, the UE could be indicated by the network N≥1 separate DL TCI states in the common beam indication for BFRR each corresponding to/associated with a TRP in the multi-TRP system or a configured BFD RS set, and M≥1 separate UL TCI states in the common beam indication for BFRR each corresponding to/associated with a TRP in the multi-TRP system or a configured BFD RS set. Furthermore, a subset of all the reported NBI RSs, i.e., a subset of all the reported new beams q_new’s, are indicated as the QCL source RSs in their corresponding/associated separate DL and UL TCI states in the common beam indication for BFRR. For instance, a reported NBI RS, i.e., a reported new beam, e.g., from a NBI RS set m, is indicated as the QCL source RS in the separate DL TCI state corresponding to/associated with the failed BFD RS set (e.g., BFD RS set m) corresponding to/associated with the NBI RS set m, and the separate UL TCI state corresponding to/associated with the failed BFD RS set (e.g., BFD RS set m) corresponding to/associated with the NBI RS set m, where m∈{1, 2,..., N} or m∈{1, 2,..., M}.

In addition, a reported NBI RS, i.e., a reported new beam, e.g., from a NBI RS set m′, is not indicated as the QCL source RS in either the separate DL TCI state corresponding to/associated with the failed BFD RS set (e.g., BFD RS set m′) corresponding to/associated with the NBI RS set m′, or the separate UL TCI state corresponding to/associated with the failed BFD RS set (e.g., BFD RS set m′) corresponding to/associated with the NBI RS set m’, where m’∈{1, 2,..., N} or m’∈{1, 2,..., M} and m’≠m.

In yet another example, the UE is indicated by the network only the separate DL and UL TCI states indicating the reported NBI RS(s), i.e., the new beam(s), as the QCL source RSs in the common beam indication for BFRR. That is, the UE is indicated by the network only the separate DL and UL TCI states associated with the failed BFD RS set(s). For example, the UE could first report to the network a total of G≥1 NBI RS resource indices as the new beams selected from G≥1 NBI RS sets each corresponding to/associated with a failed BFD RS set. The UE could then be indicated by the network G≥1 separate DL TCI states and G≥1 separate UL TCI states in the common beam indication for BFRR each indicating a reported NBI RS as the QCL source RS.

Alternatively, the UE could be indicated by the network G’≥1 separate DL TCI states and G’≥1 separate UL TCI states in the common beam indication for BFRR each indicating a reported NBI RS as the QCL source RS. In this case, G’≤G such that the G′ NBI RSs indicated in the G′ separate DL TCI states and the G′ separate UL TCI states is a subset of the total reported G NBI RSs. The UE could be indicated by the network the association between the indicated G (or G′) separate DL TCI states and the indicated G (or G′) separate UL TCI states (and therefore, the NBI RSs indicated therein) and the M TRPs in the multi-TRP system or the M BFD RS sets. For instance, the UE could receive from the network a bitmap of length M with each entry/bit position in the bitmap corresponding to a separate DL TCI state and a separate UL TCI state associated with a TRP in the multi-TRP system or a configured BFD RS set. If an entry/bit position is enabled, e.g., set to “1,” the corresponding separate DL TCI state and separate UL TCI state are indicated in the common beam indication for BFRR. The bitmap could comprise G (or G') “1”s. The G (or G') indicated separate DL TCI states and the G (or G') indicated separate UL TCI states are sorted according to the order of the enabled entries/bit positions (i.e., “1”s) in the bitmap.

A separate DL TCI state indicated in the common beam for BFRR could be for both PDCCH and PDSCH, and a separate UL TCI state indicated in the common beam for BFRR could be for both PUCCH and PUSCH. The UE could be indicated by the network N≥1 separate DL TCI states and M≥1 separate UL TCI states via the MAC CE based or DCI based (with or without MAC CE activation) common beam indication strategy discussed herein.

The NBI RS corresponding to the new beam q_new is indicated as the QCL source RSs in both the separate DL TCI state and the separate UL TCI state in the common beam indication for BFRR. The BFRR for the (failed) BFD RS set p corresponds to the separate DL TCI state p for both PDCCH and PDSCH and the separate UL TCI state p for both PUCCH and PUSCH, both indicating the NBI RS/new beam selected from the NBI RS set p associated with the (failed) BFD RS set p as the QCL source RS, where p∈{1, 2,..., N} or p∈{1, 2,..., M}.

For the DL channels, in one example, X_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply the same receive filter as that for receiving the new beam selected from the NBI RS set p to receive the DL channels PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

For the DL channels, in another example, X_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, Y_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may assume/expect that the network may apply/use the new beam selected by the UE from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply the same receive filter as that for receiving the new beam selected from the NBI RS set p to receive the PDSCH(s) associated with BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be different from X_p, the NBI RS set p is associated with the BFD RS set p, and p∈{1, 2,..., N} or p∈{1, 2,..., M}.

For the DL channels, in yet another example, the UE could receive from the network an indicator indicating whether the new beam q_new indicated in the separate DL TCI state p and the separate UL TCI state p (p∈{1, 2,..., N} or p∈{1, 2,..., M}) may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the separate DL TCI state p for PDCCH and PDSCH and the separate UL TCI state p for PUCCH and PUSCH both indicating the NBI RS/new beam selected from the NBI RS set p associated with the failed BFD RS set p, to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

If the one-bit indicator is set to “1,” Y_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may assume/expect that the network may apply/use the new beam selected by the UE from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be the same as or different from X_p, the NBI RS set p is associated with the BFD RS set p, and p∈{1, 2,..., N} or p∈{1, 2,..., M}.

For another example, Y_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the separate DL TCI state p for PDCCH and PDSCH and the separate UL TCI state p for PUCCH and PUSCH both indicating the NBI RS/new beam selected from the NBI RS set p associated with the failed BFD RS set p, to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

If the one-bit indicator is set to “1,” X_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Here, X_p could be the same as or different from Y_p, the NBI RS set p is associated with the BFD RS set p, and p∈{1, 2,..., N} or p∈{1, 2,..., M}.

For the UL channels, in one example, K_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply a transmit filter same as the receive filter for receiving the new beam selected from the NBI RS set p to transmit the UL channels PUCCH(s) and PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

For the UL channels, in another example, K_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation update for the PUCCH(s) associated with the BFD RS set p (or the corresponding TRP/TRP-specific index/ID value such as CORESETPoolIndex or PCI).

Furthermore, L_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be different from K_p, the NBI RS set p is associated with the BFD RS set p, and p∈{1, 2,..., M}.

For the UL channels, in yet another example, the UE could receive from the network an indicator indicating whether the new beam q_new indicated in the separate DL TCI state p and the separate UL TCI state p (p∈{1, 2,.., N} or p∈{1, 2,..., M}) may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Alternatively, the UE may apply a transmit filter same as the receive filter for receiving the BFRR for the failed BFD RS set p, i.e., the separate DL TCI state p for PDCCH and PDSCH and the separate UL TCI state p for PUCCH and PUSCH both indicating the NBI RS/new beam selected from the NBI RS set p associated with the failed BFD RS set p, to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

If the one-bit indicator is set to “1,” L_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be the same as or different from K_p, the NBI RS set p is associated with the BFD RS set p, and p∈{1, 2,..., N} or p∈{1, 2,..., M}.

For another example, L_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the separate DL TCI state p for PDCCH and PDSCH and the separate UL TCI state p for PUCCH and PUSCH both indicating the NBI RS/new beam selected from the NBI RS set p associated with the failed BFD RS set p, to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

If the one-bit indicator is set to “1,” K_p symbols after receiving the BFRR for the failed BFD RS set p (i.e., the separate DL TCI state p for PDCCH and PDSCH and the separate UL TCI state p for PUCCH and PUSCH, both indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Here, K_p could be the same as or different from L_p, the NBI RS set p is associated with the BFD RS set p, and p∈{1, 2,..., N} or p∈{1, 2,..., M}.

In the discussed design examples, the UE could receive from the network separate indicators respectively indicating whether the new beam q_new indicated in the separate DL TCI state p and the separate UL TCI state p (p∈{1, 2,..., N} or p∈{1, 2,..., M}) may be applied to one or more of PDCCH and PDSCH associated with the BFD RS set p (or the corresponding TRP/TRP-specific index/ID value such as CORESETPoolIndex or PCI) and whether the new beam q_new indicated in the joint DL and UL TCI state p∈{1, 2,..., M} may be applied to one or more of PUCCH and PUSCH associated with the BFD RS set p (or the corresponding TRP/TRP-specific index/ID value such as CORESETPoolIndex or PCI). Similarly, the UE could receive from the network separate indicators respectively indicating whether the new beam q_new indicated in the separate DL TCI state p and the separate UL TCI state p (p∈{1, 2,..., N} or p∈{1, 2,..., M}) may be applied to one or more of PDCCH and PUCCH associated with the BFD RS set p (or the corresponding TRP/TRP-specific index/ID value such as CORESETPoolIndex or PCI) and whether the new beam q_new indicated in the separate DL TCI state p and the separate UL TCI state p (p∈{1, 2,..., N} or p∈{1, 2,..., M}) may be applied to one or more of PDSCH and PUSCH associated with the BFD RS set p (or the corresponding TRP/TRP-specific index/ID value such as CORESETPoolIndex or PCI).

Alternatively, the UE could receive from a network a single indicator to indicate whether the new beam q_new indicated in the separate DL TCI state p and the separate UL TCI state p (p∈{1, 2,..., N} or p∈{1, 2,..., M}) may be applied to one or more of PDCCH, PDSCH, PUCCH and PUSCH associated with the BFD RS set p (or the corresponding TRP/TRP-specific index/ID value such as CORESETPoolIndex or PCI). For instance, the UE could receive from the network a bitmap with each entry/bit position corresponding to a channel such as PDCCH, PDSCH, PUCCH or PUSCH. If an entry/bit position in the bitmap is enabled, e.g., set to “1,” the new beam q_new indicated in the separate DL TCI state p and the separate UL TCI state p (p∈{1, 2,..., N} or p∈{1, 2,..., M}) may be applied to the corresponding channel associated with the BFD RS set p (or the corresponding TRP/TRP-specific index/ID value such as CORESETPoolIndex or PCI). The bitmap could comprise more than one entries/bit positions set to “1”s.

For the separate DL TCI state q∈{1, 2,..., N} not indicating any new beam and for DL channels, following examples can be considered.

For example, the UE may apply the same receive filter as that for receiving the PDCCH(s) or PDSCH(s) associated with the BFD RS set q (or the corresponding TRP/TRP-specific index/ID value such as CORESETPoolIndex or PCI) prior to receiving the BFRR to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For another example, the UE may apply the same receive filter as that for receiving the BFRR for the BFD RS set q to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For yet another example, the UE may apply the same receive filter as that for receiving the QCL source RS/beam indicated in the separate DL TCI state q for PDCCH and PDSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For the separate DL TCI state q ∈{1, 2,..., N} not indicating any new beam and for UL channels, following examples can be considered.

For example, the UE may apply a transmit filter same as the receive filter for receiving the PDCCH(s) or PDSCH(s) associated with the BFD RS set q (or the corresponding TRP/TRP-specific index/ID value such as CORESETPoolIndex or PCI) prior to receiving the BFRR to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For another example, the UE may apply a transmit filter same as the receive filter for receiving the BFRR for the BFD RS set q to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For yet another example, the UE may apply a transmit filter same as that for receiving the QCL source RS/beam indicated in the separate DL TCI state q for both PDCCH and PDSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For the separate UL TCI state q’∈{1, 2,..., M} not indicating any new beam and for DL channels, following examples can be considered.

For example, the UE may apply the same receive filter as that for receiving the PDCCH(s) or PDSCH(s) associated with the BFD RS set q′ (or the corresponding TRP/TRP-specific index/ID value such as CORESETPoolIndex or PCI) prior to receiving the BFRR to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For another example, the UE may apply the same receive filter as that for receiving the BFRR for the BFD RS set q′ to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For yet another example, the UE may apply the same receive filter as that for receiving the QCL source RS/beam indicated in the separate UL TCI state q′ for PUCCH and PUSCH associated with the BFD RS set q′, to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For the separate UL TCI state q′ ∈{1, 2,..., M} not indicating any new beam and for UL channels, following examples can be considered.

For example, the UE may apply a transmit filter same as the receive filter for receiving the PDCCH(s) or PDSCH(s) associated with the BFD RS set q′ (or the corresponding TRP/TRP-specific index/ID value such as CORESETPoolIndex or PCI) prior to receiving the BFRR to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

For another example, the UE may apply a transmit filter same as the receive filter for receiving the BFRR for the BFD RS set q′ to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

For yet another example, the UE may apply a transmit filter same as that for receiving the QCL source RS/beam indicated in the separate UL TCI state q′ for both PUCCH and PUSCH associated with the BFD RS set q′, to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

In a multi-TRP system, one or more CORESETs could be associated with the same BFD RS set. For example, configuration/indication of a CORESET, e.g., the higher layer parameter ControlResourceSet, could include/comprise the associated BFD RS set index/lD. For another example, a CORESET associated with CORESETPoolIndex m - 1 could be associated with the BFD RS set m, where in this case, m=1, 2. Hence, a PDCCH from a CORESET associated with the BFD RS set m, and the corresponding PDSCH or PUSCH scheduled by the PDCCH, may be associated with the BFD RS set m, where m∈{1, 2,..., M}. Furthermore, one or more PUCCH resource settings or one or more PUCCH resource sets could be associated with the same BFD RS set.

For example, configuration/indication of a PUCCH resource setting, e.g., the higher layer parameter PUCCH-Config, could include/comprise the associated BFD RS set index/lD. For another example, configuration/indication of a PUCCH resource set, e.g., the higher layer parameter PUCCH-ResourceSet, could include/comprise the associated BFD RS set index/lD. Yet for another example, a PUCCH resource set with the PUCCH resource set ID (pucch-ResourceSetId) value m could be associated with the BFD RS set m, where m=1, 2,..., M. Hence, a PUCCH configured in a PUCCH resource setting or a PUCCH resource set associated with the BFD RS set m may be associated with the BFD RS set m, where m∈{1, 2,..., M}.

In a multi-TRP system, one or more CORESETs could be associated with the same TRP-specific index/ID value such as CORESETPoolIndex value, PCI or any other TRP-specific higher layer signaling index value. For example, configuration/indication of a CORESET, e.g., the higher layer parameter ControlResourceSet, could include/comprise the associated TRP-specific index/ID value such as PCI. For another example, a CORESET is associated with a CORESETPoolIndex m – 1, e.g., by incorporating/including the CORESETPoolIndex value in the configuration/indication of the CORESET (e.g., via the higher layer parameter ControlResrouceSet), where in this case, m=1, 2. Hence, a PDCCH from a CORESET associated with the TRP-specific index/ID value x (x = m – 1 for CORESETPoolIndex with m=1, 2) and the corresponding PDSCH or PUSCH scheduled by the PDCCH, may be associated with the TRP-specific index/ID value x (x = m – 1 for CORESETPoolIndex with m=1, 2). Furthermore, one or more PUCCH resource settings or one or more PUCCH resource sets could be associated with the same TRP-specific index/ID value such as CORESETPoolIndex value, PCI or any other TRP-specific higher layer signaling index value.

For example, configuration/indication of a PUCCH resource setting, e.g., the higher layer parameter PUCCH-Config, could include/comprise the associated TRP-specific index/ID value. For another example, configuration/indication of a PUCCH resource set, e.g., the higher layer parameter PUCCH-ResourceSet, could include/comprise the associated TRP-specific index/ID value. Yet for another example, a PUCCH resource set with the PUCCH resource set ID (pucch-ResourceSetId) value m could be associated with CORESETPoolIndex m – 1, where m=1, 2. Hence, a PUCCH configured in a PUCCH resource setting or a PUCCH resource set associated with the TRP-specific index/ID value x (x = m – 1 for CORESETPoolIndex with m=1, 2) may be associated with the TRP-specific index/ID value x (x = m – 1 for CORESETPoolIndex with m=1, 2).

The NBI RS corresponding to the new beam q_new is indicated as the QCL source RS in the separate DL TCI state. A RS such as a SSB or a CSI-RS different from the NBI RS corresponding to the new beam q_new is indicated as the QCL source RS in the separate UL TCI state. The BFRR for the (failed) BFD RS set p corresponds to the separate DL TCI state p for PDCCH and PDSCH and the separate UL TCI state p for PUCCH and PUSCH, with only the separate DL TCI state p indicating the NBI RS/new beam selected from the NBI RS set p associated with the (failed) BFD RS set p, where p∈{1, 2,..., N}.

For the DL channels, in one example, X_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBIRS/new beam selected from the NBI RS set p associated with the failed BFD RS set p), the UE may apply the same receive filter as that for receiving the new beam selected from the NBI RS set p to receive the DL channels PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI). Here, the NBI RS set p is associated with the BFD RS set p and p∈{1, 2,..., N}.

For the DL channels, in another example, X_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). That is, X_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Furthermore, Y_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBIRS/new beam selected from the NBI RS set p associated with the failed BFD RS set p), the UE may assume/expect that the network may apply/use the new beam selected by the UE from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBIRS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be different from X_p, the NBI RS set p is associated with the BFD RS set p, and p∈{1, 2,..., N}.

For the DL channels, in yet another example, the UE could receive from the network an indicator indicating whether the new beam q_new indicated in the separate DL TCI state p∈{1, 2,..., N} may be applied to the PDCCH or PDSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, X_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the separate DL TCI state p for PDCCH and PDSCH and the separate UL TCI state p for PUCCH and PUSCH with only the separate DL TCI state p indicating the NBI RS/new beam selected from the NBI RS set p associated with the failed BFD RS set p, to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Optionally, the UE may apply the same receive filter as that for receiving the QCL source RS indicated in the separate UL TCI state p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

If the one-bit indicator is set to “1,” Y_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may assume/expect that the network may apply/use the new beam selected by the UE from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be the same as or different from X_p, the NBI RS set p is associated with the BFD RS set p, and p∈{1, 2,..., N}.

For another example, Y_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the separate DL TCI state p for PDCCH and PDSCH and the separate UL TCI state p for PUCCH and PUSCH with only the separate DL TCI state p indicating the NBI RS/new beam selected from the NBI RS set p associated with the failed BFD RS set p, to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Optionally, the UE may apply the same receive filter as that for receiving the QCL source RS indicated in the separate UL TCI state p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

If the one-bit indicator is set to “1,” X_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Here, X_p could be the same as or different from Y_p, the NBI RS set p is associated with the BFD RS set p, and p∈{1, 2,..., N}.

The UE could receive from the network an indicator indicating whether the new beam indicated in the BFRR for the failed BFD RS set p, i.e., the separate DL TCI state p for PDCCH and PDSCH and the separate UL TCI state p for PUCCH and PUSCH with only the separate DL TCI state p indicating the NBI RS/new beam selected from the NBI RS set p associated with the failed BFD RS set p, may be applied to at least one of PUCCH and PUSCH associated with the BFD RS set p (or the corresponding TRP/TRP-specific index/ID value such as CORESETPoolIndex or PCI); this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For instance, the UE could receive from the network a one-bit indicator with “0”/absent indicating that the new beam may not be applied to the subsequent PUCCH and PUSCH transmissions, and “1” indicating that the new beam may be applied to at least one of subsequent PUCCH and PUSCH transmissions. If the new beam q_new indicated in the BFRR for the failed BFD RS set p (i.e., the separate DL TCI state p for PDCCH and PDSCH and the separate UL TCI state p for PUCCH and PUSCH, with only the separate DL TCI state p indicating the NBIRS/new beam selected from the NBI RS set p associated with the failed BFD RS set p) may be applied to at least one of PUCCH and PUSCH associated with the BFD RS set p (or the corresponding TRP/TRP-specific index/ID value such as CORESETPoolIndex or PCI), following examples can be considered.

In one example, K_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply a transmit filter same as the receive filter for receiving the new beam selected from the NBI RS set p to transmit the UL channels PUCCH(s) and PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

In another example, K_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Furthermore, L_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBIRS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be different from K_p, the NBI RS set p is associated with the BFD RS set p, and p∈{1, 2,..., N}.

In yet another example, the UE could receive from the network an indicator indicating whether the new beam q_new indicated in the separate DL TCI state p∈{1, 2,..., N} may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the separate DL TCI state p for PDCCH and PDSCH and the separate UL TCI state p for PUCCH and PUSCH with only the separate DL TCI state p indicating the NBI RS/new beam selected from the NBI RS set p associated with the failed BFD RS set p, to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Optionally, the UE may apply a transmit filter same as the receive filter for receiving the QCL source RS indicated in the separate UL TCI state p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

If the one-bit indicator is set to “1,” L_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be the same as or different from K_p, the NBI RS set p is associated with the BFD RS set p, and p∈{1, 2,..., N}.

For another example, L_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as+ CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the separate DL TCI state p for PDCCH and PDSCH and the separate UL TCI state p for PUCCH and PUSCH with only the separate DL TCI state p indicating the NBI RS/new beam selected from the NBI RS set p associated with the failed BFD RS set p, to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Optionally, the UE may apply a transmit filter same as the receive filter for receiving the QCL source RS indicated in the separate UL TCI state p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

If the one-bit indicator is set to “1,” K_p symbols after receiving the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Here, K_p could be the same as or different from L_p, the NBI RS set p is associated with the BFD RS set p, and p∈{1, 2,..., N}.

If the new beam q_new indicated in the BFRR for the failed BFD RS set p (i.e., the separate DL TCI state p for PDCCH and PDSCH and the separate UL TCI state p for PUCCH and PUSCH, with only the separate DL TCI state p indicating the NBI RS/new beam selected from the NBI RS set p associated with the failed BFD RS set p) may not be applied to either PUCCH or PUSCH associated with the BFD RS set p (or the corresponding TRP/TRP-specific index/ID value such as CORESETPoolIndex or PCI), the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI); alternatively, the UE may apply a transmit filter same as the receive filter for receiving the BFRR for the failed BFD RS set p, i.e., the separate DL TCI state p for PDCCH and PDSCH and the separate UL TCI state p for PUCCH and PUSCH with only the separate DL TCI state p indicating the NBIRS/new beam selected from the NBI RS set p associated with the failed BFD RS set p, to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI); optionally, the UE may apply a transmit filter same as the receive filter for receiving the QCL source RS indicated in the separate UL TCI state p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

For the separate DL TCI state q∈{1, 2,..., N} not indicating any new beam and for DL channels, following examples can be considered.

For example, the UE may apply the same receive filter as that for receiving the PDCCH(s) or PDSCH(s) associated with the BFD RS set q (or the corresponding TRP/TRP-specific index/ID value such as CORESETPoolIndex or PCI) prior to receiving the BFRR to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For another example, the UE may apply the same receive filter as that for receiving the BFRR for the BFD RS set q to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For yet another example, the UE may apply the same receive filter as that for receiving the QCL source RS/beam indicated in the separate DL TCI state q for PDCCH and PDSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For the separate DL TCI state q ∈{1, 2,..., N} not indicating any new beam and for UL channels, following examples can be considered.

For example, the UE may apply a transmit filter same as the receive filter for receiving the PDCCH(s) or PDSCH(s) associated with the BFD RS set q (or the corresponding TRP/TRP-specific index/ID value such as CORESETPoolIndex or PCI) prior to receiving the BFRR to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For another example, the UE may apply a transmit filter same as the receive filter for receiving the BFRR for the BFD RS set q to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For yet another example, the UE may apply a transmit filter same as that for receiving the QCL source RS/beam indicated in the separate DL TCI state q for both PDCCH and PDSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For the separate UL TCI state q’∈{1, 2,..., M} not indicating any new beam and for DL channels, following examples can be considered.

For example, the UE may apply the same receive filter as that for receiving the PDCCH(s) or PDSCH(s) associated with the BFD RS set q′ (or the corresponding TRP/TRP-specific index/ID value such as CORESETPoolIndex or PCI) prior to receiving the BFRR to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For another example, the UE may apply the same receive filter as that for receiving the BFRR for the BFD RS set q′ to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For yet another example, the UE may apply the same receive filter as that for receiving the QCL source RS/beam indicated in the separate UL TCI state q′ for PUCCH and PUSCH associated with the BFD RS set q′, to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For the separate UL TCI state q′ ∈{1, 2,..., M} not indicating any new beam and for UL channels, following examples can be considered.

For example, the UE may apply a transmit filter same as the receive filter for receiving the PDCCH(s) or PDSCH(s) associated with the BFD RS set q′ (or the corresponding TRP/TRP-specific index/ID value such as CORESETPoolIndex or PCI) prior to receiving the BFRR to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

For another example, the UE may apply a transmit filter same as the receive filter for receiving the BFRR for the BFD RS set q′ to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

For yet another example, the UE may apply a transmit filter same as that for receiving the QCL source RS/beam indicated in the separate UL TCI state q′ for both PUCCH and PUSCH associated with the BFD RS set q′, to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

In a multi-TRP system, one or more CORESETs could be associated with the same BFD RS set. For example, configuration/indication of a CORESET, e.g., the higher layer parameter ControlResourceSet, could include/comprise the associated BFD RS set index/lD. For another example, a CORESET associated with CORESETPoolIndex n - 1 could be associated with the BFD RS set n, where in this case, n=1, 2. Hence, a PDCCH from a CORESET associated with the BFD RS set n, and the corresponding PDSCH or PUSCH scheduled by the PDCCH, may be associated with the BFD RS set n, where n∈{1, 2,..., N}. Furthermore, one or more PUCCH resource settings or one or more PUCCH resource sets could be associated with the same BFD RS set. For example, configuration/indication of a PUCCH resource setting, e.g., the higher layer parameter PUCCH-Config, could include/comprise the associated BFD RS set index/lD. For another example, configuration/indication of a PUCCH resource set, e.g., the higher layer parameter PUCCH-ResourceSet, could include/comprise the associated BFD RS set index/lD. Yet for another example, a PUCCH resource set with the PUCCH resource set ID (pucch-ResourceSetId) value n could be associated with the BFD RS set n, where n=1, 2,..., N. Hence, a PUCCH configured in a PUCCH resource setting or a PUCCH resource set associated with the BFD RS set n may be associated with the BFD RS set n, where n∈{1, 2,..., N}.

In a multi-TRP system, one or more CORESETs could be associated with the same TRP-specific index/ID value such as CORESETPoolIndex value, PCI or any other TRP-specific higher layer signaling index value. For example, configuration/indication of a CORESET, e.g., the higher layer parameter ControlResourceSet, could include/comprise the associated TRP-specific index/ID value such as PCI. For another example, a CORESET is associated with a CORESETPoolIndex n – 1, e.g., by incorporating/including the CORESETPoolIndex value in the configuration/indication of the CORESET (e.g., via the higher layer parameter ControlResrouceSet), where in this case, n=1, 2. Hence, a PDCCH from a CORESET associated with the TRP-specific index/ID value x (x = n – 1 for CORESETPoolIndex with n=1, 2) and the corresponding PDSCH or PUSCH scheduled by the PDCCH, may be associated with the TRP-specific index/ID value x (x = n – 1 for CORESETPoolIndex with n=1, 2).

Furthermore, one or more PUCCH resource settings or one or more PUCCH resource sets could be associated with the same TRP-specific index/ID value such as CORESETPoolIndex value, PCI or any other TRP-specific higher layer signaling index value. For example, configuration/indication of a PUCCH resource setting, e.g., the higher layer parameter PUCCH-Config, could include/comprise the associated TRP-specific index/ID value. For another example, configuration/indication of a PUCCH resource set, e.g., the higher layer parameter PUCCH-ResourceSet, could include/comprise the associated TRP-specific index/ID value. Yet for another example, a PUCCH resource set with the PUCCH resource set ID (pucch-ResourceSetId) value n could be associated with CORESETPoolIndex n – 1, where n=1, 2. Hence, a PUCCH configured in a PUCCH resource setting or a PUCCH resource set associated with the TRP-specific index/ID value x (x = n – 1 for CORESETPoolIndex with n=1, 2) may be associated with the TRP-specific index/ID value x (x = n – 1 for CORESETPoolIndex with n=1, 2).

The NBI RS corresponding to the new beam q_new is indicated as the QCL source RS in the separate UL TCI state. A RS such as a SSB or a CSI-RS different from the NBI RS corresponding to the new beam q_new is indicated as the QCL source RS in the separate DL TCI state. The BFRR for the (failed) BFD RS set p corresponds to the separate DL TCI state p for PDCCH and PDSCH and the separate UL TCI state p for PUCCH and PUSCH, with only the separate UL TCI state p indicating the NBI RS/new beam selected from the NBI RS set p associated with the (failed) BFD RS set p, where p∈{1, 2,..., M}.

For the UL channels, in one example, K_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply a transmit filter same as the receive filter for receiving the new beam selected from the NBI RS set p to transmit the UL channels PUCCH(s) and PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

For the UL channels, in another example, K_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation update for the PUCCH(s) associated with the BFD RS set p (or the corresponding TRP/TRP-specific index/ID value such as CORESETPoolIndex or PCI).

Furthermore, L_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBIRS/new beam selected from the NBIRS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be different from K_p, the NBI RS set p is associated with the BFD RS set p, and p∈{1, 2,..., M}.

For the UL channels, in yet another example, the UE could receive from the network an indicator indicating whether the new beam q_new indicated in the separate UL TCI state p∈{1, 2,..., M} may be applied to the PUCCH or PUSCH or both; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, K_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUSCH transmission and “1” indicating that the new beam may be applied to the subsequent PUSCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the separate DL TCI state p for PDCCH and PDSCH and the separate UL TCI state p for PUCCH and PUSCH with only the separate UL TCI state p indicating the NBI RS/new beam selected from the NBI RS set p associated with the failed BFD RS set p, to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Optionally, the UE may apply a transmit filter same as the receive filter for receiving the QCL source RS indicated in the separate DL TCI state p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

If the one-bit indicator is set to “1,” L_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply a transmit filter same as the receive filter for receiving the new beam selected from the NBI RS set p to transmit the PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Here, L_p could be the same as or different from K_p, the NBI RS set p is associated with the BFD RS set p, and p∈{1, 2,..., M}.

For another example, L_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PUCCH transmission and “1” indicating that the new beam may be applied to the subsequent PUCCH transmission.

If the one-bit indicator is set to “0” or absent, the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p, i.e., the separate DL TCI state p for PDCCH and PDSCH and the separate UL TCI state p for PUCCH and PUSCH with only the separate UL TCI state p indicating the NBI RS/new beam selected from the NBI RS set p associated with the failed BFD RS set p, to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Optionally, the UE may apply a transmit filter same as the receive filter for receiving the QCL source RS indicated in the separate DL TCI state p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

If the one-bit indicator is set to “1,” K_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply a transmit filter same as the receive filter for receiving the new beam selected from the NBI RS set p to transmit the PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Here, K_p could be the same as or different from L_p, the NBI RS set p is associated with the BFD RS set p, and p∈{1, 2,..., M}.

The UE could receive from the network an indicator indicating whether the new beam indicated in the BFRR for the failed BFD RS set p, i.e., the separate DL TCI state p for PDCCH and PDSCH and the separate UL TCI state p for PUCCH and PUSCH with only the separate UL TCI state p indicating the NBI RS/new beam selected from the NBI RS set p associated with the failed BFD RS set p, may be applied to at least one of PDCCH and PDSCH associated with the BFD RS set p (or the corresponding TRP/TRP-specific index/ID value such as CORESETPoolIndex or PCI); this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For instance, the UE could receive from the network a one-bit indicator with “0”/absent indicating that the new beam may not be applied to the subsequent PDCCH and PDSCH transmissions, and “1” indicating that the new beam may be applied to at least one of subsequent PDCCH and PDSCH transmissions. If the new beam q_new indicated in the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p) may be applied to at least one of PDCCH and PDSCH associated with the BFD RS set p (or the corresponding TRP/TRP-specific index/ID value such as CORESETPoolIndex or PCI), following examples can be considered.

In one example, X_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply the same receive filter as that for receiving the new beam selected from the NBI RS set p to receive the DL channels PDCCH(s) and PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

In another example, X_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may assume/expect that the network may apply/use the new beam selected by the UE from the NBI RS set p to transmit the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

That is, X_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Furthermore, Y_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may assume/expect that the network may apply/use the new beam selected from the NBI RS set p to transmit the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

That is, Y_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBIRS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be different from X_p, the NBI RS set p is associated with the BFD RS set p, and p∈{1, 2,..., M}.

In yet another example, the UE could receive from the network an indicator indicating whether the new beam q_new indicated in the separate UL TCI state p∈{1, 2,..., M} may be applied to the PDCCH or PDSCH or both; this indication could be via higher layer (RRC) or/and MAC CE or/and DCI based signaling or/and any combination of at least two of RRC, MAC CE and DCIbased signaling; this indication could be via a separate (dedicated) parameter or joint with another parameter.

For example, X_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBIRS/new beam selected from the NBI RS set p associated with the failed BFD RS set p), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDSCH transmission and “1” indicating that the new beam may be applied to the subsequent PDSCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PD SCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the separate DL TCI state p for PDCCH and PDSCH and the separate UL TCI state p for PUCCH and PUSCH with only the separate UL TCI state p indicating the NBI RS/new beam selected from the NBI RS set p associated with the failed BFD RS set p, to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Optionally, the UE may apply the same receive filter as that for receiving the QCL source RS indicated in the separate DL TCI state p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

If the one-bit indicator is set to “1,” Y_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply the same receive filter as that for receiving the new beam selected from the NBI RS set p to receive the PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Here, Y_p could be the same as or different from X_p, the NBI RS set p is associated with the BFD RS set p, and p∈{1, 2,..., M}.

For another example, Y_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). In addition, the UE could receive from the network a one-bit indicator with “0”/absent indicating that the new beam may not be applied to the subsequent PDCCH transmission and “1” indicating that the new beam may be applied to the subsequent PDCCH transmission.

If the one-bit indicator is set to “0” or absent, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p, i.e., the separate DL TCI state p for PDCCH and PDSCH and the separate UL TCI state p for PUCCH and PUSCH with only the separate UL TCI state p indicating the NBI RS/new beam selected from the NBI RS set p associated with the failed BFD RS set p, to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Optionally, the UE may apply the same receive filter as that for receiving the QCL source RS indicated in the separate DL TCI state p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

If the one-bit indicator is set to “1,” X_p symbols after receiving the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p), the UE may apply the same receive filter as that for receiving the new beam selected from the NBI RS set p to receive the PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

Here, X_p could be the same as or different from Y_p, the NBI RS set p is associated with the BFD RS set p, and p∈{1, 2,..., M}. If the new beam q_new indicated in the BFRR for the failed BFD RS set p (i.e., the separate DL TCI state p for PDCCH and PDSCH and the separate UL TCI state p for PUCCH and PUSCH, with only the separate UL TCI state p indicating the NBI RS/new beam selected from the NBI RS set p associated with the failed BFD RS set p) may not be applied to either PDCCH or PDSCH, the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI); alternatively, the UE may apply the same receive filter as that for receiving the BFRR for the failed BFD RS set p, i.e., the separate DL TCI state p for PDCCH and PDSCH and the separate UL TCI state p for PUCCH and PUSCH with only the separate UL TCI state p indicating the NBI RS/new beam selected from the NBI RS set p associated with the failed BFD RS set p, to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI); optionally, the UE may apply the same receive filter as that for receiving the QCL source RS indicated in the separate DL TCI state p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

For the separate UL TCI state q∈{1, 2,..., M} not indicating any new beam and for DL channels, following examples can be considered.

For example, the UE may apply the same receive filter as that for receiving the PDCCH(s) or PDSCH(s) associated with the BFD RS set q (or the corresponding TRP/TRP-specific index/ID value such as CORESETPoolIndex or PCI) prior to receiving the BFRR to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For another example, the UE may apply the same receive filter as that for receiving the BFRR for the BFD RS set q to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For yet another example, the UE may apply the same receive filter as that for receiving the QCL source RS/beam indicated in the separate UL TCI state q for PUCCH and PUSCH associated with the BFD RS set q, to receive the subsequent PDCCH(s) or PDSCH(s) associated with the BFD RS set q (or the corresponding TRP/TRP-specific index/ID value such as CORESETPoolIndex or PCI) until the UE receives a TCI state update for the PDCCH(s) or PDSCH(s) associated with the BFD RS set q (or the corresponding TRP/TRP-specific index/ID value such as CORESETPoolIndex or PCI).

For the separate UL TCI state q ∈{1, 2,..., M} not indicating any new beam and for UL channels, following examples can be considered.

For example, the UE may apply a transmit filter same as the receive filter for receiving the PDCCH(s) or PDSCH(s) associated with the BFD RS set q (or the corresponding TRP/TRP-specific index/ID value such as CORESETPoolIndex or PCI) prior to receiving the BFRR to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For another example, the UE may apply a transmit filter same as the receive filter for receiving the BFRR for the BFD RS set q to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For yet another example, the UE may apply a transmit filter same as that for receiving the QCL source RS/beam indicated in the separate UL TCI state q for both PUCCH and PUSCH associated with the BFD RS set q, to transmit the subsequent PUCCH(s) or PUSCH(s) associated with the BFD RS set q (or the corresponding TRP/TRP-specific index/ID value such as CORESETPoolIndex or PCI) until the UE receives a TCI state/spatial relation information update for the PUCCH(s) or PUSCH(s) associated with the BFD RS set q (or the corresponding TRP/TRP-specific index/ID value such as CORESETPoolIndex or PCI).

For the separate DL TCI state q′ ∈{1, 2,..., N} not indicating any new beam and for DL channels, following examples can be considered.

For example, the UE may apply the same receive filter as that for receiving the PDCCH(s) or PDSCH(s) associated with the BFD RS set q′ (or the corresponding TRP/TRP-specific index/ID value such as CORESETPoolIndex or PCI) prior to receiving the BFRR to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For another example, the UE may apply the same receive filter as that for receiving the BFRR for the BFD RS set q′ to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For yet another example, the UE may apply the same receive filter as that for receiving the QCL source RS/beam indicated in the separate DL TCI state q′ for PDCCH and PDSCH associated with the BFD RS set q′, to receive the subsequent PDCCH(s) or PDSCH(s) associated with the BFD RS set q′ (or the corresponding TRP/TRP-specific index/ID value such as CORESETPoolIndex or PCI) until the UE receives a TCI state update for the PDCCH(s) or PDSCH(s) associated with the BFD RS set q′ (or the corresponding TRP/TRP-specific index/ID value such as CORESETPoolIndex or PCI).

For the separate DL TCI state q′ ∈{1, 2,..., N} not indicating any new beam and for UL channels, following examples can be considered.

For example, the UE may apply a transmit filter same as the receive filter for receiving the PDCCH(s) or PDSCH(s) associated with the BFD RS set q′ (or the corresponding TRP/TRP-specific index/ID value such as CORESETPoolIndex or PCI) prior to receiving the BFRR to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

For another example, the UE may apply a transmit filter same as the receive filter for receiving the BFRR for the BFD RS set q′ to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

For yet another example, the UE may apply a transmit filter same as that for receiving the QCL source RS/beam indicated in the separate DL TCI state q′ for both PDCCH and PDSCH associated with the BFD RS set q′, to transmit the subsequent PUCCH(s) or PUSCH(s) associated with the BFD RS set q′ (or the corresponding TRP/TRP-specific index/ID value such as CORESETPoolIndex or PCI) until the UE receives a TCI state/spatial relation information update for the PUCCH(s) or PUSCH(s) associated with the BFD RS set q′ (or the corresponding TRP/TRP-specific index/ID value such as CORESETPoolIndex or PCI).

In a multi-TRP system, one or more CORESETs could be associated with the same BFD RS set. For example, configuration/indication of a CORESET, e.g., the higher layer parameter ControlResourceSet, could include/comprise the associated BFD RS set index/lD. For another example, a CORESET associated with CORESETPoolIndex m - 1 could be associated with the BFD RS set m, where in this case, m=1, 2. Hence, a PDCCH from a CORESET associated with the BFD RS set m, and the corresponding PDSCH or PUSCH scheduled by the PDCCH, may be associated with the BFD RS set m, where m∈{1, 2,..., M}.

Furthermore, one or more PUCCH resource settings or one or more PUCCH resource sets could be associated with the same BFD RS set. For example, configuration/indication of a PUCCH resource setting, e.g., the higher layer parameter PUCCH-Config, could include/comprise the associated BFD RS set index/lD. For another example, configuration/indication of a PUCCH resource set, e.g., the higher layer parameter PUCCH-ResourceSet, could include/comprise the associated BFD RS set index/ID. Yet for another example, a PUCCH resource set with the PUCCH resource set ID (pucch-ResourceSetId) value m could be associated with the BFD RS set m, where m=1, 2,..., M. Hence, a PUCCH configured in a PUCCH resource setting or a PUCCH resource set associated with the BFD RS set m may be associated with the BFD RS set m, where m∈{1, 2,..., M}.

In a multi-TRP system, one or more CORESETs could be associated with the same TRP-specific index/ID value such as CORESETPoolIndex value, PCI or any other TRP-specific higher layer signaling index value. For example, configuration/indication of a CORESET, e.g., the higher layer parameter ControlResourceSet, could include/comprise the associated TRP-specific index/ID value such as PCI. For another example, a CORESET is associated with a CORESETPoolIndex m – 1, e.g., by incorporating/including the CORESETPoolIndex value in the configuration/indication of the CORESET (e.g., via the higher layer parameter ControlResrouceSet), where in this case, m=1, 2. Hence, a PDCCH from a CORESET associated with the TRP-specific index/ID value x (x = m – 1 for CORESETPoolIndex with m=1, 2) and the corresponding PDSCH or PUSCH scheduled by the PDCCH, may be associated with the TRP-specific index/ID value x (x = m – 1 for CORESETPoolIndex with m=1, 2).

Furthermore, one or more PUCCH resource settings or one or more PUCCH resource sets could be associated with the same TRP-specific index/ID value such as CORESETPoolIndex value, PCI or any other TRP-specific higher layer signaling index value. For example, configuration/indication of a PUCCH resource setting, e.g., the higher layer parameter PUCCH-Config, could include/comprise the associated TRP-specific index/ID value. For another example, configuration/indication of a PUCCH resource set, e.g., the higher layer parameter PUCCH-ResourceSet, could include/comprise the associated TRP-specific index/ID value. Yet for another example, a PUCCH resource set with the PUCCH resource set ID (pucch-ResourceSetId) value m could be associated with CORESETPoolIndex m – 1, where m=1, 2. Hence, a PUCCH configured in a PUCCH resource setting or a PUCCH resource set associated with the TRP-specific index/ID value x (x = m – 1 for CORESETPoolIndex with m=1, 2) may be associated with the TRP-specific index/ID value x (x = m – 1 for CORESETPoolIndex with m=1, 2).

As discussed herein, four slots after the UE has transmitted the BFRQ, the UE could start to monitor a dedicated CORESET/search space for BFRR. The dedicated CORESET is addressed to the UE-specific C-RNTI, and may be transmitted by the gNB using the newly identified beam. Alternatively, the BFRR could also be a normal uplink grant for scheduling a new transmission for the same HARQ process (e.g., with the same HARQ process ID) as the PUSCH carrying the MAC CE for BFR.

In a multi-TRP system, one or more CORESETs could be associated with the same BFD RS set. For example, configuration/indication of a CORESET, e.g., the higher layer parameter ControlResourceSet, could include/comprise the associated BFD RS set index/lD. For another example, a CORESET associated with CORESETPoolIndex m – 1 could be associated with the BFD RS set m, where in this case, m=1, 2. Hence, a PDCCH from a CORESET associated with the BFD RS set m, and the corresponding PDSCH or PUSCH scheduled by the PDCCH, may be associated with the BFD RS set m, where m∈{1, 2,..., M}.

Furthermore, one or more PUCCH resource settings or one or more PUCCH resource sets could be associated with the same BFD RS set. For example, configuration/indication of a PUCCH resource setting, e.g., the higher layer parameter PUCCH-Config, could include/comprise the associated BFD RS set index/lD. For another example, configuration/indication of a PUCCH resource set, e.g., the higher layer parameter PUCCH-ResourceSet, could include/comprise the associated BFD RS set index/ID. Yet for another example, a PUCCH resource set with the PUCCH resource set ID (pucch-ResourceSetId) value m could be associated with the BFD RS set m, where m=1, 2,..., M. Hence, a PUCCH configured in a PUCCH resource setting or a PUCCH resource set associated with the BFD RS set m may be associated with the BFD RS set m, where m∈{1, 2,..., M}.

In a multi-TRP system, one or more CORESETs could be associated with the same TRP-specific index/ID value such as CORESETPoolIndex value, PCI or any other TRP-specific higher layer signaling index value. For example, configuration/indication of a CORESET, e.g., the higher layer parameter ControlResourceSet, could include/comprise the associated TRP-specific index/ID value such as PCI. For another example, a CORESET is associated with a CORESETPoolIndex m – 1, e.g., by incorporating/including the CORESETPoolIndex value in the configuration/indication of the CORESET (e.g., via the higher layer parameter ControlResrouceSet), where in this case, m=1, 2. Hence, a PDCCH from a CORESET associated with the TRP-specific index/ID value x (x = m – 1 for CORESETPoolIndex with m=1, 2) and the corresponding PDSCH or PUSCH scheduled by the PDCCH, may be associated with the TRP-specific index/ID value x (x = m – 1 for CORESETPoolIndex with m=1, 2).

Furthermore, one or more PUCCH resource settings or one or more PUCCH resource sets could be associated with the same TRP-specific index/ID value such as CORESETPoolIndex value, PCI or any other TRP-specific higher layer signaling index value. For example, configuration/indication of a PUCCH resource setting, e.g., the higher layer parameter PUCCH-Config, could include/comprise the associated TRP-specific index/ID value. For another example, configuration/indication of a PUCCH resource set, e.g., the higher layer parameter PUCCH-ResourceSet, could include/comprise the associated TRP-specific index/ID value. Yet for another example, a PUCCH resource set with the PUCCH resource set ID (pucch-ResourceSetId) value m could be associated with CORESETPoolIndex m – 1, where m=1, 2. Hence, a PUCCH configured in a PUCCH resource setting or a PUCCH resource set associated with the TRP-specific index/ID value x (x = m – 1 for CORESETPoolIndex with m=1, 2) may be associated with the TRP-specific index/ID value x (x = m – 1 for CORESETPoolIndex with m=1, 2).

For the multi-TRP BFR, the UE could receive from the network a single BFRR for all the (failed) BFR RS sets. For example, the BFRR could be a dedicated CORESET/search space addressed to the UE-specific C-RNTI, and transmitted using the newly identified beam. For another example, the BFRR could be an uplink grant for scheduling a new transmission for the same HARQ process (e.g., with the same HARQ process ID) as the PUSCH carrying the MAC CE for the multi-TRP BFR.

Alternatively, the UE could receive from the network one or more BFRRs each for a (failed) BFD RS set.

For example (example-A), the BFRR for the (failed) BFD RS set p could be a dedicated CORESET/search space associated with the BFD RS set p (e.g., via the association between the CORESETPoolIndex values and the BFD RS sets discussed herein) addressed to the UE-specific C-RNTI, and transmitted using the newly identified beam, where p∈{1,2,..., M}. That is, the BFRR for the (failed) BFD RS set p or an entity ID could be a (first) PDCCH reception in a search space set (associated with the BFD RS set p or the entity ID) provided by recoverySearchSpaceId where the UE detects a DCI format with CRC scrambled by C-RNTI or MCS-C-RNTI for the PCell or the PSCell, where p∈{1,2,..., M}, and the entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/lD.

For another example (example-B), the BFRR for the (failed) BFD RS set p could could be an uplink grant for scheduling a new transmission for the same HARQ process (e.g., with the same HARQ process ID) as the PUSCH associated with the BFD RS set p carrying the BFR MAC CE for the BFD RS set p, where p∈{1,2,...,M}. That is, the BFRR for the (failed) BFD RS set p or an entity ID could be a PDCCH reception in a CORESET associated with the BFD RS set p or the entity ID with a DCI format scheduling a PUSCH transmission with a same HARQ process number as for the transmission of the PUSCH (e.g., associated with the BFD RS set p or the entity ID) carrying the MAC CE for BFR for the BFD RS set p or the entity ID and having a toggled NDI field value for the SCell, where p∈{1,2,...,M}, and the entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

Yet for another example (example-C), the BFRR for the (failed) BFD RS set p or an entity ID could be a PDCCH reception in a CORESET associated with the BFD RS set p or the entity ID that determines the completion of the contention based random access procedure for BFR as described in the 3GPP TS 38.321 for the TRP associated with the BFD RS (beam) set p or the entity ID, where p∈{1,2,..., M}, and the entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

Yet for another example (example-D), as discussed herein in the present disclosure, the BFRR for the (failed) BFD RS set p or an entity ID could be a unified/common TCI state(s) indication/update associated with/for the BFD RS set p or the entity ID, where the unified/common TCI state(s) could be indicated/updated for various DL and/or UL channels/signals such as PDCCH, PDSCH, CSI-RS, PUCCH, PUSCH or SRS associated with the BFD RS set p or the entity ID, and the unified/common TCI state(s) could be indicated/provided/configured in a beam indication DCI (e.g., DCI format 1_1 or 1_2 with or without DL assignment) received in a CORESET associated with the BFD RS set p or the entity ID. Here, p∈{ 1,2,...,M}, and the entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

Yet for another example (example-E), as discussed herein in the present disclosure, the BFRR for the (failed) BFD RS set p or a first entity ID could be a unified/common TCI state(s) indication/update associated with/for the BFD RS set p or the first entity ID, where the unified/common TCI state(s) could be indicated/updated for various DL and/or UL channels/signals such as PDCCH, PDSCH, CSI-RS, PUCCH, PUSCH or SRS associated with the BFD RS set p or the first entity ID, and the unified/common TCI state(s) could be indicated/provided/configured in a beam indication DCI (e.g., DCI format 1_1 or 1_2 with or without DL assignment) received in a CORESET associated with the BFD RS set p′ or a second entity ID. Here, p∈{1,2,...,M}, p’∈{1,2,...,M}, and the first or the second entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID. In this design example, the value of p could be different from the value of p′, e.g., p=1 (e.g., the first BFD RS set or BFD RS set 1 or set q̅_{0,0} described herein in the present disclosure) while p′=2 (e.g., the second BFD RS set or BFD RS set 2 or set q̅_{0,1} described herein in the present disclosure), or p=2 (e.g., the second BFD RS set or BFD RS set 2 or set q̅_{0,1} described herein in the present disclosure) while p′=1 (e.g., the first BFD RS set or BFD RS set 1 or set q̅_{0,0} described herein in the present disclosure). The first entity ID could also be different from the second entity ID.

For the example-C, the UE is provided, in message 3 (Msg3) or message A (MsgA) of contention-based random-access procedure, a BFR MAC CE for the BFD RS set p or an entity ID, and a PUCCH resource associated with the BFD RS set p or the entity ID is provided with PUCCH-SpatialRelationInfo or UL-TCIState associated with the BFD RS set q or the entity ID, where p∈{ 1,2,...,M}, and the entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGrouplndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID. For the example-B, the UE can provide in a first PUSCH MAC CE (e.g., associated with the BFD RS set p or an entity ID) index(es) for at least corresponding BFD RS set p or the entity ID with radio link quality worse than Q_{out,LR}, indication(s) of presence of q_{new} for corresponding BFD RS set p or the entity ID, and index(es) q_{new} for a periodic CSI-RS configuration or for a SS/PBCH block provided by higher layers, as described in [11, TS 38.321], if any, for corresponding BFD RS set p or the entity ID, where p∈{1,2,...,M}, and the entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGrouplndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

Various UE’s behaviors after receiving one or more of the above discussed BFRR formats/forms (such as those specified in the example-A, example-B, example-C, example-D or example-E) for the (failed) BFD RS set p (p∈{1,2,...,M}) are specified as follows, under the unified TCI framework, wherein the UE could be provided/configured/indicated by the network, e.g., in a MAC CE or DCI format 1_1 or 1_2 with or without DL assignment (e.g., by the TCI field in the beam indication DCI), one or more unified TCI states each for transmission/reception of various DL/UL channels/signals such as PDCCH, PDSCH, CSI-RS, PUCCH, PUSCH or SRS associated with a TRP configured/associated with a BFD RS (beam) set p (p∈{1,2,...,M}) or an entity ID specified herein in the present disclosure.

In one example, X_p symbols after receiving the BFRR for the failed BFD RS set p, the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

For PDSCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

For PUCCH(s) or PUSCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

In another example, Y_p symbols after receiving the BFRR for the failed BFD RS set p (p∈{1, 2,..., M}), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

For PDCCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

For PUCCH(s) or PUSCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI). Alternatively, the UE may apply a transmit filter same as the receive filter for receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

In yet another example, K_p symbols after receiving the BFRR for the failed BFD RS set p (p∈{1, 2,..., M}), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

For PDCCH(s) or PDSCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

For PUSCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

In yet another example, L_p symbols after receiving the BFRR for the failed BFD RS set p (p∈{ 1,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

For PDCCH(s) or PDSCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

For PUCCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

In yet another example, X_p symbols after receiving the BFRR for the failed BFD RS set p (p∈{1, 2,..., M}), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, Y_p symbols after receiving the BFRR for the failed BFD RS set p (p∈{1, 2,..., M}), the UE may apply the same receive filter as that for receiving the new beam selected from the NBIRS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

For PUCCH(s) or PUSCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p to transmit the subsequent PUCCH(s) or PUSCH(s) associated with the BFD RS set p (or the corresponding TRP/TRP-specific index/ID value such as CORESETPoolIndex or PCI) until the UE receives a TCI state/spatial relation information update for the PUCCH(s) or PUSCH(s) associated with the BFD RS set p (or the corresponding TRP/TRP-specific index/ID value such as CORESETPoolIndex or PCI).

In yet another example, X_p symbols after receiving the BFRR for the failed BFD RS set p (p∈{1, 2,..., M}), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, K_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

For PDSCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

For PUSCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

In yet another example, X_p symbols after receiving the BFRR for the failed BFD RS set p (p∈{1, 2,..., M}), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, L_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

For PDSCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

For PUCCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Alternatively, the UE may apply a transmit filter same as the receive filter for receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

In yet another example, X_p symbols after receiving the BFRR for the failed BFD RS set p (p∈{1, 2,..., M}), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, Y_p symbols after receiving the BFRR for the failed BFD RS set p (p∈{1, 2,..., M}), the UE may apply the same receive filter as that for receiving the new beam selected from the NBIRS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

In addition, K_p symbols after receiving the BFRR for the failed BFD RS set p (p∈{1, 2,..., M}), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

For PUSCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI). Alternatively, the UE may apply a transmit filter same as the receive filter for receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

In yet another example, X_p symbols after receiving the BFRR for the failed BFD RS set p (p∈{1, 2,..., M}), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, Y_p symbols after receiving the BFRR for the failed BFD RS set p (p∈{1, 2,..., M}), the UE may apply the same receive filter as that for receiving the new beam selected from the NBIRS set p to receive the subsequent PDSCH(s) associated with the BFD RS set p (or the corresponding TRP/TRP-specific index/ID value such as CORESETPoolIndex or PCI) until the UE receives a TCI state update for the PD SCH(s) associated with the BFD RS set p (or the corresponding TRP/TRP-specific index/ID value such as CORESETPoolIndex or PCI).

In addition, L_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

For PUCCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Alternatively, the UE may apply a transmit filter same as the receive filter for receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

In yet another example, X_p symbols after receiving the BFRR for the failed BFD RS set p (p∈{1, 2,..., M}), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, K_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state update for the PUCCH(s) associated with the BFD RS set p (or the corresponding TRP/TRP-specific index/ID value such as CORESETPoolIndex or PCI).

In addition, L_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

For PDSCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

Alternatively, the UE may apply the same receive filter as that for receiving the BFRR for the failed BFD RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

In yet another example, Y_p symbols after receiving the BFRR for the failed BFD RS set p (p∈{1, 2,..., M}), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Furthermore, K_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

For PDCCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

For PUSCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

Alternatively, the UE may apply a transmit filter same as the receive filter for receiving the BFRR for the failed BFD RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

In yet another example, Y_p symbols after receiving the BFRR for the failed BFD RS set p (p∈{1, 2,..., M}), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Furthermore, L_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

For PDCCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

For PUCCH(s): the UE may apply a transmit filter same as the receive filter for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Alternatively, the UE may apply a transmit filter same as the receive filter for receiving the BFRR for the failed BFD RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI).

In yet another example, Y_p symbols after receiving the BFRR for the failed BFD RS set p (p∈{1, 2,..., M}), the UE may apply the same receive filter as that for receiving the new beam selected from the NBI RS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI). Furthermore, K_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state update for the PUCCH(s) associated with the BFD RS set p (or the corresponding TRP/TRP-specific index/ID value such as CORESETPoolIndex or PCI).

In addition, L_p symbols after receiving the BFRR for the failed BFD RS set p (p∈{1, 2,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

For PDCCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI).

In yet another example, K_p symbols after receiving the BFRR for the failed BFD RS set p (p∈{1, 2,..., M}), the UE may apply a transmit filter same as that for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state/spatial relation information update for the PUCCH(s) associated with the BFD RS set p (or the corresponding TRP/TRP-specific index/ID value such as CORESETPoolIndex or PCI). Furthermore, L_p symbols after receiving the BFRR for the failed BFD RS set p (p∈{ 1, 2,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

For PDCCH(s) or PDSCH(s): the UE may apply the same receive filter as that for receiving the PDCCH(s) or PDSCH(s) associated with the BFD RS set p (or the corresponding TRP/TRP-specific index/ID value such as CORESETPoolIndex or PCI) prior to receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI). Alternatively, the UE may apply the same receive filter as that for receiving the BFRR for the failed BFD RS set p to receive the subsequent PDCCH(s) or PDSCH(s) associated with the BFD RS set p (or the corresponding TRP/TRP-specific index/ID value such as CORESETPoolIndex or PCI) until the UE receives a TCI state update for the PDCCH(s) or PDSCH(s) associated with the BFD RS set p (or the corresponding TRP/TRP-specific index/ID value such as CORESETPoolIndex or PCI).

In yet another example, X_p symbols after receiving the BFRR for the failed BFD RS set p (p∈{1, 2,..., M}), the UE may apply the same receive filter as that for receiving the new beam selected from the NBI RS set p to receive the subsequent PDCCH(s) associated with the BFD RS set p (or the corresponding TRP/TRP-specific index/ID value such as CORESETPoolIndex or PCI) until the UE receives a TCI state update for the PDCCH(s) associated with the BFD RS set p (or the corresponding TRP/TRP-specific index/ID value such as CORESETPoolIndex or PCI). Furthermore, Y_p symbols after receiving the BFRR for the failed BFD RS set p (p∈{1, 2,..., M}), the UE may apply the same receive filter as that for receiving the new beam selected from the NBIRS set p to receive the subsequent PDSCH(s) associated with the BFD RS set p (or the corresponding TRP/TRP-specific index/ID value such as CORESETPoolIndex or PCI) until the UE receives a TCI state update for the PDSCH(s) associated with the BFD RS set p (or the corresponding TRP/TRP-specific index/ID value such as CORESETPoolIndex or PCI).

In addition, K_p symbols after receiving the BFRR for the failed BFD RS set p (p∈{1, 2,..., M}), the UE may apply a transmit filter same as the receive filter for receiving the new beam selected from the NBI RS set p to transmit the subsequent PUCCH(s) associated with the BFD RS set p (or the corresponding TRP/TRP-specific index/ID value such as CORESETPoolIndex or PCI) until the UE receives a TCI state update for the PUCCH(s) associated with the BFD RS set p (or the corresponding TRP/TRP-specific index/ID value such as CORESETPoolIndex or PCI). Also, L_p symbols after receiving the BFRR for the failed BFD RS set p (p∈{1, 2,..., M}), the UE may apply a transmit filter same as the receive filter for receiving the new beam selected from the NBI RS set p to transmit the subsequent PUSCH(s) associated with the BFD RS set p (or the corresponding TRP/TRP-specific index/ID value such as CORESETPoolIndex or PCI) until the UE receives a TCI state/spatial relation information update for the PUSCH(s) associated with the BFD RS set p (or the corresponding TRP/TRP-specific index/ID value such as CORESETPoolIndex or PCI).

If a UE is provided/indicated/configured by the network, e.g., in a MAC CE or a DCI format 1_1/1_2 with or without DL assignment (e.g., via the TCI field(s) in the beam indication DCI), one or more unified TCI states for the PCell or the PSCell, after 28 symbols from a last symbol of a first PDCCH reception in a search space set (associated with BFD RS set p or an entity ID) provided by recoverySearchSpaceld where the UE detects a DCI format with CRC scrambled by C-RNTI or MCS-C-RNTI, the UE could (1) monitor PDCCH in all CORESETs associated with the BFD RS set p or the entity ID, and receives PDSCH associated with the BFD RS set p or the entity ID and aperiodic CSI-RS resource in a CSI-RS resource set associated with the BFD RS set p or the entity ID with same indicated TCI state as for the PDCCH and PDSCH described herein, using the same antenna port quasi co-location parameters as the ones associated with the corresponding index q_{new} determined from the NBIRS set p, if any, and/or (2) transmit PUSCH associated with the BFD RS set p or the entity ID, PUCCH associated with the BFD RS set p or the entity ID and SRS associated with the BFD RS set p or the entity ID that uses a same spatial domain filter with same indicated TCI state as for the PUSCH and the PUCCH described herein, using a same spatial domain filter as for the last PRACH transmission associated with the BFD RS set p or the entity ID using the following parameters for determination of a corresponding power: (i) the RS index q_{d,p} = q_{new} for obtaining the downlink pathloss estimate for the BFD RS set p or the entity ID, (ii) the values of P_{O_UE_}_{PUSCH,b,f,c,p}(j), α_{b,f,c,p}(j), and the PUSCH power control adjustment state lp provided by p0-Alpha-CLID-PUSCH-Set associated with the smallest value of ul-powercontrolld for the BFD RS set p or the entity ID, or associated with the p-th smallest value of ul-powercontrolld for the PCell or the PSCell, (iii) the value of P_{O_PUCCH,b,f,c,p}(qᵤ) and the PUCCH power control adjustment state Iₚ provided by p0-Alpha-CLID-PUCCH-Set associated with the p-th smallest value of ul-powercontrolld for the PCell or the PSCell or associated with the smallest value of ul-powercontrolld for the BFD RS set p or the entity ID, and/or (iv) the values of P_{O_SRS,b,f,c,p}(qs), a_{SRS,b,f,c,p}(qₛ), and the SRS power control adjustment state lₚ provided by p0-Alpha-CLID-SRS-Set associated with the p-th smallest value of ul-powercontrolld for the PCell or the PSCell, or associated with the smallest value of ul-powercontrolld for the BFD RS set p or the entity ID.

In the above example, p∈{ 1,2,...,M} - as discussed/described herein, for p=1, the BFD RS set p could correspond to the first BFD RS set or BFD RS set 1 or the set q̅_{0,0} described herein in the present disclosure, and for p=2, the BFD RS set p could correspond to the second BFD RS set or BFD RS set 2 or the set q̅_{0,1} described herein in the present disclosure, and the entity ID could be at least one of: a PCI (i.e., a serving cell PCI or a PCI other than the serving cell PCI), a PCI index pointing to an entry/PCIin a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

If a UE is provided/indicated/configured by the network, e.g., in a MAC CE or a DCI format 1_1/1_2 with or without DL assignment (e.g., via the TCI field(s) in the beam indication DCI), one or more unified TCI states for the PCell or the PSCell, and the UE provides BFR MAC CE (e.g., for the BFD RS set p or an entity ID) in Msg3 or MsgA of contention based random access procedure, after 28 symbols from the last symbol of the PDCCH reception in a CORESET associated with the BFD RS set p or the entity ID that determines the completion of the contention based random access procedure as described in [11, TS 38.321], the UE could (1) monitor PDCCH in all CORESETs associated with the BFD RS set p or the entity ID, and receives PDSCH associated with the BFD RS set p or the entity ID and aperiodic CSI-RS resource in a CSI-RS resource set associated with the BFD RS set p or the entity ID with same indicated TCI state as for the PDCCH and PDSCH using the same antenna port quasi co-location parameters as the ones associated with the corresponding index q_{new} detemrined from the NBI RS set p, if any, and/or (2) transmit PUSCH associated with the BFD RS set p or the entity ID, PUCCH associated with the BFD RS set p or the entity ID and SRS associated with the BFD RS set p or the entity ID that uses a same spatial domain filter with same indicated TCI state as for the PUSCH and PUCCH described herein, using a same spatial domain filter as for the last PRACH transmission associated with the BFD RS set p or the entity ID using the following parameters for determination of a corresponding power: (i) the RS index q_{d,p} = q_{new} for obtaining the downlink pathloss estimate for the BFD RS set p or the entity ID, (ii) the values of P_{O_UE_}_{PUSCH,b,f,c,p}(j), a_{b,f,c,p}(j), and the PUSCH power control adjustment state lp provided by p0-Alpha-CLID-PUSCH-Set associated with the smallest value of ul-powercontrolld for the BFD RS set p or the entity ID, or associated with the p-th smallest value of ul-powercontrolld for the PCell or the PSCell, (iii) the value of P_{O-PUCCH,b,f,c,p}(qᵤ) and the PUCCH power control adjustment state lₚ provided by p0-Alpha-CLID-PUCCH-Set associated with the p-th smallest value of ul-powercontrolld for the PCell or the PSCell or associated with the smallest value of ul-powercontrolld for the BFD RS set p or the entity ID, and/or (iv) the values of P_{O_SRS,b,f,c,p}(qₛ), a_{SRS,b,f,c,p}(qₛ), and the SRS power control adjustment state lₚ provided by p0-Alpha-CLID-SRS-Set associated with the p-th smallest value of ul-powercontrolld for the PCell or the PSCell, or associated with the smallest value of ul-powercontrolld for the BFD RS set p or the entity ID.

In the above example, p∈{1,2,...,M} - as discussed/described herein, for p=1, the BFD RS set p could correspond to the first BFD RS set or BFD RS set 1 or the set q̅_{0,0} described herein in the present disclosure, and for p=2, the BFD RS set p could correspond to the second BFD RS set or BFD RS set 2 or the set q̅_{0,1} described herein in the present disclosure, and the entity ID could be at least one of: a PCI (i.e., a serving cell PCI or a PCI other than the serving cell PCI), a PCI index pointing to an entry/PCIin a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

The UE can provide, in a first PUSCH MAC CE (e.g., associated with the BFD RS set p or an entity ID), index(es) for at least corresponding BFD RS set p or the entity ID with radio link quality worse than Q_{out,LR}, indication(s) of presence of q_{new} (determined from the NBI RS set p) for corresponding BFD RS set p or the entity ID, and index(es) q_{new} (determined from the NBI RS set p) for a periodic CSI-RS configuration or for a SS/PBCH block provided by higher layers, as described in [11, TS 38.321], if any, for corresponding BFD RS set p or the entity ID. If a UE is provided/indicated/configured by the network, e.g., in a MAC CE or a DCIformat 1_1/1_2 with or without DL assignment (e.g., via the TCI field(s) in the beam indication DCI), one or more unified TCI states for the PCell or the PSCell, after 28 symbols from a last symbol of a PDCCH reception in a CORESET associated with the BFD RS set p or an entity ID with a DCI format scheduling a PUSCH transmission associated with the BFD RS set p or the entity ID with a same HARQ process number as for the transmission of the first PUSCH associated with the BFD RS set p or the entity ID and having a toggled NDI field value, the UE could (1) monitor PDCCH in all CORESETs associated with the BFD RS set p or the entity ID, and receives PDSCH associated with the BFD RS set p or the entity ID and aperiodic CSI-RS resource in a CSI-RS resource set associated with the BFD RS set p or the entity ID using the same antenna port quasi co-location parameters as the ones associated with the corresponding index q_{new} selected/determined from the NBI RS set p, if any, and/or (2) transmit PUSCH associated with the BFD RS set p or the entity ID, PUCCH associated with the BFD RS set p or the entity ID and SRS associated with the BFD RS set p or the entity ID that uses a same spatial domain filter with same indicated TCI state as for the PUSCH and PUCCH described herein, using a same spatial domain filter as the one corresponding to q_{new} selected/determined from the NBI RS set p, if any, and using the following parameters for determination of a corresponding power: (i) the RS index q_{d,p} = q_{new} for obtaining the downlink pathloss estimate for the BFD RS set p or the entity ID, (ii) the values of P_{O-UE-PUSCH,b,f,c,p}(j), a_{b,f,c,p}(j), and the PUSCH power control adjustment state lₚ provided by p0-Alpha-CLID-PUSCH-Set associated with the smallest value of ul-powercontrolld for the BFD RS set p or the entity ID, or associated with the p-th smallest value of ul-powercontrolld for the PCell or the PSCell, (iii) the value of P_{O_PUCCH,b,f,c,p}(qᵤ) and the PUCCH power control adjustment state lₚ provided byp0-Alpha-CLID-PUCCH-Set associated with the p-th smallest value of ul-powercontrolld for the PCell or the PSCell or associated with the smallest value of ul-powercontrolld for the BFD RS set p or the entity ID, and/or (iv) the values of P_{O_SRS,b,f,c,p}(qs), a_{SRS,b,f,c,p}(qₛ), and the SRS power control adjustment state lₚ provided by p0-Alpha-CLID-SRS-Set associated with the p-th smallest value of ul-powercontrolld for the PCell or the PSCell, or associated with the smallest value of ul-powercontrolld for the BFD RS set p or the entity ID.

In the above example, p∈{ 1,2,...,M} - as discussed/described herein, for p=1, the BFD RS set p could correspond to the first BFD RS set or BFD RS set 1 or the set q̅_{0,0} described herein in the present disclosure, and for p=2, the BFD RS set p could correspond to the second BFD RS set or BFD RS set 2 or the set q̅_{0,1} described herein in the present disclosure, and the entity ID could be at least one of: a PCI (i.e., a serving cell PCI or a PCI other than the serving cell PCI), a PCI index pointing to an entry/PCIin a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

When the UE would transmit the last symbol of a PUCCH with HARQ-ACK information (e.g., associated with the BFD RS set p or an entity ID) corresponding to the DCI carrying the TCI State indication and without DL assignment (e.g., the DCI is received in a CORESET associated with the BFD RS set p or the entity ID, or the indicated TCI state is associated with the BFD RS set p or the entity ID), or corresponding to the PDSCH (e.g., associated with the BFD RS set p or the entity ID) scheduled by the DCI carrying the TCI State indication (e.g., the DCI is received in a CORESET associated with the BFD RS set p or the entity ID, or the indicated TCI state is associated with the BFD RS set p or the entity ID), and if the indicated TCI State is different from the previously indicated one, the UE would apply the indicated TCI State starting from the first slot that is at least BeamAppTime_r17 symbols after the last symbol of the PUCCH. The first slot and the BeamAppTime_r17 symbols are both determined on the carrier with the smallest SCS among the carrier(s) — associated with the BFD RS set p or the same entity ID — applying the beam indication. If a UE is provided/indicated/configured by the network, e.g., in a MAC CE or a DCI format 1_1/1_2 with or without DL assignment (e.g., via the TCI field(s) in the beam indication DCI), one or more unified TCI states for the PCell or the PSCell, starting from the first slot that is at least BeamAppTime_r17 symbols after the last symbol of the PUCCH with HARQ-ACK information (e.g., associated with the BFD RS set p or the entity ID) for the TCI state(s) indicated in the beam indication DCI (e.g., the beam indication DCIis associated with the BFD RS set p or the entity ID, or the indicated TCI state is associated with the BFD RS set p or the entity ID) as described herein, the UE could (1) monitor PDCCH in all CORESETs associated with the BFD RS set p or the entity ID, and receives PDSCH associated with the BFD RS set p or the entity ID and aperiodic CSI-RS resource in a CSI-RS resource set associated with the BFD RS set p or the entity ID using the same antenna port quasi co-location parameters as the ones associated with the corresponding index q_{new} selected/determined from the NBIRS set p, if any, and/or (2) transmit PUSCH associated with the BFD RS set p or the entity ID, PUCCH associated with the BFD RS set p or the entity ID and SRS associated with the BFD RS set p or the entity ID that uses a same spatial domain filter with same indicated TCI state as for the PUSCH and PUCCH described herein, using a same spatial domain filter as the one corresponding to q_{new} selected/determined from the NBI RS set p, if any, and using the following parameters for determination of a corresponding power: (i) the RS index q_{d,p} = q_{new} for obtaining the downlink pathloss estimate for the BFD RS set p or the entity ID, (ii) the values of P_{O_UE_}_{PUSCH,b,f,c,p}(j), a_{b,f,c,p}(j), and the PUSCH power control adjustment state lₚ provided by p0-Alpha-CLID-PUSCH-Set associated with the smallest value of ul-powercontrolld for the BFD RS set p or the entity ID, or associated with the p-th smallest value of ul-powercontrolld for the PCell or the PSCell, (iii) the value of P_{O_PUCCH,b,f,c,p}(qᵤ) and the PUCCH power control adjustment state lₚ provided by p0-Alpha-CLID-PUCCH-Set associated with the p-th smallest value of ul-powercontrolld for the PCell or the PSCell or associated with the smallest value of ul-powercontrolld for the BFD RS set p or the entity ID, and/or (iv) the values of P_{O_SRS,b,f,c,p}(qs), a_{SRS},_{b,f,c,p}(qₛ), and the SRS power control adjustment state lₚ provided by p0-Alpha-CLID-SRS-Set associated with the p-th smallest value of ul-powercontrolld for the PCell or the PSCell, or associated with the smallest value of ul-powercontrolld for the BFD RS set p or the entity ID.

In the above example, p∈{ 1,2,...,M} - as discussed/described herein, for p=1, the BFD RS set p could correspond to the first BFD RS set or BFD RS set 1 or the set q̅_{0,0} described herein in the present disclosure, and for p=2, the BFD RS set p could correspond to the second BFD RS set or BFD RS set 2 or the set q̅_{0,1} described herein in the present disclosure, and the entity ID could be at least one of: a PCI (i.e., a serving cell PCI or a PCI other than the serving cell PCI), a PCI index pointing to an entry/PCIin a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGrouplndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

When the UE would transmit the last symbol of a PUCCH with HARQ-ACK information (e.g., associated with the BFD RS set p′ or a second entity ID) corresponding to the DCI carrying the TCI State indication and without DL assignment (e.g., the DCI is received in a CORESET associated with the BFD RS set p′ or the second entity ID, or the indicated TCI state is associated with the BFD RS set p or a first entity ID), or corresponding to the PDSCH (e.g., associated with the BFD RS set p′ or the second entity ID) scheduled by the DCI carrying the TCI State indication (e.g., the DCI is received in a CORESET associated with the BFD RS set p′ or the second entity ID, or the indicated TCI state is associated with the BFD RS set p or the first entity ID), and if the indicated TCI State associated with the BFD RS set p or the first entity ID is different from the previously indicated one associated with the BFD RS set p or the same first entity ID, the UE would apply the indicated TCI State for the BFD RS set p or the first entity ID starting from the first slot that is at least BeamAppTime_r17 symbols after the last symbol of the PUCCH (e.g., associated with the BFD RS set p′ or the second entity ID). The first slot and the BeamAppTime_r17 symbols are both determined on the carrier with the smallest SCS among the carrier(s) — associated with the BFD RS set p (or p′) or the same first (or second) entity ID -applying the beam indication. If a UE is provided/indicated/configured by the network, e.g., in a MAC CE or a DCIformat 1_1/1_2 with or without DL assignment (e.g., via the TCIfield(s) in the beam indication DCI), one or more unified TCI states for the PCell or the PSCell, starting from the first slot that is at least BeamAppTime_r17 symbols after the last symbol of the PUCCH with HARQ-ACK information (e.g., associated with the BFD RS set p′ or the second entity ID) for the TCI state(s) indicated in the beam indication DCI (e.g., the beam indication DCI is received in a CORESET associated with the BFD RS set p′ or the second entity ID, or the indicated TCI state is associated with the BFD RS set p or the first entity ID) as described herein, the UE could (1) monitor PDCCH in all CORESETs associated with the BFD RS set p or the first entity ID, and receives PDSCH associated with the BFD RS set p or the first entity ID and aperiodic CSI-RS resource in a CSI-RS resource set associated with the BFD RS set p or the first entity ID using the same antenna port quasi co-location parameters as the ones associated with the corresponding index q_{new} selected/determined from the NBI RS set p, if any, and/or (2) transmit PUSCH associated with the BFD RS set p or the first entity ID, PUCCH associated with the BFD RS set p or the first entity ID and SRS associated with the BFD RS set p or the first entity ID that uses a same spatial domain filter with same indicated TCI state as for the PUSCH and PUCCH described herein, using a same spatial domain filter as the one corresponding to q_{new} selected/determined from the NBI RS set p, if any, and using the following parameters for determination of a corresponding power: (i) the RS index q_{d,p} = q_{new} for obtaining the downlink pathloss estimate for the BFD RS set p or the first entity ID, (ii) the values of P_{O_UE_PUSCH,b,f,c,p}(j), a_{b,f,c,p}(j), and the PUSCH power control adjustment state lₚ provided by p0-Alpha-CLID-PUSCHSet associated with the smallest value of ul-powercontrolld for the BFD RS set p or the first entity ID, or associated with the p-th smallest value of ul-powercontrolld for the PCell or the PSCell, (iii) the value of P_{O_}_{PUCCH,b,f,c,p}(qᵤ) and the PUCCH power control adjustment state lₚ provided by p0-Alpha-CLID-PUCCH-Set associated with the p-th smallest value of ul-powercontrolld for the PCell or the PSCell or associated with the smallest value of ul-powercontrolld for the BFD RS set p or the first entity ID, and/or (iv) the values of P_{O_SRS,b,f,c,p}(qs), a_{SRS,b,f,c,p}(qₛ), and the SRS power control adjustment state lₚ provided by p0-Alpha-CLID-SRS-Set associated with the p-th smallest value of ul-powercontrolld for the PCell or the PSCell, or associated with the smallest value of ul-powercontrolld for the BFD RS set p or the first entity ID.

In the above example, p∈{1,2,...,M}, p'∈{1,2,...,M} - as discussed/described herein, for p=1 (or p′=1), the BFD RS set p (or p′) could correspond to the first BFD RS set or BFD RS set 1 or the set q̅_{0,0} described herein in the present disclosure, and for p=2 (or p′=2), the BFD RS set p (or p′) could correspond to the second BFD RS set or BFD RS set 2 or the set q̅_{0,1} described7 herein in the present disclosure, and the first or second entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID. In this design example, the value of p could be different from the value of p′, e.g., p=1 (e.g., the first BFD RS set or BFD RS set 1 or set q̅_{0,0} described herein in the present disclosure) while p′=2 (e.g., the second BFD RS set or BFD RS set 2 or set q̅_{0,1} described herein in the present disclosure), or p=2 (e.g., the second BFD RS set or BFD RS set 2 or set q̅_{0,1} described herein in the present disclosure) while p′=1 (e.g., the first BFD RS set or BFD RS set 1 or set q̅_{0,0} described herein in the present disclosure). The first entity ID could also be different from the second entity ID.

In the design examples, the NBIRS set p is associated with the BFD RS set p for p∈{1, 2,..., M}.

Various methods of configuring/indicating the values of X_p, Y_p, K_p, L_p (p∈{1, 2,..., N} or p∈{1, 2,..., M}) are presented below.

In one example, the values of X_p, Y_p, K_p and L_p are fixed in the system specifications. For example, the values of X_p, Y_p, K_p and L_p could be the same. For another example, the values of X_p, Y_p, K_p and L_p could be all different. Yet for another example, X_p =Y_p and K_p =L_p. Yet for another example, X_p =K_p and Y_p =L_p. The value of X_p, Y_p, K_p or L_p could be equal to 28 (symbols). Furthermore, the values of X_p, Y_p, K_p and L_p could depend on BFRR format. That is, for different BFRR formats such as a TCI state indication, an uplink grant or a dedicated BFR-CORESET discussed herein, the values of {X_p, Y_p, K_p, L_p} could be different.

In another example, the UE could be indicated by the network one or more of X_p, Y_p, K_p and L_p; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

In yet another example, the UE could autonomously determine one or more of X_p, Y_p, K_p and L_p.

In yet another example, the values of one or more of X_p, Y_p, K_p and L_p could be determined as the first slot that is at least BeamAppTime_r17 symbols after the last symbol of a first PUCCH, which is defined according to: when the UE would transmit the last symbol of the first PUCCH with HARQ-ACK information (e.g., associated with the BFD RS set p or an entity ID) corresponding to the DCI carrying the TCI State indication and without DL assignment (e.g., the DCI is received in a CORESET associated with the BFD RS set p or the entity ID, or the indicated TCI state is associated with the BFD RS set p or the entity ID), or corresponding to the PDSCH (e.g., associated with the BFD RS set p or the entity ID) scheduled by the DCI carrying the TCI State indication (e.g., the DCI is received in a CORESET associated with the BFD RS set p or the entity ID, or the indicated TCI state is associated with the BFD RS set p or the entity ID), and if the indicated TCI State is different from the previously indicated one, the UE would apply the indicated TCI State starting from the first slot that is at least BeamAppTime_r17 symbols after the last symbol of the first PUCCH. The first slot and the BeamAppTime_r17 symbols are both determined on the carrier with the smallest SCS among the carrier(s) — associated with the BFD RS set p or the same entity ID — applying the beam indication. Here, p∈ { 1,2,...,M} - as discussed/described herein, for p=1, the BFD RS set p could correspond to the first BFD RS set or BFD RS set 1 or the set q̅_{0,0} described herein in the present disclosure, and for p=2, the BFD RS set p could correspond to the second BFD RS set or BFD RS set 2 or the set q̅_{0,1} described herein in the present disclosure, and the first or second entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID.

In yet another example, the values of one or more of X_p, Y_p, K_p and L_p could be determined as the first slot that is at least BeamAppTime_r17 symbols after the last symbol of a first PUCCH, which is defined according to: when the UE would transmit the last symbol of the first PUCCH with HARQ-ACK information (e.g., associated with the BFD RS set p′ or a second entity ID) corresponding to the DCI carrying the TCI State indication and without DL assignment (e.g., the DCI is received in a CORESET associated with the BFD RS set p′ or the second entity ID, or the indicated TCI state is associated with the BFD RS set p or a first entity ID), or corresponding to the PDSCH (e.g., associated with the BFD RS set p′ or the second entity ID) scheduled by the DCI carrying the TCI State indication (e.g., the DCI is received in a CORESET associated with the BFD RS set p′ or the second entity ID, or the indicated TCI state is associated with the BFD RS set p or the first entity ID), and if the indicated TCI State associated with the BFD RS set p or the first entity ID is different from the previously indicated one associated with the BFD RS set p or the same first entity ID, the UE would apply the indicated TCI State for the BFD RS set p or the first entity ID starting from the first slot that is at least BeamAppTime_r17 symbols after the last symbol of the first PUCCH (e.g., associated with the BFD RS set p′ or the second entity ID). The first slot and the BeamAppTime_r17 symbols are both determined on the carrier with the smallest SCS among the carrier(s) — associated with the BFD RS set p (or p′) or the same first (or second) entity ID — applying the beam indication. Here, p ∈ {1,2,...,M}, p’∈{ 1,2,...,M} - as discussed/described herein, for p=1 (or p′=1), the BFD RS set p (or p′) could correspond to the first BFD RS set or BFD RS set 1 or the set q̅_{0,0} described herein in the present disclosure, and for p=2 (or p′=2), the BFD RS set p (or p′) could correspond to the second BFD RS set or BFD RS set 2 or the set q̅_{0,1} described herein in the present disclosure, and the first or second entity ID could be at least one of: a PCI (i.e., a serving cell PCI or a PCI other than the serving cell PCI), a PCI index pointing to an entry/PCI in a list of PCIs higher layer configured to the UE, a CORESET pool index/CORESETPoolIndex (e.g., provided in PDCCH-Config/PDSCH-Config/ControlResourceSet with value 0 or 1), a CORESET group index/CORESETGroupIndex (e.g., provided in PDCCH-Config/PDSCH-Config/ControlResourceSet with value 0 or 1), a TRP-specific index/ID, a TRP-specific resource set index/ID or a TRP-specific higher layer signaling index/ID. In this design example, the value of p could be different from the value of p′, e.g., p=1 (e.g., the first BFD RS set or BFD RS set 1 or set q̅_{0,0} described herein in the present disclosure) while p′=2 (e.g., the second BFD RS set or BFD RS set 2 or set q̅_{0,1} described herein in the present disclosure), or p=2 (e.g., the second BFD RS set or BFD RS set 2 or set q̅_{0,1} described herein in the present disclosure) while p′=1 (e.g., the first BFD RS set or BFD RS set 1 or set q̅_{0,0} described herein in the present disclosure). The first entity ID could also be different from the second entity ID.

Furthermore, X_p, Y_p, K_p or L_p (p∈{ 1, 2,..., N} or p∈{ 1, 2,..., M}) could be the number of symbols after an end of the ACK for the BFRR. Alternatively, X_p, Y_p, K_p or L_p could be the number of symbols after an end of the BFRR. Other options of counting X_p, Y_p, K_p or L_p may not be excluded.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

1-20. (canceled)

21. A user equipment (UE) in a wireless communication system, the UE comprising:
a transceiver configured to receive, from a base station (BS), information on a unified transmission configuration indicator (TCI) state; and
a processor operably coupled to the transceiver, the processor configured to:
detect a beam failure, and
identify an index for a beam failure recovery (BFR), the index corresponding to the unified TCI state,
wherein the transceiver is further configured to:
receive, from the BS, a physical downlink control channel (PDCCH) for the BFR, and
receive, from the BS, a physical downlink shared channel (PDSCH), after 28 symbols from a last symbol of the PDCCH, using a reception parameter associated with the index for the BFR which corresponds to the unified TCI state.

22. The UE of claim 21, wherein the transceiver is further configured to transmit, to the BS, a physical uplink shared channel (PUSCH), after the 28 symbols from the last symbol of the PDCCH, using a transmission filter associated with the index for the BFR which corresponds to the unified TCI state.

23. The UE of claim 21, wherein the processor is further configured to identify a power of an uplink transmission based on an uplink power control parameter associated with the unified TCI state.

24. The UE of claim 21, wherein the PDCCH is associated with a cell radio network temporary identifier (C-RNTI).

25. The UE of claim 21, wherein the PDCCH schedules an uplink transmission with a same hybrid automatic repeat request (HARQ) process as a transmission of a BFR medium access control (MAC) control element (CE).

26. A base station (BS) in a wireless communication system, the BS comprising:
a processor; and
a transceiver operably coupled to the processor, the transceiver configured to:
transmit, to a user equipment (UE), information on a unified transmission configuration indicator (TCI) state,
transmit, to the UE, a physical downlink control channel (PDCCH) for a beam failure recovery (BFR), and
transmit, to the UE, a physical downlink shared channel (PDSCH), after 28 symbols from a last symbol of the PDCCH, based on a reception parameter associated with an index for the BFR which corresponds to the unified TCI state.

27. The BS of claim 26, wherein the transceiver is further configured to receive, from the UE, a physical uplink shared channel (PUSCH), after the 28 symbols from the last symbol of the PDCCH, based on a transmission filter associated with the index for the BFR which corresponds to the unified TCI state.

28. The BS of claim 26, wherein a power of an uplink transmission is based on an uplink power control parameter associated with the unified TCI state.

29. The BS of claim 26, wherein the PDCCH is associated with a cell radio network temporary identifier (C-RNTI).

30. The BS of claim 26, wherein the PDCCH schedules an uplink transmission with a same hybrid automatic repeat request (HARQ) process as a transmission of a BFR medium access control (MAC) control element (CE).

31. A method performed by a user equipment (UE) in a wireless communication system, the method comprising:
receiving, from a base station (BS), information on a unified transmission configuration indicator (TCI) state;
detecting a beam failure;
identifying an index for a beam failure recovery (BFR), the index corresponding to the unified TCI state;
receiving, from the BS, a physical downlink control channel (PDCCH) for the BFR; and
receiving, from the BS, a physical downlink shared channel (PDSCH), after 28 symbols from a last symbol of the PDCCH, using a reception parameter associated with the index for the BFR which corresponds to the unified TCI state.

32. The method of claim 31, further comprising transmitting, to the BS, a physical uplink shared channel (PUSCH), after the 28 symbols from the last symbol of the PDCCH, using a transmission filter associated with the index for the BFR which corresponds to the unified TCI state.

33. The method of claim 31, further comprising identifying a power of an uplink transmission based on an uplink power control parameter associated with the unified TCI state.

34. The method of claim 31, wherein the PDCCH is associated with a cell radio network temporary identifier (C-RNTI).

35. The method of claim 31, wherein the PDCCH schedules an uplink transmission with a same hybrid automatic repeat request (HARQ) process as a transmission of a BFR medium access control (MAC) control element (CE).
